(19) United States
(12) Patent Application Publication
(10) Pub. No.: US 2018/0167918 A1
(43) Pub. Date: Jun. 14, 2018

(54) WIRELESS TELECOMMUNICATIONS METHODS AND APPARATUS COMPRISING ADVANCE NOTIFICATION OF CHANGE OF SYSTEM INFORMATION

(71) Applicant: SHARP Laboratories of America, Inc., Camas, WA (US)

(72) Inventor: Atsushi ISHII, Vancouver, WA (US)

(21) Appl. No.: 15/839,468

(22) Filed: Dec. 12, 2017

Related U.S. Application Data
(60) Provisional application No. 62/433,711, filed on Dec. 13, 2016.

(51) Int. Cl. H04W 72/04; H04W 74/00; H04W 48/12; H04W 68/00

(52) U.S. Cl. CPC H04W 72/042; H04W 74/006; H04W 72/0446; H04W 68/005; H04W 48/12

(57) ABSTRACT

An access node (22) comprising processor circuitry (30) and transmitter circuitry (34). The processor circuitry (30) is configured to generate system information messages which comprise content of system information blocks and to generate a notification message configured to prospectively indicate a change of the content of at least one of the system information blocks. The transmitter circuitry (34) is configured to transmit the system information messages and the notification message over an air interface to the one or more wireless terminals. A wireless terminal (26) comprises receiver circuitry (46) and processor circuitry (40). The receiver circuitry (46) is configured to receive messages over an air interface from an access node. The messages include a system information message which comprises content of system information block and a notification message configured to prospectively indicate of a change of content of at least one of the system information blocks. The processor circuitry (40) is configured to use the notification message to make a determination regarding acquisition of the content of at least one system information block.

This application claims the priority and benefit of U.S. Provisional Patent Application 62/433,711, filed Dec. 13, 2016, entitled “WIRELESS TELECOMMUNICATIONS METHODS AND APPARATUS COMPRISING ADVANCE NOTIFICATION OF CHANGE OF SYSTEM INFORMATION”, which is incorporated hereby by reference in its entirety.

### TECHNICAL FIELD

The technology relates to wireless communications, and particularly to methods and apparatus for requesting, transmitting, and using system information (SI) in wireless communications.

### BACKGROUND

In wireless communication systems, a radio access network generally comprises one or more access nodes (such as a base station) which communicate on radio channels over a radio or air interface with plural wireless terminals. In some technologies such a wireless terminal is also called a User Equipment (UE). A group known as the 3rd Generation Partnership Project (“3GPP”) has undertaken to define globally applicable technical specifications and technical reports for present and future generation wireless communication systems. The 3GPP Long Term Evolution (“LTE”) and 3GPP LTE Advanced (LTE-A) are projects to improve an earlier Universal Mobile Telecommunications System (“UMTS”) mobile phone or device standard in a manner to cope with future requirements.

In typical cellular mobile communication systems, the base station broadcasts on the radio channels certain information which is required for mobile stations to access to the network. In Long-Term Evolution (LTE) and LTE Advanced (LTE-A), such information is called “system information” (“SI”). Each access node, such as an evolved NodeB (“eNB”), broadcasts such system information to its coverage area via several System Information Blocks (SIBs) on downlink radio resources allocated to the access node.

A wireless terminal (“UE”), after entering a coverage area of an eNB, is required to obtain all the SIBs which are necessary to access to the system. For sake of UEs under coverage, the eNB periodically broadcasts all SIBs relevant for offered services, not just SIBs that are required for access to the system. Each type of SIBs is transmitted in a designated radio resource(s) with its own pre-determined/configurable frequency.

This all-broadcast-based periodic delivery method (e.g., collective broadcast of all SIBs, not just those necessary for system access) is efficient under a condition where many UEs are almost always flowing into the coverage area (such as a macro cell). However, this approach may result in wasting valuable radio resources in case of small cell deployment. Therefore, more efficient methods of SIB transmission are desired.

What is needed, therefore, and an example object of the technology disclosed herein, are methods, apparatus, and techniques for more efficient transmission of system information blocks (SIBs).

### SUMMARY

In one of its example aspects the technology disclosed herein concerns an access node comprising processor circuitry and transmitter circuitry. The processor circuitry is configured to: generate system information messages which comprise content of system information blocks; and generate a notification message configured to prospectively indicate a change of the content of at least one of the system information blocks. The transmitter circuitry is configured to transmit the system information messages and the notification message over an air interface to the one or more wireless terminals.

In another of its example aspects the technology disclosed herein concerns a method in an access node. The method comprises using processor circuitry to generate system information messages which comprise content of system information blocks and to generate a notification message configured to prospectively indicate a change of the content of at least one of the system information blocks. The method further comprises transmitting the system information messages and the notification message over an air interface to the one or more wireless terminals

In another of its aspects the technology disclosed herein concerns a wireless terminal comprising receiver circuitry and processor circuitry. The receiver circuitry is configured to receive messages over an air interface from an access node, the messages including a system information message which comprises content of system information blocks and a notification message configured to prospectively indicate of a change of content of at least one of the system information blocks. The processor circuitry is configured to use the notification message to make a determination regarding acquisition of the content of at least one system information block.

In another of its example aspects the technology disclosed herein concerns a method in a wireless terminal. The method comprises receiving messages over an air interface from an access node, including a system information message which comprises content of system information blocks and a notification message configured to prospectively indicate of a change of content of at least one of the system information blocks. The method further comprises using processor circuitry to make a determination regarding acquisition of the content of at least one system information block

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a schematic view showing an example communications system comprising a radio access node and a wireless terminal, and wherein the radio access node provides a value tag for system information (SI).

FIG. 2 is a diagrammatic view of a node-available system information message according to an example embodiment and mode.

FIG. 3 is a flowchart showing example, representative, basic acts or steps performed by the radio access node of FIG. 1.

FIG. 4 is a flowchart showing example, representative, basic acts or steps performed by the wireless terminal of FIG. 1

FIG. 5 is a schematic view showing an example communications system comprising a radio access node and a wireless terminal, and wherein the radio access node provides a value tag for system information (SI) along with differentiated delivery of system information (SI).

FIG. 6 is a diagrammatic view showing example message flow for the example communications system of FIG. 5.

FIG. 7 is a diagrammatic view showing an example format of an Essential System Information message according to an example implementation of the system of FIG. 5.

FIG. 8 is a schematic view showing an example communications system comprising a radio access node and a wireless terminal, and wherein the radio access node provides a value tag for system information (SI) along with definition of a base of second type system information to which the value tag applies.

FIG. 9 is a diagrammatic view showing example message flow for the example communications system of FIG. 8.

FIG. 10 is a schematic view showing an example communications system comprising a radio access node and a wireless terminal, and wherein the wireless terminal provides a stored value tag for stored second type system information system information (SI) when requesting second type system information from the radio access node.

FIG. 11 is a diagrammatic view showing example message flow for the example communications system of FIG. 1-10.

FIG. 12 is a flowchart showing example, representative, basic acts or steps performed by the radio access node of FIG. 10 in implementing certain acts of FIG. 11.

FIG. 13 is a flowchart showing example, representative, basic acts or steps performed by the wireless terminal of FIG. 10 in implementing certain acts of FIG. 11.

FIG. 14 is a schematic view showing an example communications system comprising a radio access node and a wireless terminal, and wherein the radio access node provides a value tag which is associated with a group of plural system information blocks (SIBs).

FIG. 15 is a diagrammatic view showing an example format of an Essential System Information message according to an example implementation of the system of FIG. 14, wherein multiple sibIds associated with one valueTag forms a non-essential SIB group.

FIG. 16 is a diagrammatic view showing example message flow for the example communications system of FIG. 14.

FIG. 17 is a flowchart showing example, representative, basic acts or steps performed by the radio access node of FIG. 14 in implementing certain acts of FIG. 16.

FIG. 18 is a flowchart showing example, representative, basic acts or steps performed by the wireless terminal of FIG. 14 in implementing certain acts of FIG. 16.

FIG. 19 is a diagrammatic view showing example message flow for another example embodiment and mode which combines features of the embodiment and mode of FIG. 10 and the embodiment and mode of FIG. 14.

FIG. 20 is a diagrammatic views showing an example message flow for yet other example embodiments and modes.

FIG. 21 is a diagrammatic view showing an example format of an Essential System Information message according to an example implementation of the system of FIG. 20.

FIG. 22-FIG. 25 are diagrammatic views showing example message flows for still yet other example embodiments and modes.

FIG. 26 is a schematic view showing an example communications system comprising a radio access node and a wireless terminal, and wherein the radio access node provides an automatic broadcast-after-update for system information.

FIG. 27 is a diagrammatic view showing example message flow for the example communications system of FIG. 16.

FIG. 28 is a schematic view showing an example communications system comprising a radio access node and a wireless terminal, and wherein the radio access node provides an automatic broadcast-after-update for system information for a group of second type system information blocks.

FIG. 29 is a flowchart showing example, representative, basic acts or steps performed by the radio access node of FIG. 28.

FIG. 30 is a flowchart showing example, representative, basic acts or steps performed by the wireless terminal of FIG. 28.

FIG. 31 is a diagrammatic view showing example message flow for the example communications system of FIG. 28.

FIG. 32 is a diagrammatic view showing an example format of an Essential System Information message according to an example implementation of the system of FIG. 28.

FIG. 33 is a schematic view showing an example communications system comprising a radio access node and a wireless terminal, and wherein the radio access node provides a compressed automatic broadcast-after-update message for second type system information blocks.

FIG. 34 is a diagrammatic view showing example message flow for the example communications system of FIG. 33.

FIG. 35 is a diagrammatic view showing example message flow for an example communications system such as that of FIG. 33 which also uses compression.

FIG. 36 is a schematic view showing an example communications system comprising a radio access node and a wireless terminal, and wherein the radio access node provides a geographical area identifier which specifies a geographical area for which the value tag is valid.

FIG. 37 is a flowchart showing example, representative, basic acts or steps performed by the wireless terminal of FIG. 36.

FIG. 38 is a diagrammatic view showing a context of a radio access network (RAN) in which the wireless terminal of FIG. 36 performs the acts of FIG. 37.

FIG. 39A-FIG. 39E are diagrammatic views showing various different manners of inclusion/obtaining geographical area identifier from respectively differently formatted broadcast messages.

FIG. 40 is a schematic view showing an example communications system comprising a radio access node and a wireless terminal, and wherein the radio access node provides check information based on content of system information available at the access node.

FIG. 41 is a flowchart showing example, representative, basic acts or steps performed by the access node of FIG. 40.

FIG. 42 is a flowchart showing example, representative, basic acts or steps performed by the wireless terminal of FIG. 40.

FIG. 43 is a diagrammatic view showing a context of a radio access network (RAN) in which the access node of FIG. 40 perform the acts of FIG. 41 and the wireless terminal of FIG. 40 performs the acts of FIG. 42.

FIG. 44 is a diagrammatic views showing example format of inclusion of system information check information in a message transmitted by the access node of FIG. 40.

FIG. 45 is a schematic view showing an example communications system comprising a radio access node and a wireless terminal, and wherein the wireless terminal uses check information to confirm updated system information received from the access node.

FIG. 46 is a flowchart showing example, representative, basic acts or steps performed by the wireless terminal of FIG. 45.

FIG. 47 is a flowchart showing example, representative, basic acts or steps performed by the access node of FIG. 45.

FIG. 48 is a diagrammatic view showing a context of a radio access network (RAN) in which the access node of FIG. 45 perform the acts of FIG. 46 and the wireless terminal of FIG. 45 performs the acts of FIG. 46.

FIG. 49 is a schematic view showing an example communications system comprising a radio access node and a wireless terminal, and wherein the radio access node receives check information based on content of system information stored at the wireless terminal.

FIG. 50 is a flowchart showing example, representative, basic acts or steps performed by the wireless terminal of FIG. 49.

FIG. 51 is a flowchart showing example, representative, basic acts or steps performed by the access node of FIG. 49.

FIG. 52 is a diagrammatic view showing a context of a radio access network (RAN) in which the access node of FIG. 49 perform the acts of FIG. 51 and the wireless terminal of FIG. 49 performs the acts of FIG. 50.

FIG. 53 is a schematic view showing an example communications system comprising a radio access node and a wireless terminal, and wherein the radio access node sends a validity time value which specifies a time period during which the second type system information system information obtained from the first access node remains valid in the geographical area served by the access node.

FIG. 54 is a flowchart showing example, representative, basic acts or steps performed by the wireless terminal of FIG. 53.

FIG. 55 is a flowchart showing example, representative, basic acts or steps performed by the access node of FIG. 53.

FIG. 56 is a diagrammatic view showing a context of a radio access network (RAN) in which the access node of FIG. 53 perform the acts of FIG. 55 and the wireless terminal of FIG. 53 performs the acts of FIG. 54.

FIG. 57 is a schematic view showing an example communications system comprising a radio access node and a wireless terminal, and wherein a wireless terminal determines that, if a geographical area identifier is not received along with system information from a particular access node, the system information received from that access node is unique for that access.

FIG. 58 is a flowchart showing example, representative, basic acts or steps performed by the wireless terminal of FIG. 57.

FIG. 59 is a diagrammatic view showing a context of a radio access network (RAN) in which the wireless terminal of FIG. 57 performs the acts of FIG. 58.

FIG. 60 is a diagrammatic view showing example electronic machinery which may comprise node electronic machinery or terminal electronic machinery.

FIG. 61 is a schematic view showing an example communications system comprising a radio access node and a wireless terminal, and wherein when a particular system information block (SIB) changes membership between the first set of system information and the second set of system information, the access node changes a delivery mode of the particular system information block (SIB), and accordingly changes composition of the broadcast messages which emanate from the access node.

FIG. 62 includes diagrammatic views showing an example format of an Essential System Information message BM-61-A before a particular SIB changes membership and an Essential System Information message BM-61-B after the particular SIB changes membership according to an example implementation of the system of FIG. 61.

FIG. 63 is a flowchart showing example, representative, basic acts or steps performed by the access node of FIG. 61.

FIG. 64 is a flowchart showing example, representative, basic acts or steps performed by the access node of FIG. 61 including an optional act of generating and transmitting a system information modification indication.

FIG. 65 is a flowchart showing example, representative, basic acts or steps performed by the access node of FIG. 61 including an optional act of deriving a post-change value tag for inclusion in the broadcast message second portion from a pre-change value tag.

FIG. 66 is a flowchart showing example, representative, basic acts or steps performed by the wireless terminal of FIG. 61.

FIG. 67 is a schematic view showing an example communications system comprising a radio access node and a wireless terminal, and wherein the radio access node generates and transmits a notification message configured to prospectively indicate a change of content of at least one system information block.

FIG. 68 is a diagrammatic view of a series of modification periods and showing generation and transmission of system information messages in the modification periods and generation and transmission of notification messages in a “current” modification period.

FIG. 69 is a flowchart showing example, representative, basic acts or steps performed by the radio access node of FIG. 1.

FIG. 70 is a flowchart showing example, representative, basic acts or steps performed by the wireless terminal of FIG. 1

FIG. 71 is a diagrammatic view showing an example format of a paging message (PM) that comprises an optional information element that indicates that at least one of the system information blocks (SIBs) available from an access node will be updated.

FIG. 72 is a diagrammatic view showing an example format of an Essential System Information message according to an example embodiment and mode which shows, e.g., an essentialSystemInformation information element.

FIG. 73 is a schematic view showing an example communications system comprising a radio access node and a wireless terminal, wherein the radio access node generates and transmits a notification message configured to prospectively indicate a change of the content of at least one system information block, and wherein the system information (SI) may be classified into plural categories or types.

FIG. 74 is a diagrammatic view showing an example format of a paging message comprising a first field which prospectively indicates if a first set of system information blocks will include a system information block comprising changed content and a second field which prospectively indicates if a second set of system information blocks will include a system information block comprising changed content.

FIG. 75 is a flowchart showing example, representative, basic acts or steps performed by the wireless terminal of FIG. 7.

FIG. 76A is a diagrammatic view showing an example format of a paging message which comprises a bitmap.

FIG. 76B is a diagrammatic view showing an example format of a paging message which comprises a bitmap for each of plural categories or classes of system information blocks.

FIG. 77A is a diagrammatic view showing an example format of a paging message which comprises a list of identifiers of system information blocks having changed content.

FIG. 77B is a diagrammatic view showing an example format of a paging message which provides a list of affected system information blocks for each of plural categories or classes of system information blocks.

FIG. 78 is a schematic view showing an example communications system comprising a radio access node and a wireless terminal, wherein the radio access node generates and transmits a notification message configured to prospectively indicate a change of the content of at least one system information block, and the radio access node also generates value tags or version tags.

FIG. 79 is a diagrammatic view showing an example format of a paging message wherein a systemInfoModification field is configured in association with value tags.

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc.

As used herein, the term “wireless terminal” can refer to any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, netbooks, e-readers, wireless modems, etc.

As used herein, the term “access node”, “node”, or “base station” can refer to any device or group of devices that facilitates wireless communication or otherwise provides an interface between a wireless terminal and a telecommunications system. A non-limiting example of a base station can include, in the 3GPP specification, a Node B (“NB”), an enhanced Node B (“eNB”), a home eNB (“HeNB”), a gNB or some other similar terminology. Another non-limiting example of a base station is an access point. An access point may be an electronic device that provides access for wireless terminal to a data network, such as (but not limited to) a Local Area Network (“LAN”), Wide Area Network (“WAN”), the Internet, etc. Although some examples of the systems and methods disclosed herein may be described in relation to given standards (e.g., 3GPP Releases 8, 9, 10, 11, and/or 12 or higher), the scope of the present disclosure should not be limited in this regard. At least some aspects of the systems and methods disclosed herein may be utilized in other types of wireless communication systems.

As used herein, the term “telecommunication system” or “communications system” can refer to any network of devices used to transmit information. A non-limiting example of a telecommunication system is a cellular network or other wireless communication system.

As used herein, the term “cellular network” can refer to a network distributed over cells, each cell served by at least one fixed-location transceiver, such as a base station. A “cell” may be any communication channel that is specified by standardization or regulatory bodies to be used for International Mobile Telecommunications-Advanced (“IMTAdvanced”). All or a subset of the cell may be adopted by 3GPP as licensed bands (e.g., frequency band) to be used for communication between a base station, such as a Node B, and a UE terminal. A cellular network using licensed frequency bands can include configured cells. Configured cells can include cells of which a UE terminal is aware and in which it is allowed by a base station to transmit or receive information.

### 1st Embodiments

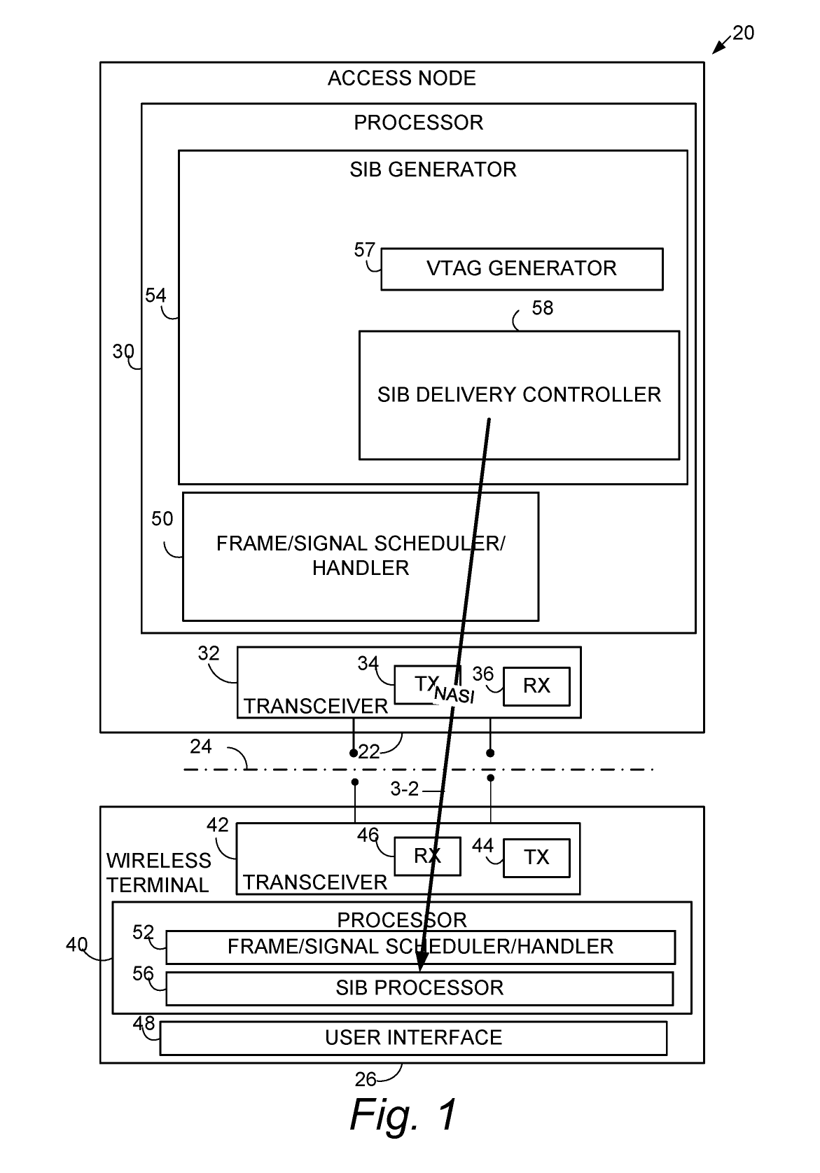

FIG. 1 shows an example communications system 20 wherein radio access node 22 communicates over air or radio interface 24 (e.g., Uu interface) with wireless terminal 26. As mentioned above, the radio access node 22 may be any suitable node for communicating with the wireless terminal 26, such as a base station node, eNodeB (“eNB”), or a gNB node (for, e.g., New Radio [NR] technology), for example. The node 22 comprises node processor circuitry (“node processor 30”) and node transceiver circuitry 32. The node transceiver circuitry 32 typically comprises node transmitter circuitry 34 and node receiver circuitry 36, which are also called node transmitter and node receiver, respectively.

The wireless terminal 26 comprises terminal processor circuitry 40 (“terminal processor 40”) and terminal transceiver circuitry 42. The terminal transceiver circuitry 42 typically comprises terminal transmitter circuitry 44 and terminal receiver circuitry 46, which are also called terminal transmitter 44 and terminal receiver 46, respectively. The wireless terminal 26 also typically comprises user interface 48. The terminal user interface 48 may serve for both user input and output operations, and may comprise (for example) a screen such as a touch screen that can both display information to the user and receive information entered by the user. The user interface 48 may also include other types of devices, such as a speaker, a microphone, or a haptic feedback device, for example.

For both the radio access node 22 and wireless terminal 26, the respective transceiver circuitries 32 and 42 include antenna(s). The respective transmitter circuits 34 and 44 may comprise, e.g., amplifier(s), modulation circuitry and other conventional transmission equipment. The respective receiver circuits 36 and 46 may comprise, e.g., e.g., amplifiers, demodulation circuitry, and other conventional receiver equipment.

In general operation node, the radio access node 22 and wireless terminal 26 communicate with each other across radio interface 24 using predefined configurations of information. By way of non-limiting example, the radio access node 22 and wireless terminal 26 may communicate over radio interface 24 using “frames” of information that may be configured to include various channels. In Long Term Evolution (LTE), for example, a frame, which may have both downlink portion(s) and uplink portion(s), may comprise plural subframes, with each LTE subframe in turn being divided into two slots. The frame may be conceptualized as a resource grid (a two dimensional grid) comprised of resource elements (RE). Each column of the two dimensional grid represents a symbol (e.g., an OFDM symbol on downlink (DL) from node to wireless terminal; an SC-FDMA symbol in an uplink (UL) frame from wireless terminal to node). Each row of the grid represents a subcarrier. The frame and subframe structure serves only as an example of a technique of formatting of information that is to be transmitted over a radio or air interface. It should be understood that “frame” and “subframe” may be utilized interchangeably or may include or be realized by other units of information formatting, and as such may bear other terminology (such as blocks, for example).

To cater to the transmission of information between radio access node 22 and wireless terminal 26 over radio interface 24, the node processor 30 and terminal processor 40 of FIG. 1 are shown as comprising respective information handlers. For an example implementation in which the information is communicated via frames, the information handler for radio access node 22 is shown as node frame/signal scheduler/handler 50, while the information handler for wireless terminal 26 is shown as terminal frame/signal handler 52.

The node processor 30 of radio access node 22 also includes system information (SI) generator 54. The wireless terminal 26 uses the system information (SI) generated by radio access node 22, and even in some example implementations specifically requests certain system information (SI), in on-demand fashion. To that end the terminal processor 40 of wireless terminal 26 is shown as comprising SIB processor 56.

The node processor 30, and system information (SI) generator 54 in particular, generates a value tag which is associated with the system information (SI). The value tag, also known as a version tag or “Vtag”, is configured to provide an indication of the version or vintage of system information with which the value tag is associated. In example implementations the value tag may take the form of a numeral or character, e.g., “1” for first version, “2” for second version, etc., or “A” for first version, “B”, for second version, etc. Any other convention for differentiating between values or versions may instead be employed. To this end system information (SI) generator 54 is shown as comprising value tag generator 57.

The value tag generator 57 serves, e.g., to change the value tag when a parameter of the system information is changed. For example, the value tag generator 57 may increment a number of the value tag when a parameter of the system information is changed.

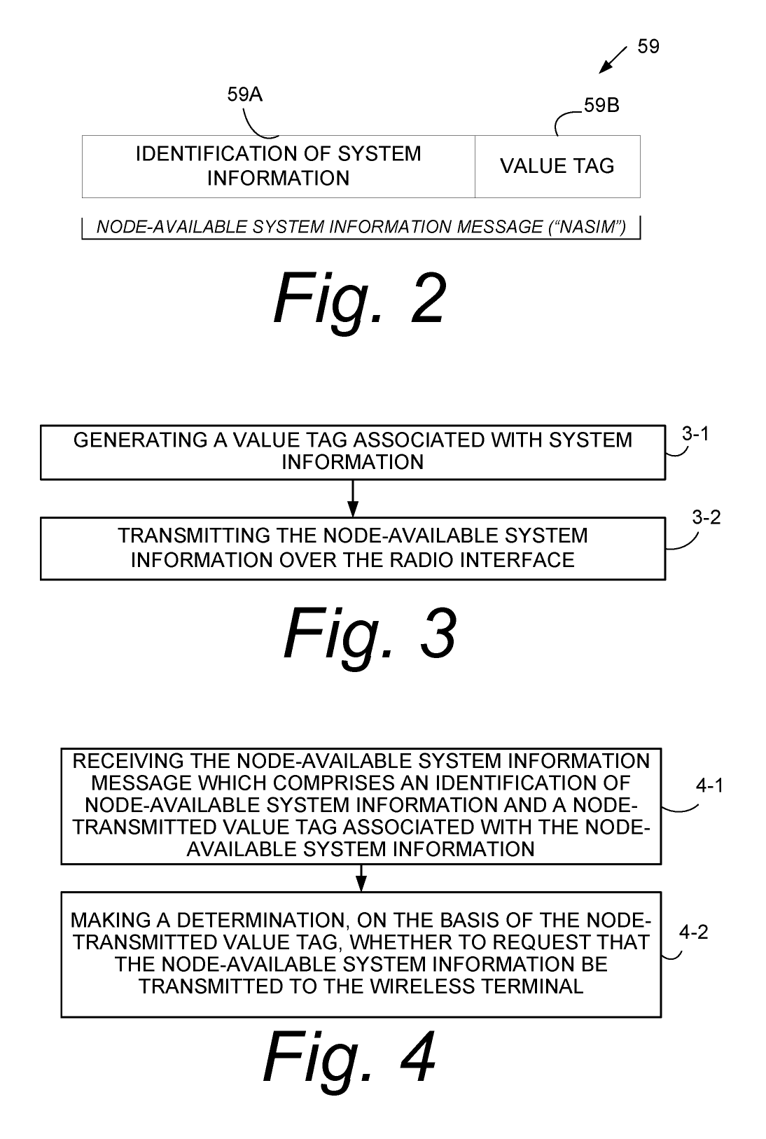

The system information (SI) generator 54 also comprises SIB delivery controller 58, which controls the timing and content of delivery of system information (SI), as well as timing and delivery of certain node-available system information (“NASI”). In an example embodiment and mode, illustrated in FIG. 2, the node-available system information comprises a node-available system information message NASIM 59 which includes both an identification of the system information that is available from the radio access node 22, and the value tag associated with that available system information. To this end, the NASIM 59 of FIG. 2 shows an identification of system information field or information element 59A, and a value tag field or information element 59B.

FIG. 3 depicts certain example, representative, basic acts or steps performed by the radio access node 22 of FIG. 1. Act 3-1 comprises generating a value tag associated with system information that is available at the radio access node 22. As is understood in the art, the system information facilitates use of communication services provided by the access node. Act 3-2 comprises transmitting over the radio interface 24 the node-available system information (“NASI”). Such transmission may be by means of the node-available system information message NASIM 59. An arrow 3-2 in FIG. 1 corresponds to act 3-2 (and, in an example implementation, to the node-available system information message NASIM 59). As indicated above and with respect to FIG. 2, the node-available system information message comprises an identification of the system information and the value tag associated with the system information.

FIG. 4 depicts certain example, representative, basic acts or steps performed by the wireless terminal 26 of FIG. 1. Act 4-1 comprises receiving, from the radio access node 22, the node-available system information message (3-2) which comprises an identification of node-available system information and a node-transmitted value tag associated with the node-available system information. Act 4-2 comprises the wireless terminal 26 making a determination, on the basis of the node-transmitted value tag, whether to request that the node-available system information be transmitted to the wireless terminal. If the determination of act 4-2 indicates that the available system information as advertised in the node-available system information message (3-2) should be obtained (e.g., because that available system information has a more recent value tag), then as act 4-3 the wireless terminal 26 sends a request message to the radio access node 22 to obtain the advertised system information.

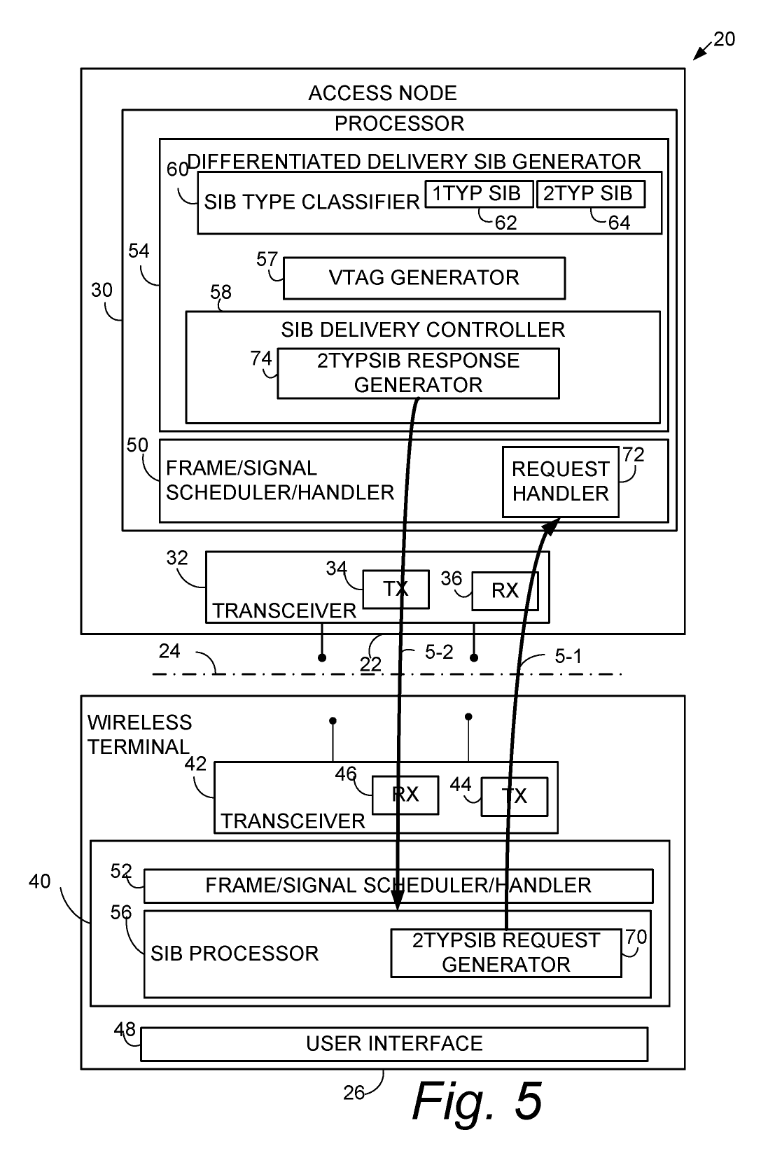

FIG. 5 illustrates certain example embodiment and mode wherein system information (SI) is classified into plural categories or types, and delivery of each category or type of system information (SI) is separately triggered and thus separately delivered across radio interface 24 to one or more wireless terminals. Accordingly, the system information (SI) generator of radio access node 22 is also known as differentiated delivery SIB generator 54.

In view of the fact that, in certain example embodiments and modes, the system information (SI) is classified into plural categories or types, the system information (SI) generator 54 is depicted in FIG. 5 as comprising SIB type classifier 60 which defines the plural categories or types of system information, and may further define an association between the plural types and respective system information blocks. For sake of example two representative categories or types of system information (SI) are shown as defined by the SIB type classifier 60 in FIG. 5: a first type of system information (1TYP SIB) and a second type of system information (2TYP SIB). Definitions and procedures for handling for the first type of system information (1TYP SIB) and the second type of system information (2TYP SIB) may be selectively configured and maintained, and are accordingly reflected by 1TYPSIB controller 62 and 2TYPSIB controller 64, respectively.

In an example embodiment and mode, the first type of system information (1TYP SIB) is SIB “essential system information”, which means system information (SI) which is essential to or minimally required by the wireless terminal 26 for initial access to the radio access network and to radio interface 24 in particular. Essential system information may be also referred as “minimum system information”. On the other hand, in the same example embodiment and mode, the second type of system information (2TYP SIB) is non-essential system information (SI). “Non-essential” system information (SI) is defined as all other types of information, and thus excludes the minimal information required for initial access. Non-essential system information may be also referred as “other system information”. As such the second type of system information (2TYP SIB) may facilitate utilization of certain features or services provided by or through radio access node 22. Thus, the first type system information comprises information which is periodically broadcasted by the transmitter and which is required for initial access to the radio access network, but the second type system information is not required for initial access to the radio access network.

In example embodiments and modes described herein, the radio access node 22 separately delivers the different types of system information, e.g., delivers the second type of system information (2TYP SIB) separately from the first type of system information (1TYP SIB). For example, the node processor 30 may schedule periodic transmissions by the transmitter of first type system information over the radio interface; and thereafter or separately from the periodic transmissions of the first type system information, schedule transmission by the transmitter of second type system information over the radio interface. Accordingly, in example embodiments and modes, the SIB delivery controller 58, among other things, may implement the “differentiated” delivery of the second type of system information (2TYP SIB) apart from the first type of system information (1TYP SIB). As explained herein, the transmission of second type system information may be either by unicast or broadcast.

FIG. 5 further illustrates that wireless terminal 26 may, after obtaining initial access to the communications system 20 (e.g., as a result of receiving the first type of system information (1TYP SIB)), recognize or appreciate that the wireless terminal 26 may need the second type of system information (2TYP SIB). Thus the wireless terminal 26 may make a special request for the second type of system information (2TYP SIB). The FIG. 5 embodiment and mode is thus an example of the radio access node 22 providing second type system information “on demand”. Such request or demand for second type of system information (2TYP SIB) may arise, for example, when the wireless terminal 26 seeks to utilize a certain service provided by the communications system 20 or a functionality of wireless terminal 26 which, although not required for access, may enhance operation of wireless terminal 26. Accordingly, FIG. 5 shows the SIB processor 56 of wireless terminal 26 as comprising 2TYPSIB request generator 70, which may generate a 2TYPSIB request depicted by arrow 5-1.

FIG. 5 further shows node frame/signal scheduler/handler 50 as comprising 2TYPSIB request handler 72, and further shows the SIB delivery controller 58 as comprising 2TYPSIB response generator 74. In the FIG. 5 embodiment and mode, the 2TYPSIB response generator 74 generates a response message 5-2 which includes one or more requested system information blocks (SIBs), e.g., includes at least one block of the second type system information.

Thus, in the FIG. 5 embodiment and mode, the node processor 30 schedules periodic transmissions by the transmitter of first type system information over the radio interface. Thereafter or separately from the periodic transmissions of the first type system information, and upon request by the wireless terminal 26, the node processor 30 schedules transmission by the transmitter of second type system information over the radio interface. The request by the wireless terminal 26 may arise after the wireless terminal 26 receives the node-available system information message NASIM 59, which advises of the value tag for the node-available system information. Thus, in the FIG. 5 embodiment and mode, the value tag is associated with the second type system information.

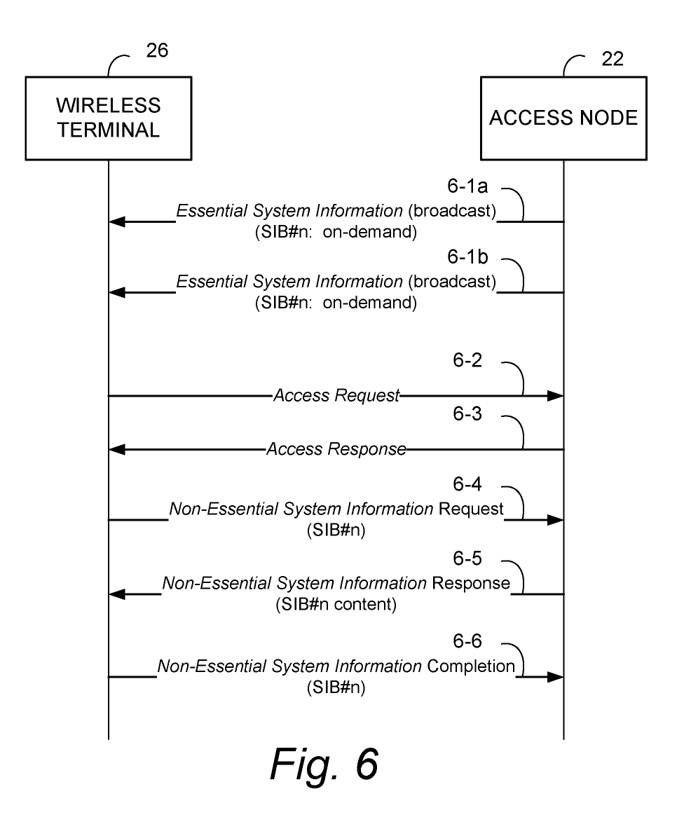

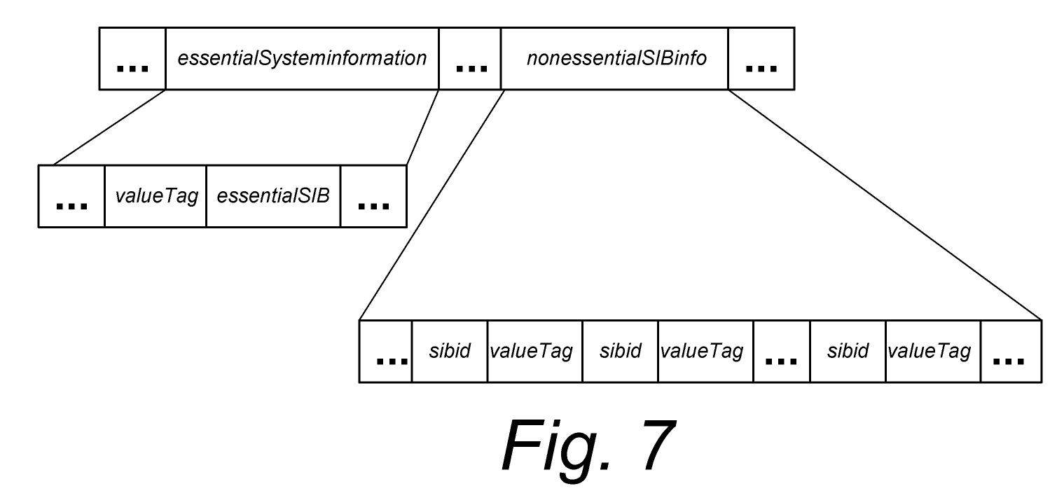

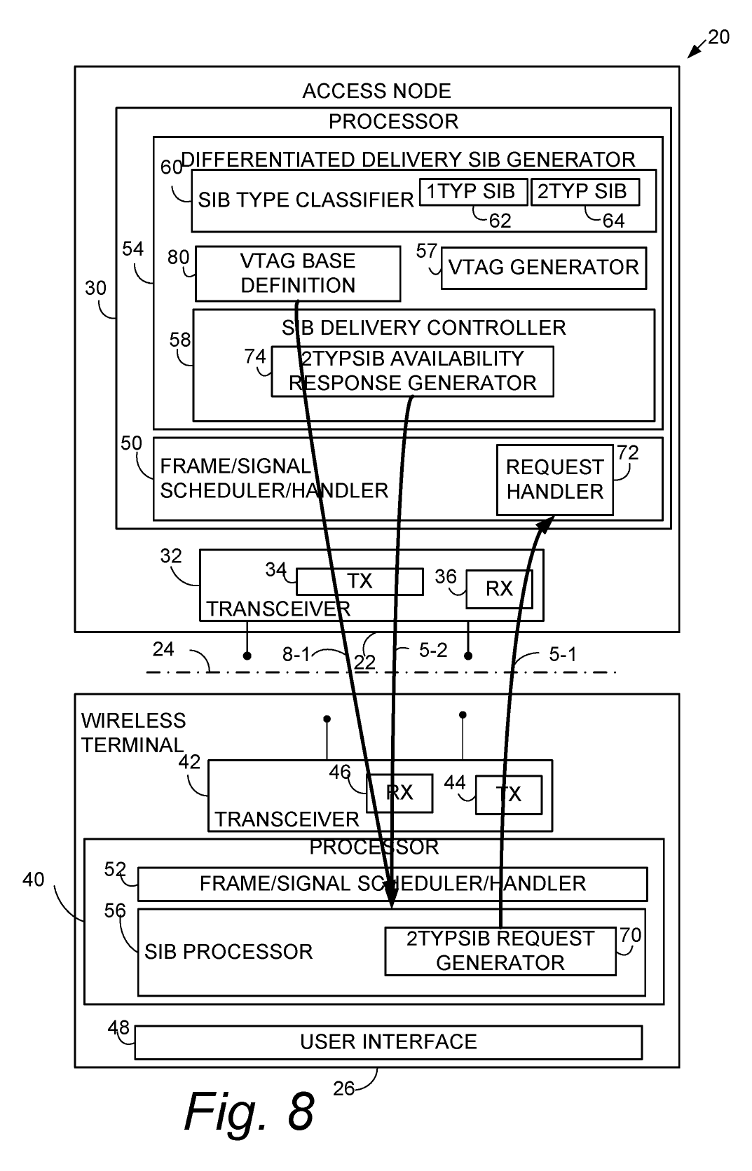

FIG. 6 shows an exemplary message flow for the embodiment of FIG. 5. In the FIG. 6 message flow, when a wireless terminal enters the coverage area of the radio access node 22, the wireless terminal first receives from the radio access node 22 the Essential System Information (i.e., first type of system information (1TYP SIB), and in particular receives Essential System Information periodically broadcasted in messages containing the essential SIB(s) as information elements. The periodic broadcast by the radio access node 22 of the Essential System Information is shown by messages 6-1a and 6-1b of FIG. 6, it being understood (in FIG. 6 and other similar drawings) that there may be one, two, or more than two such broadcast messages. An example Essential System Information message for the FIG. 5 embodiment and mode is shown in FIG. 7 and hereinafter described.

As shown in FIG. 7, the Essential System Information message may comprise a nonEssentialSIBInfo information element with the identification of the non-essential SIBs. If the nonEssentialSIBInfo information element is not present in the message, or if the information element is present but the list is empty, the wireless terminal assumes that there is no second type system information available from this access node 22.

Upon receiving the Essential System Information, i.e., the first type of system information (1TYP SIB), the wireless terminal 26 initiates the system access procedure by sending an Access Request message 6-2, which is acknowledged by radio access node 22 with an Access Response message 6-3. Following the system access procedure (comprised of the acts just described), the wireless terminal 26 sends a Non-essential System Information Request message 6-4 to radio access node 22. The Non-essential System Information Request message 6-4 may be generated by 2TYP SIG request generator 70 of FIG. 5, and may include an indication of one or more pieces of second type of system information (2TYP SIB), e.g., one or more SIB numbers (SIB#), that the wireless terminal 26 desires. Such indication of desired SIB# may be expressed in an information element of the Non-essential System Information Request message 6-4. The Non-essential System Information Request message 6-4 may be sent using uplink dedicated resources (e.g., radio resources of a frame).

In response to the Non-essential System Information Request message 6-4, the radio access node 22 may send Non-essential System Information Response message 6-5 using the downlink dedicated resources. The Non-essential System Information Response message 6-5 comprises the requested SIB#n (e.g., the SIB#n requested by the wireless terminal 26). The requested SIB#n may be included in an information element of the Non-essential System Information Response message 6-5. Afterwards, when the wireless terminal 26 has successfully obtained the requested SIB#n from the Non-essential System Information Response message 6-5, the wireless terminal 26 may send to the radio access node 22 a Non-essential System Information Completion message 6-6, at which point the radio access node 22 may release the uplink/downlink dedicated resources. Alternatively, the radio access node 22 may release the uplink/downlink dedicated resources after sending Non-essential System Information Response message 6-5.

An example Essential System Information message for the FIG. 5 embodiment and mode is shown in FIG. 7. In the embodiment and mode of FIG. 5 and FIG. 6, one or more and preferably a non-essential (e.g., second type) SIB is associated with a value tag that uniquely identifies a specific version of content for that SIB. When broadcasting Essential System Information message, the radio access node 22 of FIG. 5 includes the value tags for the latest contents of non-essential SIBs. Further, the value tag changes when any configuration parameters in the corresponding SIB get updated. In one example implementation, the value tag is incremented by one upon the SIB update. Other types of modifications, e.g., decrementation, version prefixes or suffixes, may be employed.

FIG. 7 shows an example format of the Essential System Information message, wherein the nonEssentialSIBInfo information element each sibId is paired with valueTag, the value tag of the corresponding non-essential SIB. Thus, in an example implementation, the node-available system information message NASIM 59 may be an Essential System Information message as shown in FIG. 7. FIG. 7 particularly shows that the Essential System Information message may also, when functioning as the node-available system information message NASIM 59, include an information element specifying what non-essential SIBs are available at this radio access node 22 upon request. FIG. 7 shows the essentialSysteminformation information element carrying at least one essential SIB and a nonEssentialSIBInfo information element may include a list of identifiers (sibId's) for such available non-essential SIBs. In addition, for one or more and preferably each non-essential SIBs a value tag is provided in the nonEssentialSIBInfo information element.

FIG. 7 also shows that Essential SIB(s) may be also associated with at least one value tag, which is different from the ones for non-essential SIBs, and may be conveyed as a part of the Essential System Information message.

In certain example embodiments and modes, the value tag of a non-essential SIB may be valid within one radio access node 22, e.g., valid within a coverage area or cell served by the radio access node 22. But in other example embodiments and modes, the value tag may have collective applicability, e.g., be capable of expressing a value for more than one cell, for more than one piece of system information (e.g., more than one SIB), etc. In other words, the applicable “base” of the value tag, the information to which the value tag pertains, may be selectively defined in terms of various factors such as area, number of SIBs, and so forth.

In the above regard, in an example embodiment and mode shown in FIG. 8, the system information (SI) generator 54 includes not only the value tag generator 57, but also logic, memory, or controller for a value tag base definition 80. In an example implementation, for example, the value tag base definition 80 may specify that the value tag is valid in at least one geographical area comprising plurality of radio access nodes. Thus, the node processor 30 may generate the value tag to be valid in a geographical area served by the access node and a group of at least one other access node. In such example implementation, the value tag base definition 80, or value tag “validity area”, may be separately signaled from the radio access nodes to the wireless terminals in their respective coverage areas. That is, the node processor 30 may generate a signal (such as signal 8-1 of FIG. 8) to define the group of other access nodes.

Thus, in the FIG. 8 embodiment and mode, a wireless terminal may consider a non-essential system information, a second type SIB, to be “current” if (1) it was received in the validity area of the radio access node upon which the wireless terminal is camping; (2) the value tag of the received non-essential SIB is the same as the one that the camped radio access node is currently advertising in the Essential System Information message, and (3) it was received within a pre-determined or network-configured time period from the present time.

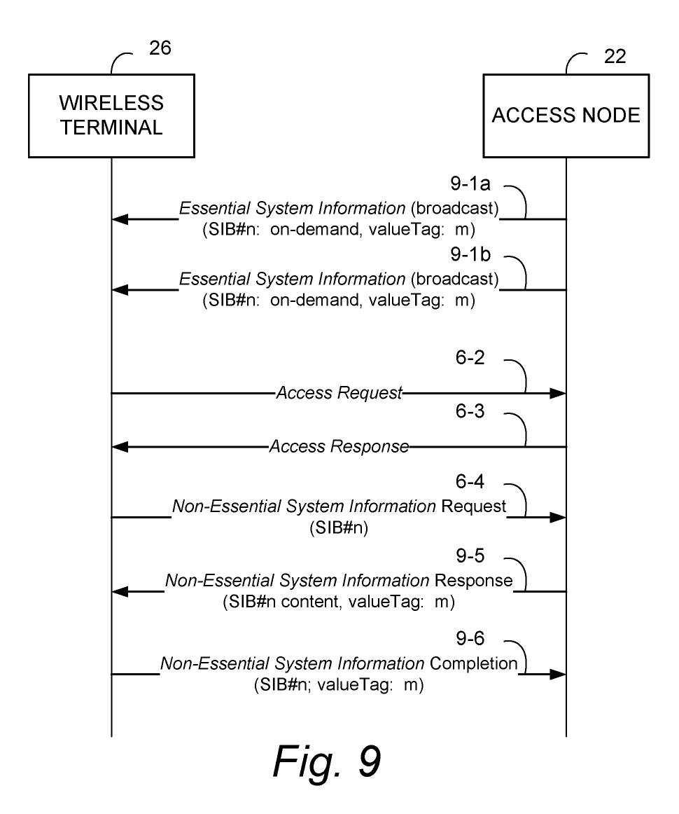

FIG. 9 shows an example message flow for the example embodiment and mode of FIG. 8. In the example embodiment and mode of FIG. 8 it is assumed that the wireless terminal 26 makes an on-demand request for second type system information (SI). Accordingly, in FIG. 9, the Essential System Information messages 9-1a and 9-1b are indicated as being “SIB#n: on-demand”. Further, as explained above, the Essential System Information messages 9-1a and 9-1b may include the value tag (“valueTag: m”). After receiving the Essential System Information, the wireless terminal 26 may perform an access procedure comprising Access Request message 6-2 and Access Response message 6-3.

In the FIG. 9 scenario the wireless terminal 26 may not need to take further action respecting the second type of system information if the wireless terminal 26 has previously received the SIB#n and the value tag for the previously-received SIB#n as stored at the wireless terminal 26 is current (e.g., is “m”). Otherwise, if the wireless terminal 26 has a value tag for the SIB#n which is older than “m”, the wireless terminal 26 may proceed to request the SIB#n transmission using the Non-Essential System Information Request message 6-4, in a manner similar to that described in a previous embodiment.

Thus, in the example embodiment and mode of FIG. 8 and FIG. 9, the Non-essential System Information Response message and/or Non-essential System Information Completion message may contain the value tag with the current value (valueTag=m).

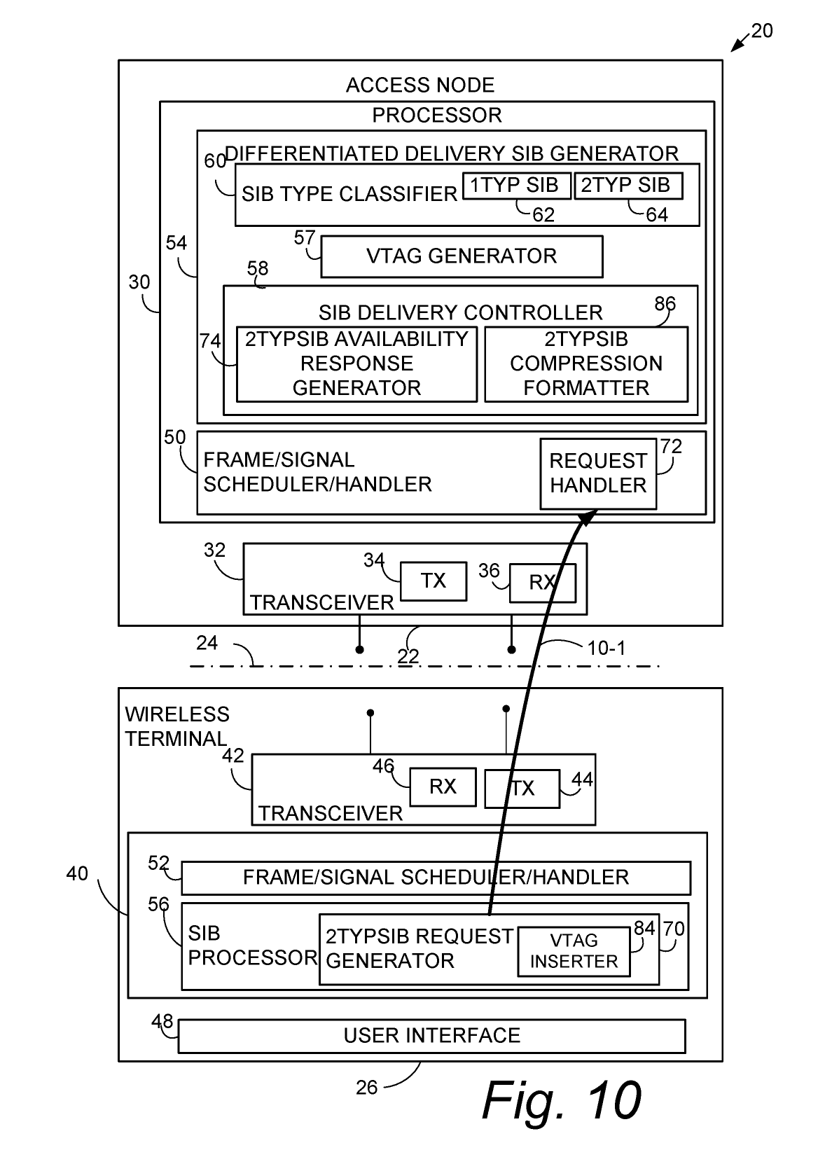

In an example embodiment and mode shown in FIG. 10, the wireless terminal 26 may optionally include in request message 10-1 (requesting the second type system information) the stored values tags of the requested second type system information. This may occur in a situation in which the wireless terminal 26 already has stored values for the second type system information and already has stored value tags for the stored second type system information, but the wireless terminal 26 does not know if the stored second type system information is or is not truly current in terms of network usage for each of the stored SIBs of the second type system information. The wireless terminal 26 may request second type system information for plural different second type system information SIBs, and the plural second type system information SIBs may each have different value tags.

In the example embodiment and mode of FIG. 10, the wireless terminal 26 comprises value tag inserter functionality 84, which includes in the request message 10-1 the stored value tag for the second type system information already stored at wireless terminal 26. Moreover, as understood below, the radio access node 22 and SIB delivery controller 58 in particular may comprise a compression formatter for the second type system information, e.g., 2TYPSIB compression formatter 86.

Thus, the FIG. 10 example embodiment and mode is similar to the embodiment and mode of FIG. 8, but the wireless terminal 26 may optionally include in the Non-essential System Information Request message 10-1 the value tags of the requested non-essential SIBs, where the wireless terminal 26 obtained those value tags when it previously received the corresponding non-essential SIBS.

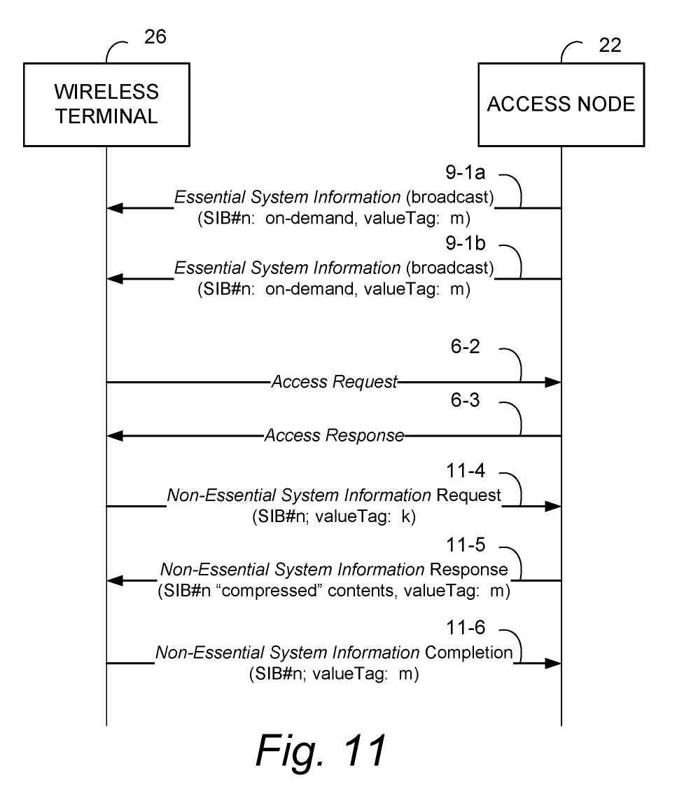

An exemplary scenario of the FIG. 10 embodiment and mode is illustrated in the message flow of FIG. 11. FIG. 11 shows, by the Non-essential System Information Request message 11-4 (which corresponds to message 10-1 of FIG. 10), that valueTag=k for its requested SIB#n. Based on this received value tag, the radio access node 22 and the 2TYPSIB compression formatter 86 in particular may compose “compressed” content of the SIB#n to be delivered via Non-essential System Information Response message 11-5.

In one example implementation of FIG. 10 and FIG. 11, the compressed content comprises the differences between the current SIB#n (valueTag=m) and the previously transmitted (valueTag=k). For example, if SIB#n consists of parameters p1 to p10 and if only p3 and p7 have been updated (if the radio access node 22 has newer values only for parameters P3 and p7 of second type system information), the compressed content of the Non-essential System Information Response message 11-5 may include only p3 and p7 with updated values.

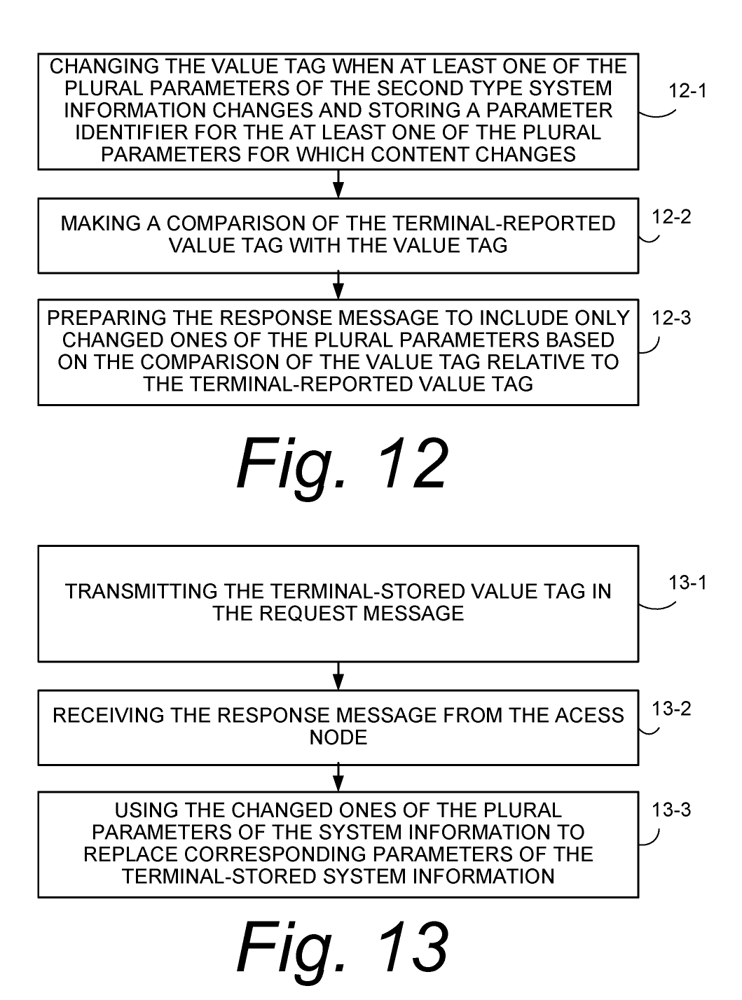

Thus the example embodiment and mode of FIG. 10 and FIG. 11 is particularly but not exclusively applicable to situations in which the second type system information comprises plural parameters and the receiver is configured to receive a wireless terminal-reported value tag in the request message. Basic example acts performed by radio access node 22 in conjunction with the example embodiment and mode of FIG. 10 and FIG. 11 are shown in FIG. 12. Act 12-1 comprises the node processor 30 (and system information (SI) generator 54 in particular) changing the value tag when at least one of the plural parameters of the second type system information changes and to store a parameter identifier for the at least one of the plural parameters for which content changes. Act 12-2 comprises making a comparison of the terminal-reported value tag (e.g., the value tag reported in the request message 10-1) with the value tag (the changed value tag). Act 12-3 comprises preparing the response message (e.g., the Non-essential System Information Response message 11-5) to include only changed ones of the plural parameters based on the comparison of the value tag relative to the terminal-reported value tag.

In some cases, the radio access node 22 may have an option to send the non-compressed versions of the requested non-essential SIBs even if the Non-essential System Information Request message contains value tags. One example of such cases is where the radio access node 22 no longer stores the contents of the previously transmitted non-essential SIBs indicated by the received value tags.

Basic example acts performed by wireless terminal 26 in conjunction with the example embodiment and mode of FIG. 10 and FIG. 11 are shown in FIG. 13. Act 13-1 comprises the wireless terminal 26 transmitting the terminal-stored value tag in the request message (e.g., in message 11-4). Act 13-2 comprises the wireless terminal 26 receiving the response message (e.g., message 11-5) from the access node. As mentioned above, the response message includes changed ones of the plural parameters based on a comparison at the access node of the node-reported value tag relative to the terminal-stored value tag. Act 13-3 comprises the wireless terminal 26 using the changed ones of the plural parameters of the system information to replace corresponding parameters of the terminal-stored system information.

In the above regard, the wireless terminal 26 may construct the entire SIB#n using the received compressed content and the content of SIB#n saved in its memory. In the example described above, the wireless terminal 26 may overwrite saved p3 and p7 with the ones received in the compressed content. The UE further updates the saved value tag for SIB#n to valueTag=m.

In typical deployments, the content of system information is stable and even if it has some updates whose updates are generally minor. By the approach described in the example embodiment of FIG. 10 and FIG. 11, it is possible to reduce the data size of the Non-essential System Information Response message.

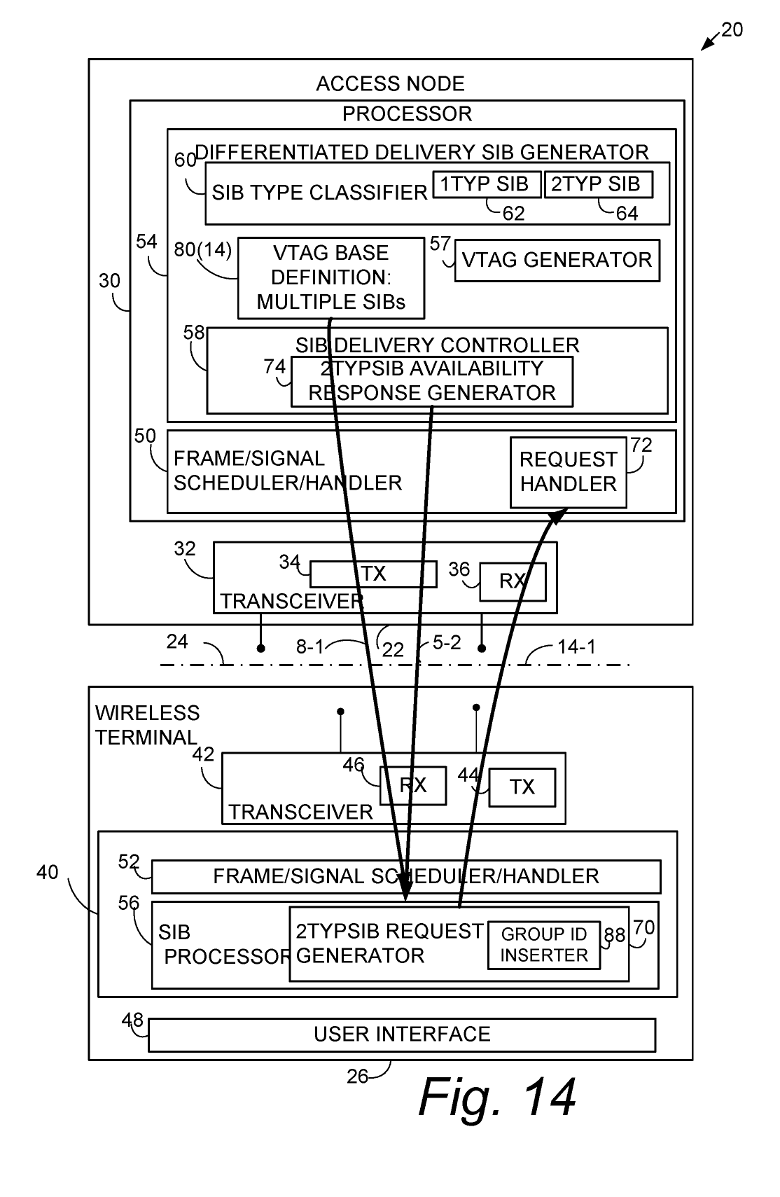

The example embodiment and mode of FIG. 14 is similar to the embodiment and mode of FIG. 8, but differs in that a value tag may represent a value or version for an aggregation of multiple non-essential SIBs, e.g., a group of second type system information blocks. In particular, the value tag base definition 80(14) of the embodiment and mode of FIG. 14 defines multiple sibIds associated with one valueTag to thereby form a non-essential or second type system information SIB “group”. Thus, in the FIG. 14 embodiment and mode, the node processor 30 generates the value tag to be associated with a group of plural second type system information blocks. The 2TYP SIG request generator 70 of the wireless terminal 26 of FIG. 14 includes a group identifier inserter (“group ID inserter 88”) which includes, in a request message 14-1, an identification of the group of second type system information blocks which are the subject of a second type system information request. The request message 14-1 also may include a value tag associated with the group.

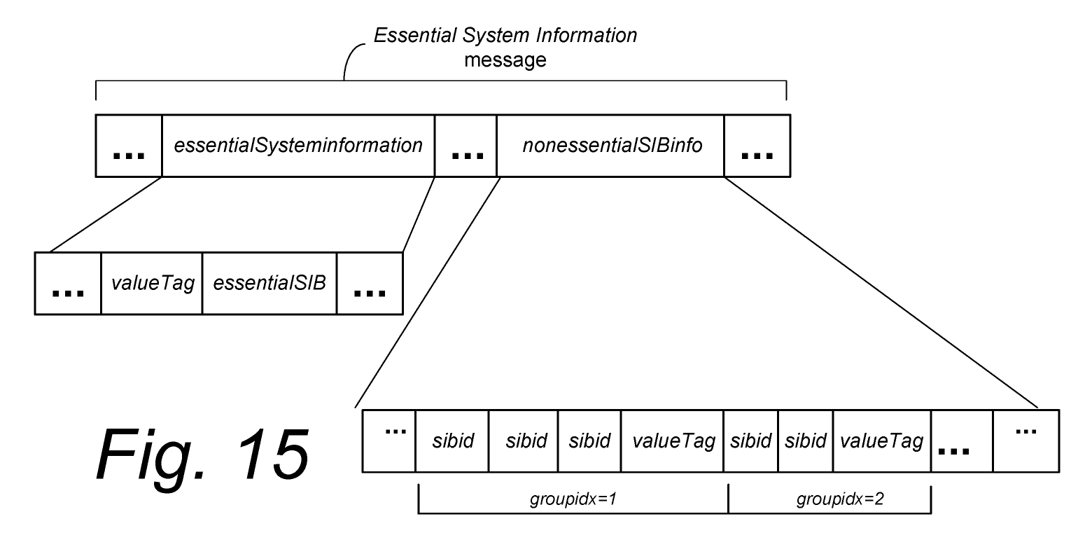

FIG. 15 shows an exemplary format of the Essential System Information message, where multiple sibIds associated with one valueTag forms a non-essential SIB group. The valueTag in each non-essential SIB group of this message is updated when the content of at least one non-essential SIB belonging to this group changes. In one configuration, each non-essential SIB group may be associated with groupIdx, an index of the group in the order of occurrence in the nonEssentialSIBInfo.

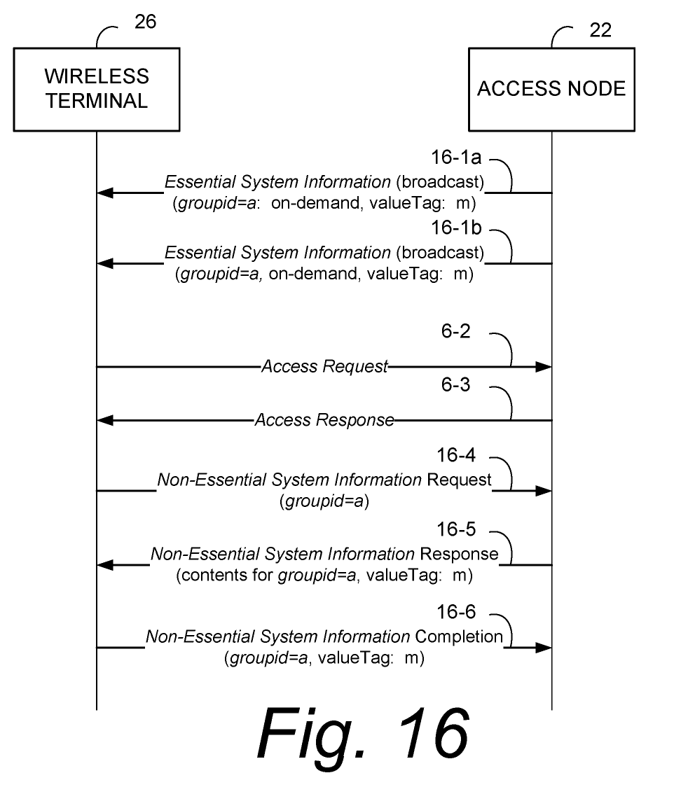

FIG. 16 illustrates an example message flow for the embodiment and mode of FIG. 14. FIG. 14 particular shows Essential System Information messages 16-1a and 16-1b as advertising a non-essential SIB group with groupIdx=a and valueTag=m. The wireless terminal 26, when requesting the contents of the non-essential SIBs belonging to the group, sends to radio access node 22 the Non-essential System Information Request message 16-4 containing groupId=a. In response, the radio access node 22 sends Non-essential System Information Response message 16-4 including the contents of all the non-essential SIBs of the group defined by groupId=a.

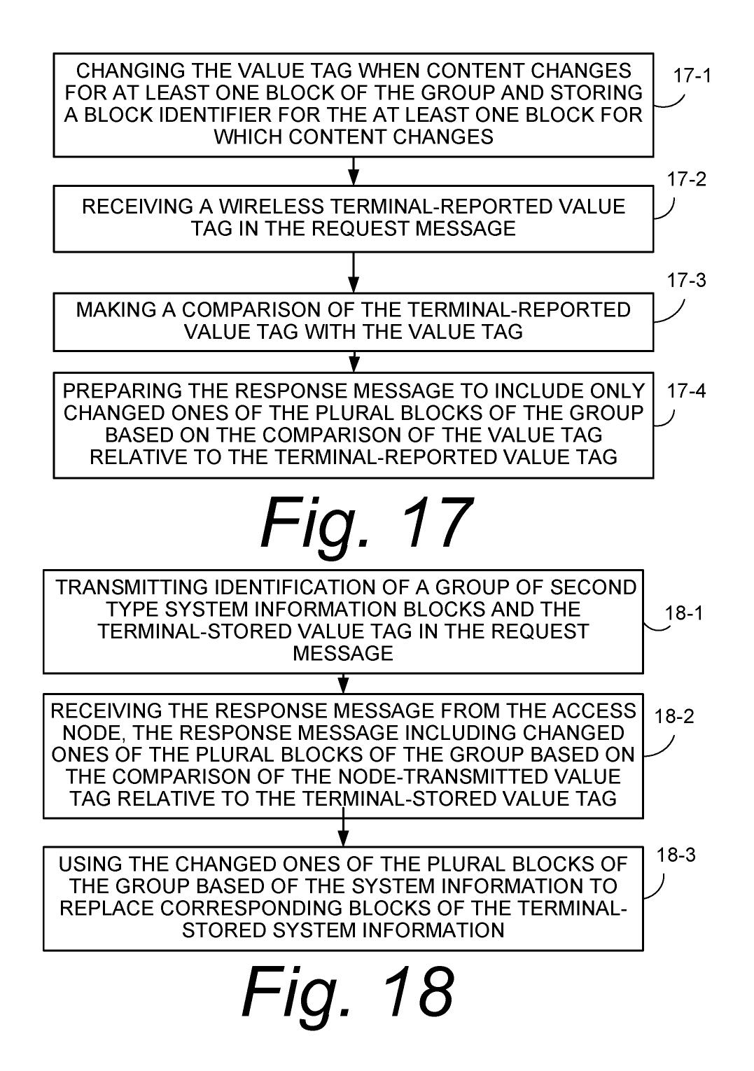

As explained above, the example embodiment and mode of FIG. 14 and FIG. 16 involves, e.g., generating the value tag to be associated with a group of plural second type system information blocks. Basic example acts performed by radio access node 22 in conjunction with the example embodiment and mode of FIG. 14 and FIG. 16 are shown in FIG. 17. Act 17-1 comprises changing the value tag when content changes for at least one block of the group and storing a block identifier for the at least one block for which content changes. Act 17-2 comprises receiving a wireless terminal-reported value tag in the request message. Act 17-3 comprises making a comparison of the terminal-reported value tag with the value tag. Act 17-4 comprises preparing the response message to include only changed ones of the plural blocks of the group based on the comparison of the value tag relative to the terminal-reported value tag.

Basic example acts performed by wireless terminal 26 in conjunction with the example embodiment and mode of FIG. 14 and FIG. 16 are shown in FIG. 18. Act 18-1 comprises transmitting an identification of a group of second type system information blocks and the associated value tag in the request message (e.g., in message 16-4 of FIG. 16). Act 18-2 comprises receiving the response message (e.g., message 16-5 of FIG. 16) from the access node, the response message including changed ones of the plural blocks of the group based on the comparison of the node-transmitted value tag relative to the terminal-stored value tag. Act 18-3 comprises using the changed ones of the plural blocks of the group based of the system information to replace corresponding blocks of the terminal-stored system information.

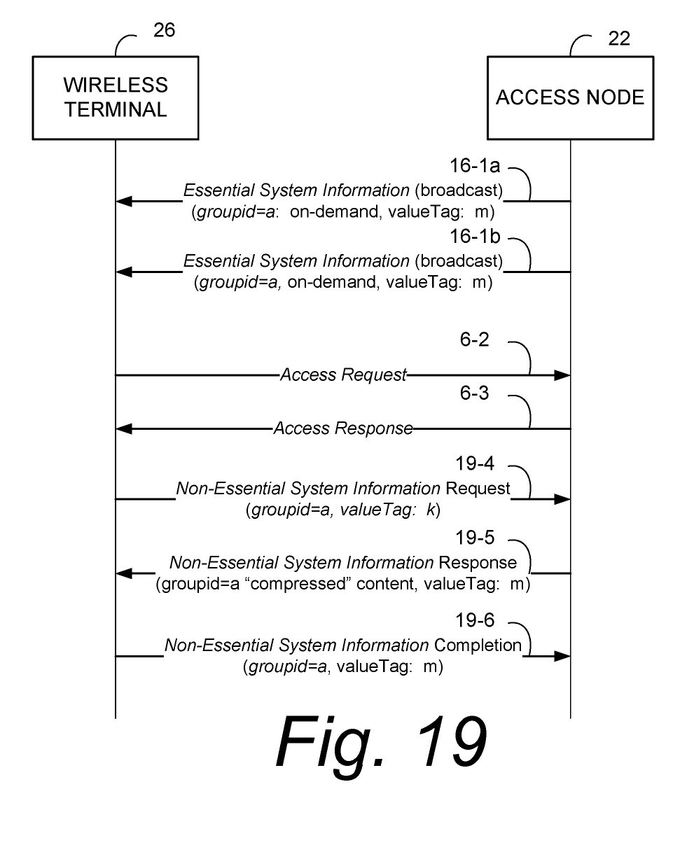

Another example embodiment and mode, having message flow represented by FIG. 19, is based on the combination of the content compression method disclosed in the embodiment of FIG. 10 and the concept of non-essential SIB group described in the embodiment of FIG. 14. In the message flow of FIG. 19, the wireless terminal 26 sends Non-essential System Information Request message 19-4 with groupIdx=a, since the value tag that UE saves for this non-essential SIB group is not current. The Non-essential System Information Response message 19-5 that the radio access node 22 sends in response contains compressed content of the non-essential SIB group. In one implementation, the compressed content comprises the differences between the current non-essential SIBs (value Tag=m) and the previously broadcasted non-essential SIBs(valueTag=k) under the same non-essential SIB group.

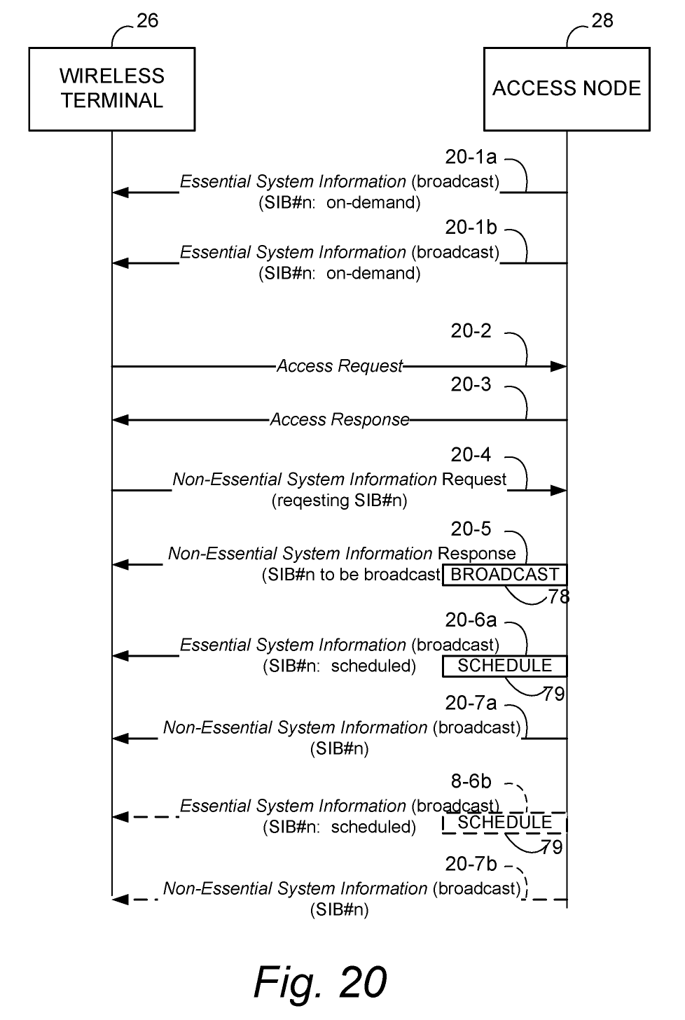

FIG. 20 illustrates another signaling message flow for another example embodiment and mode. The initial messages of FIG. 20 are similar to those of some preceding embodiments and modes, but in FIG. 20 the Non-essential System Information Response message 20-5 includes an information element 78 indicating that the requested SIB#n will be broadcasted instead of unicasted. The radio access node 22, at a subsequent cycle of an Essential System Information message transmission (e.g., at message 20-6a), starts including at least one information element (such as information element 79) for the scheduling information e of SIB#n transmissions. Based on this schedule information, the radio access node 22 broadcasts the Non-essential System Information message 20-7a containing the requested SIB#n. As indicated by the messages depicted in broken lines in FIG. 20, the radio access node 22 may repeat these two steps multiple times for reliable delivery. By receiving at least one of these repetitions, the wireless terminal 26 should successfully obtain the SIB#n. The number of the repetitions may be determined by the radio access node 22, and information indicating the number may be broadcasted together with the essential system information. Alternatively, the number of the repetitions may be determined by the wireless terminal 26 and may be notified to the radio access node 22 through the Non-essential System Information Request message 20-4.

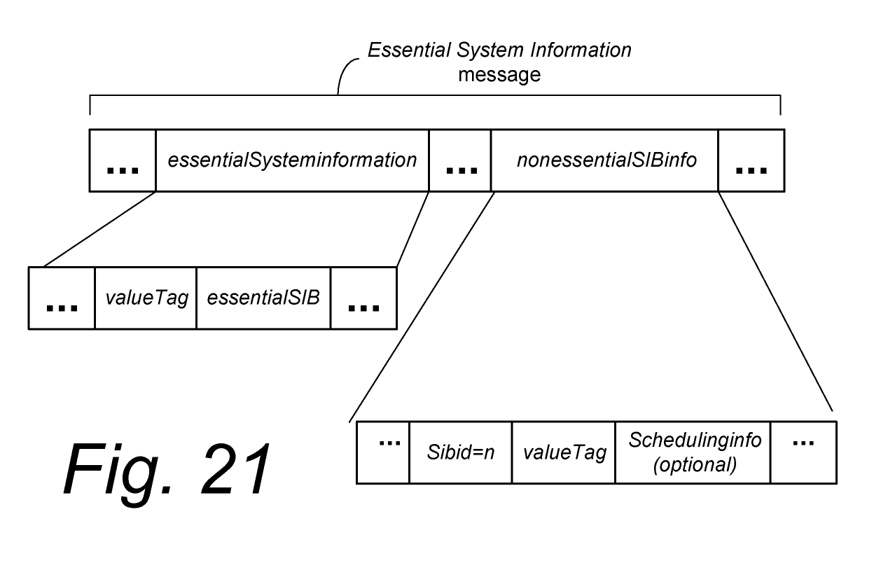

In some implementations of the example embodiment and mode of FIG. 20 the access node 22 may include a value tag(s) in messages, such as in the Essential System Information message(s) 20-6a of FIG. 20. Likewise, in some example implementations the broadcasted Non-essential System Information message(s) 20-7 may comprise a value tag that represents the version of the non-essential SIB(s) delivered by the Non-essential System Information message(s). In this regard, FIG. 21 shows one exemplary format of the Essential System Information with the scheduling information, where the SchedulingInfo optional information element is used for indicating the broadcast schedules for Non-essential System Information message with the updated SIB#n content.

A benefit of the FIG. 20 embodiment and mode is that the requested SIB#n may also be received by other wireless terminals entering the same coverage area. Such wireless terminals may receive the Essential System Information message 20-6 and know that the SIB#n is scheduled to be transmitted. As a result, the number of transmissions for Non-essential System Information Request message 20-4 may be reduced. An additional benefit is that the transmissions of messages 20-2 and 20-3 may also be reduced.

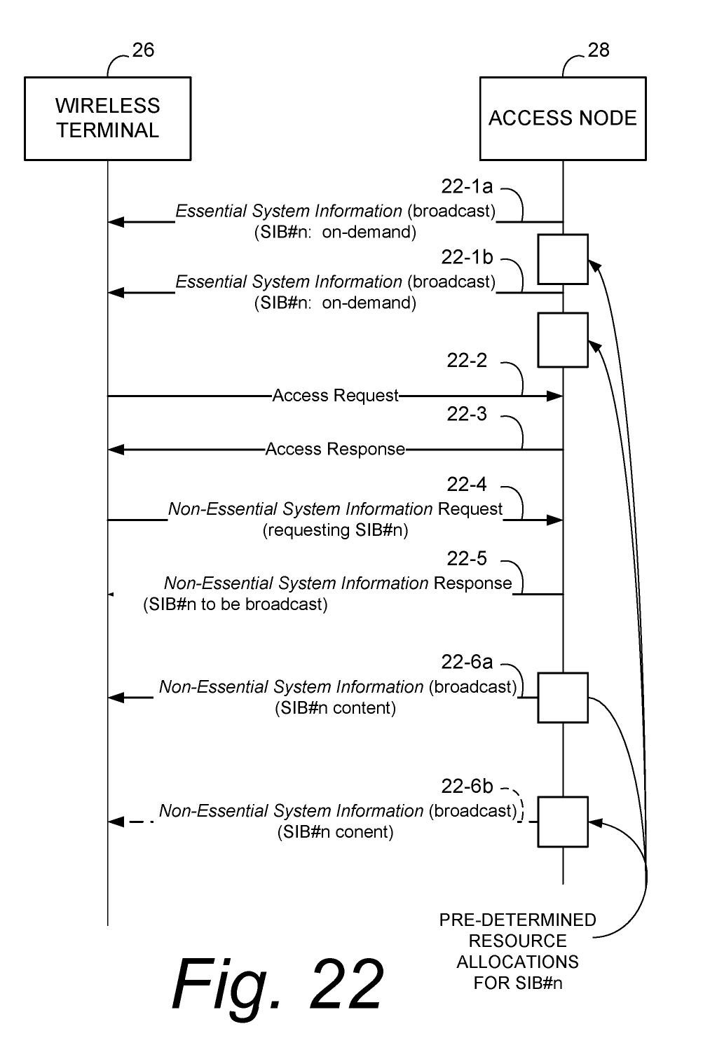

FIG. 22 illustrates yet another signaling message flow for another example embodiment and mode. The initial messages of FIG. 22 are similar to those of some preceding embodiments and modes, but in FIG. 22 the broadcasts of SIB#n in the Non-essential System Information message(s) 22-6 occur on pre-determined resource allocations. For example, the pre-determined resource allocations may be defined by using a periodicity and/or an offset. The radio access node 22 may optionally repeat sending Non-essential System Information messages 22-6 at multiple occasions. The wireless terminal 26 that has sent a Non-essential System Information Request message 22-4, requesting the SIB#n, may receive Non-essential System Information on at least one pre-determined radio resource allocation, without receiving an Essential System Information message. The radio access node 22 may use these allocated resources for other purposes if it does not transmit SIB#n.

In the FIG. 22 embodiment and mode, any other wireless terminal entering the coverage first receives the Essential System Information message 22-1, then it may monitor pre-determined resources for several times before sending Non-essential System Information Request message 22-4, in order to suppress unnecessary transmissions of Non-essential System Information Request message. The number of monitoring trials may be pre-determined, or may be configured by the Essential System Information message.

In addition, in the FIG. 22 embodiment and mode the pre-determined resource allocations can be configurable by including the information of allocations in Essential System Information message 22-1. The pre-determined resource allocations of a given non-essential SIB may be jointly coded with whether the non-essential SIB is available at this radio access node by request. Alternatively, the pre-determined resource allocations may be tied to the SIB indices.

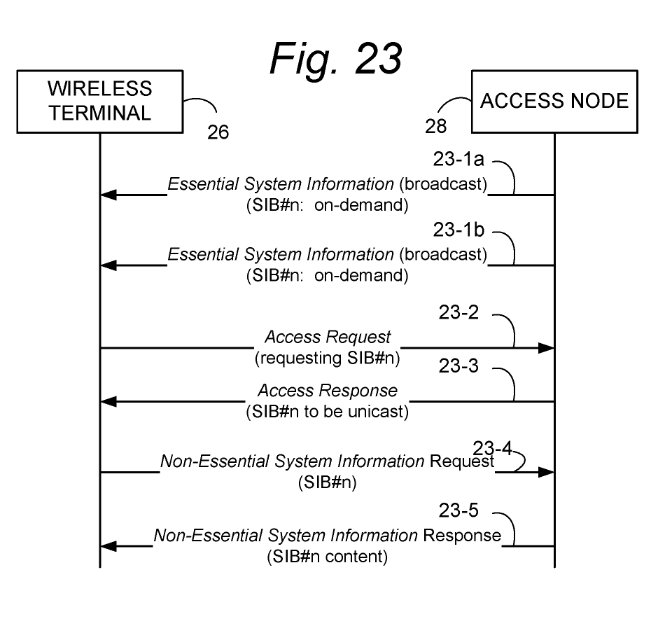

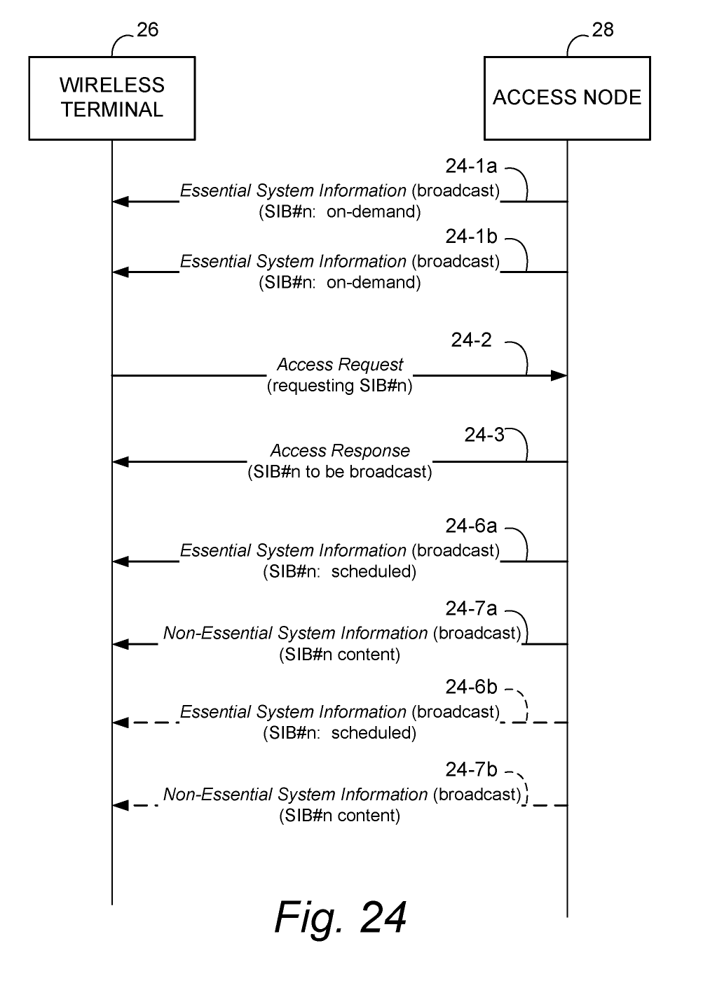

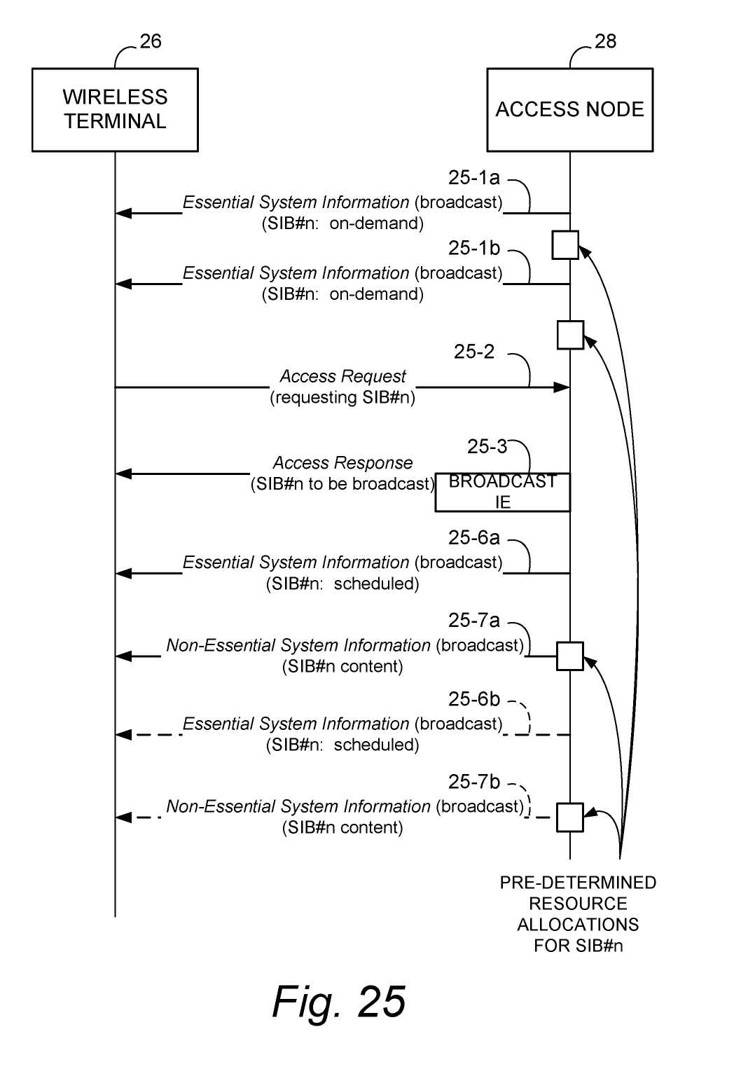

FIG. 23 illustrates yet another signaling message flow for another example embodiment and mode. In FIG. 23, the Access Request message(s) 23-2 now contain(s) a request for the SIB#n broadcast. The radio access node that receives the request may decide to deliver the SIB#n by unicast, or by broadcast. In case of unicast, it includes an information element of unicast indication for SIB#n in Access Response message 23-3, as shown in FIG. 23. Otherwise, the radio access node includes an information element of a broadcast indication for SIB#n in Access Response message 24-3, as shown in FIG. 24. An alternative approach to FIG. 24 is shown in FIG. 25, where Non-essential System Information message 25-5 is broadcasted on pre-determined resource allocations.

Further information regarding the technology disclosed herein, including but not limited to the example embodiments and modes of FIG. 20-FIG. 25, is provided in related U.S. Provisional Application 15/658,980, entitled “ON-DEMAND SYSTEM INFORMATION FOR WIRELESS TELECOMMUNICATIONS”, filed on Jul. 25, 2017.

In certain example embodiments and modes described above, if the access node 22 updates the content of a non-essential SIB, a new value of the value tag for the SIB will be used, e.g., in the Essential System Information message. In one example implementation, the value tag may be incremented (e.g., incremented by one). The wireless terminals under the coverage of the access node 22 may (1) eventually receive the message with the new value tag, (2) find out that the previously received SIB becomes obsolete, and (3) decide to send a Non-essential System Information Request message to the access node 22.

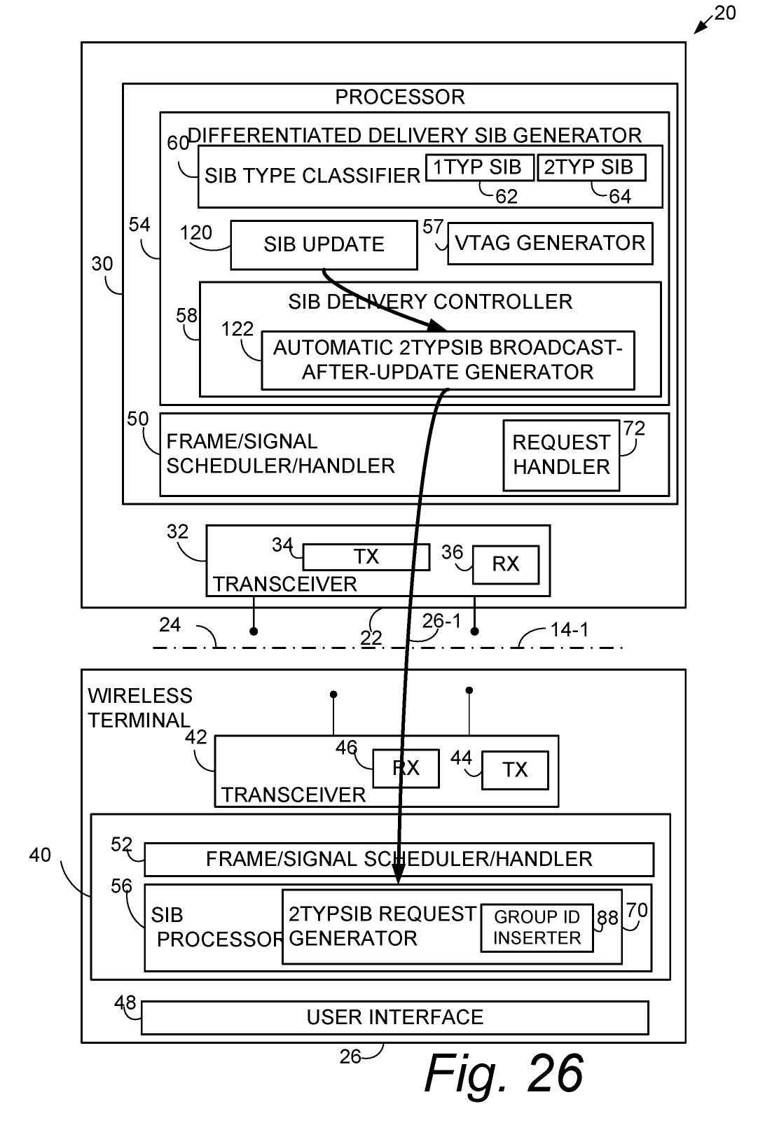

FIG. 26 illustrates certain example embodiments and modes which seek to avoid congestion that may occur if many Non-essential System Information Request messages are transmitted from wireless terminals. In particular, the example embodiment and mode of FIG. 26 allows the access node 22 to broadcast the new content of the non-essential SIB for limited times after the SIB update. The broadcast-after-update technology of FIG. 26 may be utilized in conjunction/combination with any other of the example embodiments and modes described herein.

FIG. 26 shows node processor 30, and SIB generator 54 in particular, as comprising SIB update functionality 120. The SIB update functionality 120 either updates/changes the second type system information or detects an update or change in the second type system information. The SIB delivery controller 58 comprises automatic second type system information broadcast-after-update generator 122. Whenever there is an update or other change for the second type system information as performed or detected by the SIB update functionality 120, the automatic second type system information broadcast-after-update generator 122 generates broadcast messages 26-1 including the new/updated content of the second type system information. The broadcast messages 26-1 including the new content of the second type system information continue only for a limited time, or a predetermined number of automatic-after-update broadcast messages.

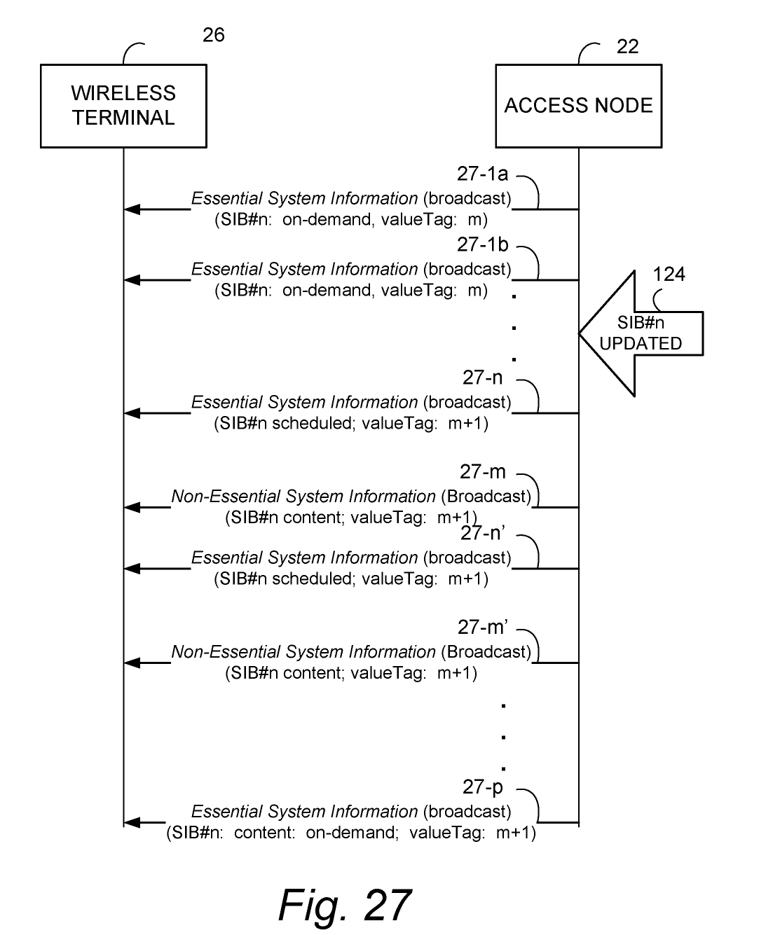

FIG. 27 illustrates a message flow for an example scenario of the example embodiment and mode of FIG. 26. In the example scenario of FIG. 27, as shown by arrow 124 SIB#n gets updated (e.g., by SIB update functionality 120) and its value tag changes from m to m+1. From this moment the access node 22 starts including the new value tag m+1 for SIB#n in the Essential System Information message(s) 27-n. In addition, at least one transmission of said Essential System Information message(s) 27-n after the SIB#n update may include scheduling information to indicate one or plurality of broadcast schedules for the updated SIB#n content. Based on the scheduling information, the access node 22 automatically (e.g., without special on-demand request from wireless terminal 26) broadcasts Non-essential System Information message(s) 27-m including the updated SIB#n content. As indicated by the primed message suffixes in FIG. 27, the access node 22 may optionally transmit Essential System Information message(s) with the scheduling information and the Non-essential System Information message(s) with the SIB#n content multiple times, e.g., for a predetermined time period after the SIB#n update, for example. As further shown in FIG. 27, after the automatic broadcast-after-update messages 27-n and 27-m, the access node 22 may also broadcast the fact that the SIB#n update is available on demand, as indicated by message 27-p.

In the example embodiment and mode of FIG. 26 and FIG. 27, the access node 22 may use the message format shown in FIG. 21 for the Essential System Information message with the scheduling information. The wireless terminals receiving this Essential System Information message may attempt to receive the scheduled Non-essential System Information message, instead of requesting on-demand delivery of the updated SIB#n. Once the scheduled broadcasts of the updated SIB#n content are completed, the wireless terminal may no longer use the optional information element.

Some communication systems may employ discontinuous reception (DRX), where the wireless terminals do not always monitor the periodic transmission of the Essential System Information message. In order to ensure that the wireless terminals under the coverage of the access node receive the automatic broadcast-after-update messages, the system in some implementations may use a separate signaling mechanism to trigger the reception of the Essential System Information message. One example is that the access node includes an indication in the Paging message for predetermined duration before transmitting the Essential System Information message 27-n.

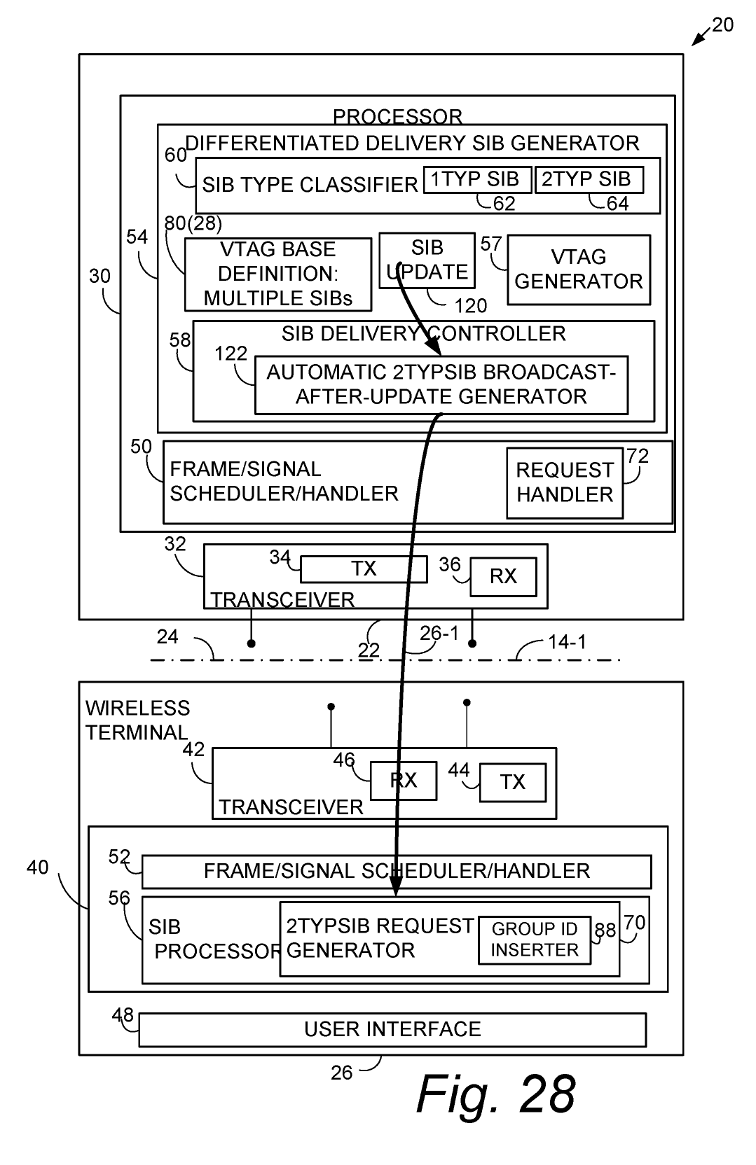

The example embodiment and mode of FIG. 28 is based at least in part on the example embodiment and mode of FIG. 26 and at least in part on the example embodiment and mode of FIG. 14 wherein the access node 22 may employ the concept of non-essential SIB groups. In the FIG. 28 example embodiment and mode, the Non-essential System Information message which is automatically broadcasted after the SIB content update includes the contents of multiple SIBs grouped with the same value tag.

FIG. 28 shows the node processor 30 and the SIB generator 54 in particular as comprising not only the SIB update functionality 120 and the automatic second type system information broadcast-after-update generator 122, but also a value tag base definition logic 80(28) which defines multiple SIB groups associated with the value tag.

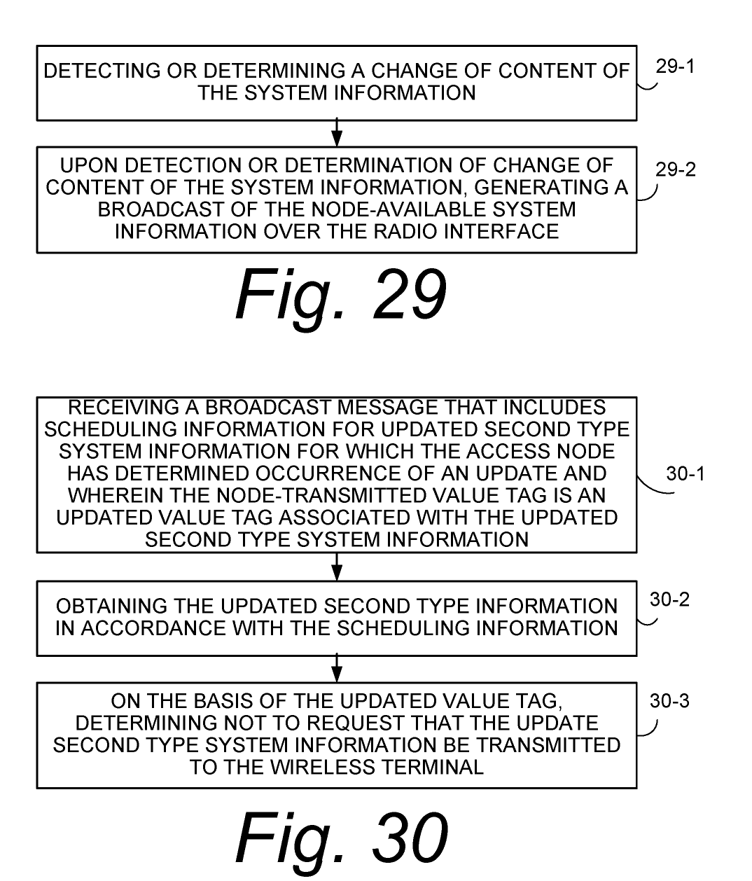

FIG. 29 shows example, representative, basic acts or steps performed by the radio access node 22 of FIG. 28. Act 29-1 comprises detecting or determining a change of content of the system information. Act 29-2 comprises, upon the detection or the determination of change of content of the system information, generating a broadcast of the updated system information over the radio interface. In the example embodiment and mode of FIG. 29, the change of content may be an update of the system information, and the changed or updated system information may in particular be second type system information. Moreover, the broadcast may be broadcast messages which are scheduled, with scheduling information for such broadcast being included in previous broadcast such as a node-available system information message. Such previous broadcast message may be, in at least some embodiments, can be an Essential System Information broadcast message. Moreover, in example implementation, the broadcast of the second type system information over the radio interface may occur only for a predetermined time, e.g., a predetermined number of such broadcasts.

FIG. 30 shows example, representative, basic acts or steps performed by the wireless terminal 26 of FIG. 28. Act 30-1 comprises receiving a broadcast message that includes scheduling information for updated second type system information for which the access node has determined occurrence of an update and wherein the node-transmitted value tag is an updated value tag associated with the updated second type system information. Act 30-2 comprises obtaining the updated second type information in accordance with the scheduling information. Act 30-3 comprises, on the basis of the updated value tag, determining not to request that the update second type system information be transmitted to the wireless terminal.

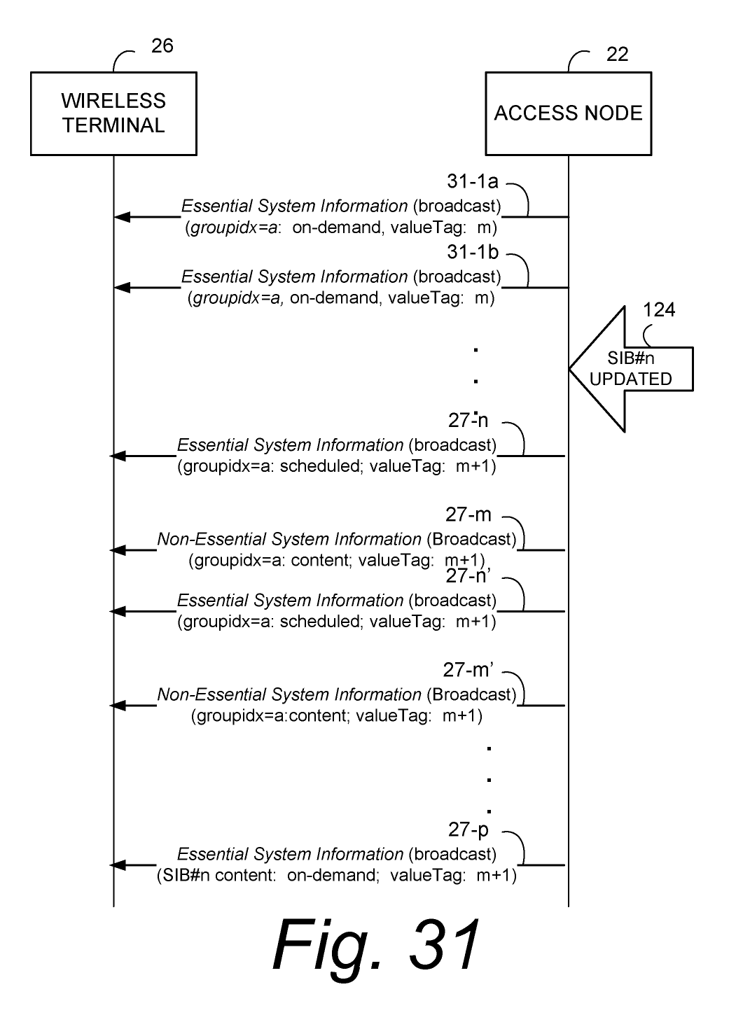

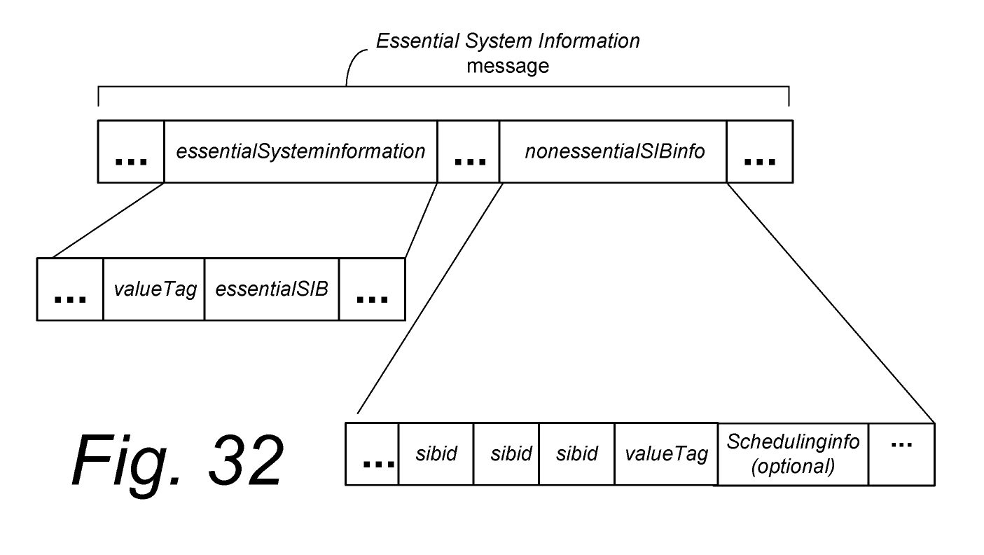

FIG. 31 shows an example of message flow for the example embodiment and mode of FIG. 28; FIG. 32 shows an example message format of the Essential System Information message for example embodiment and mode of FIG. 27 and FIG. 28.

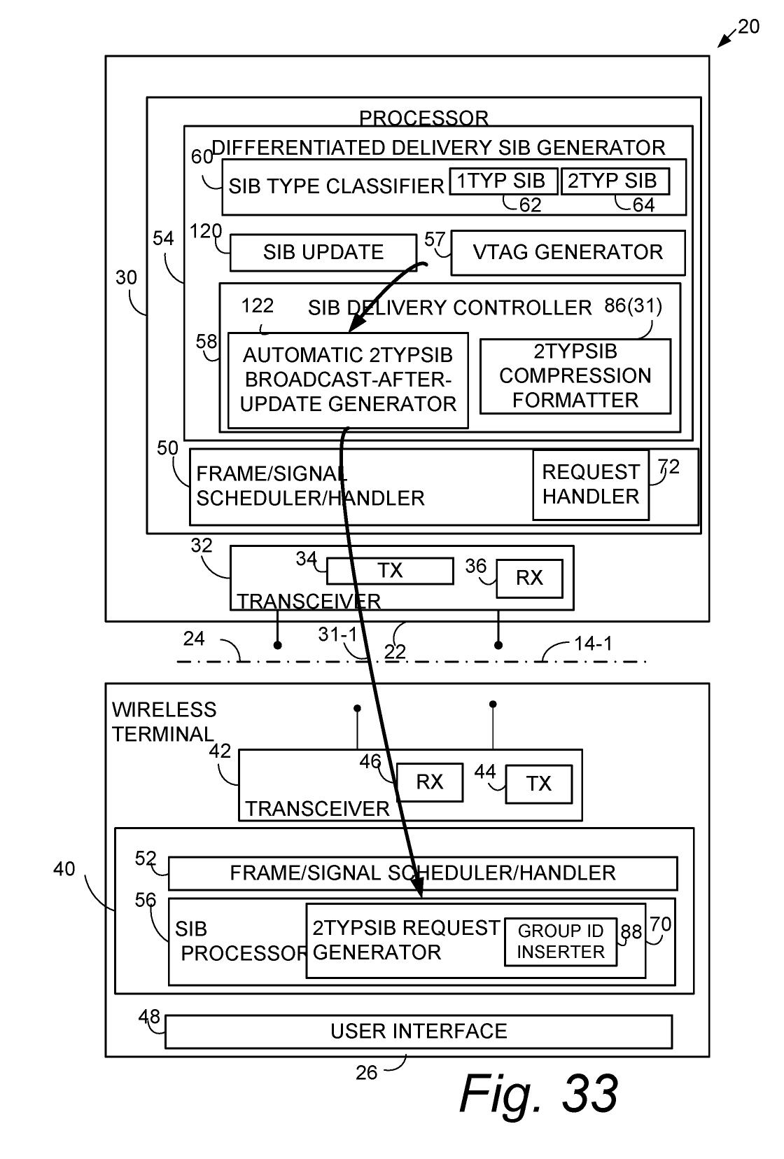

FIG. 33 illustrates certain example embodiments and modes which allow the access node 22 to broadcast a “compressed” image of updated non-essential system information in conjunction with the automatic broadcast-after-update feature. The node processor 30 of access node 22, and the SIB generator 54 in particular, comprise both the SIB update functionality 120 and automatic second type system information broadcast-after-update generator 122, as well as 2TYPSIB compression formatter 86(31). Upon actual update or detection of update of system information by functionality 120, the broadcast-after-update generator 122 generates a compressed SIB broadcast-after-update message 33-1, in which compression is achieved by virtue of 2TYPSIB compression formatter 86(31) preferably including in the SIB broadcast-after-update message 33-1 only those system information parameters of the SIB block which have changed.

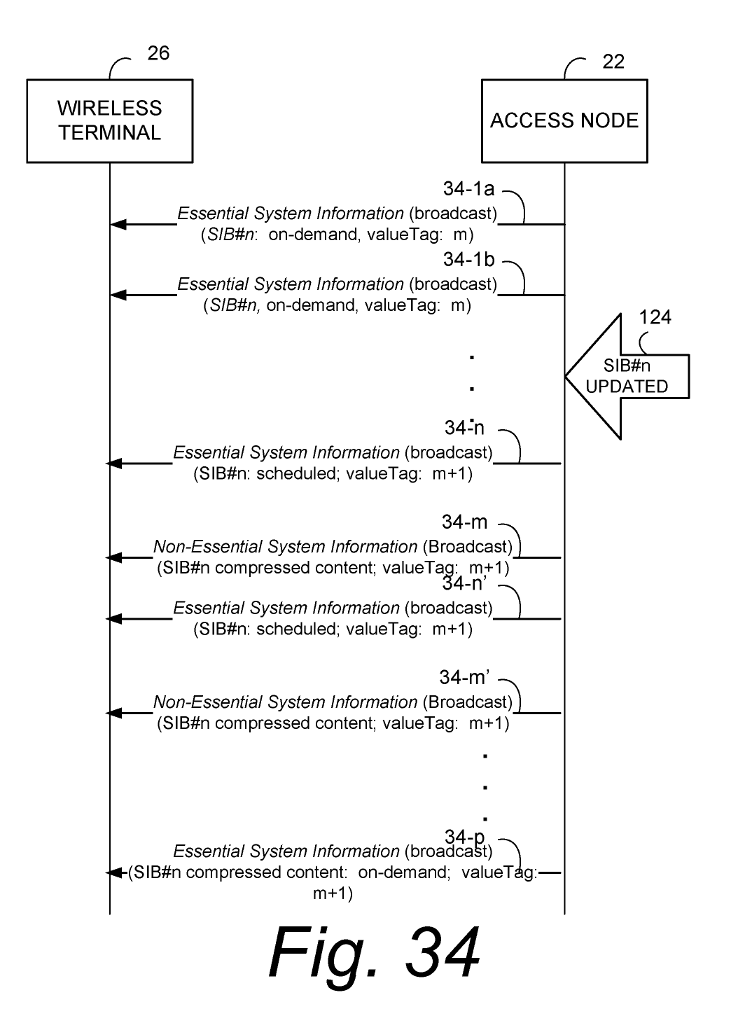

FIG. 34 shows an exemplary message flow for the embodiment and mode of FIG. 33. In FIG. 32, the broadcasted Non-essential System Information message(s) 34-n now include(s) a compressed content of the updated SIB#n with valueTag=m+1. As described in a previous embodiment and mode, in one implementation the compressed content comprises the differences between the updated SIB#n (valueTag=m+1) and the previously transmitted (valueTag=m).

The wireless terminal 26 which receives the broadcasted Non-essential System Information message 34-n with the compressed SIB#n content with valueTag=m+1 checks if it has previously received SIB#n with valueTag=m and has saved the content in its memory. If so, the wireless terminal 26 simply applies the received compressed image to the saved content to construct the updated content. Otherwise, the wireless terminal 26 may initiate an on-demand delivery request of the updated SIB#n content using one or some of the methods already disclosed above.

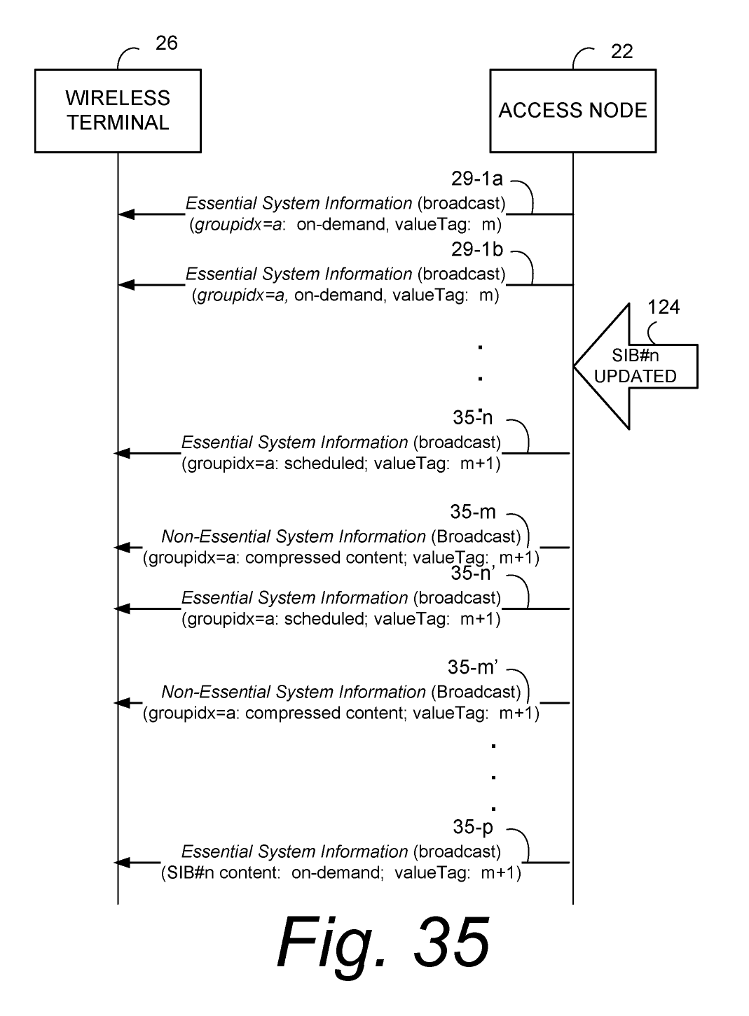

FIG. 35 illustrates an example message flow for certain example embodiments and modes which applies the concept of non-essential SIB groups to the example compression embodiment and mode of FIG. 32 in conjunction with the automatic broadcast-after-update feature. In FIG. 35 the Essential System Information message 35-n advertises one or more groupIdx's, each of which is associated with a value tag valueTag, as disclosed in a previous example embodiment and mode. Similar to a previous example embodiment and mode, the broadcasted Non-essential System Information message 35-m may contain compressed content of the non-essential SIB group. In one implementation, the compressed content comprises the differences between the current non-essential SIBs (valueTag=m+1) and the previously broadcasted (valueTag=m) under the same non-essential SIB group.

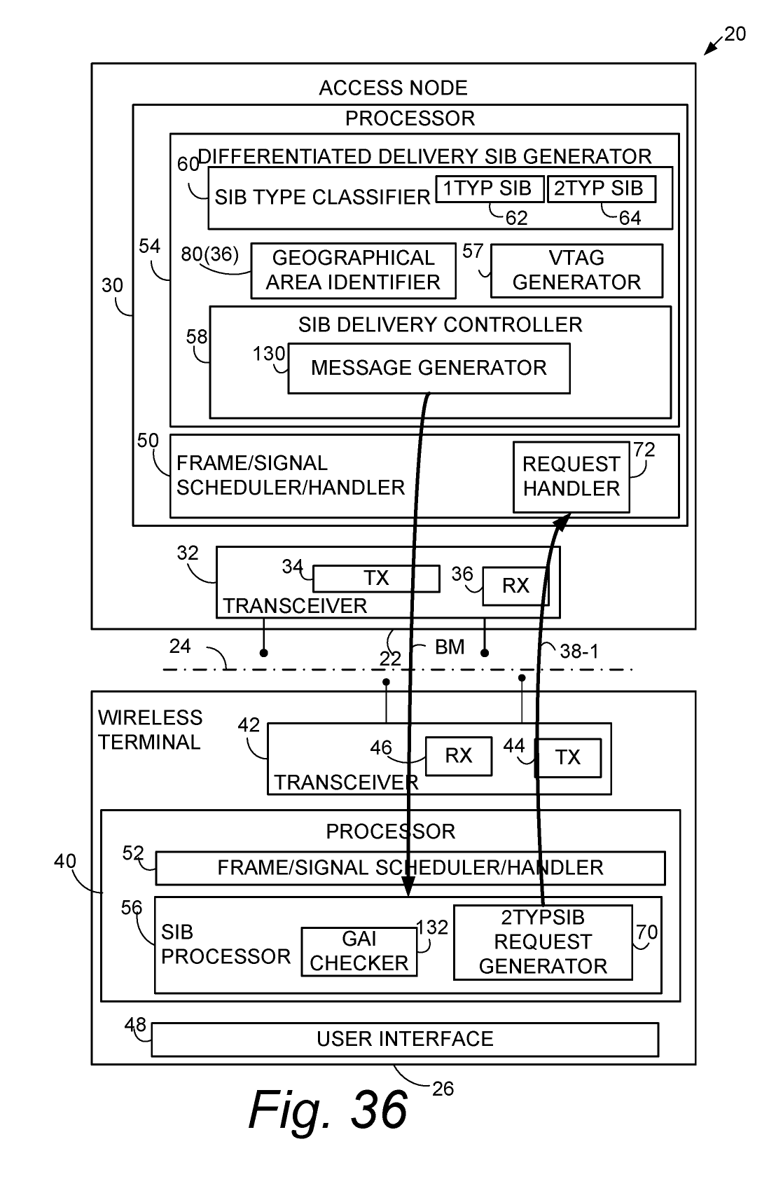

FIG. 36 illustrates certain example embodiments and modes in which a radio access node provides a geographical area identifier which specifies a geographical area for which the value tag is valid. In FIG. 36 the system information (SI) generator 54 includes value tag generator 57 and the value tag base definition takes the form of geographical area identifier (GAI) generator 80(36). The SIB delivery controller 58 of access node 22 includes message generator 130. In the wireless terminal 26 of FIG. 36 the SIB processor 56 includes geographical area identifier (GAI) checker 132.

The node processor 30 of FIG. 36, and the SIB delivery controller 58 in particular, schedules periodic transmission of a broadcast message (BM) to wireless terminal 26. The broadcast message BM of FIG. 36 comprises first type system information; identification of second type system information available from the access node; a value tag associated with the second type system information; and a geographical area identifier (GAI, or areaid). The geographical area identifier specifies a geographical area for which the value tag is valid. It will be recalled that the geographical area may be an area being served by the access node and a group comprising at least one other access node. The broadcast message BM may take the form of the node-available system information message NASIM 59, an example of which is the Essential System Information message as hereinbefore described. The value tag associated with the second type system information may be obtained from value tag generator 57. The geographical area identifier may be obtained from geographical area identifier generator 80(36). In one implementation, the geographical area identifier of a non-essential SIB or the geographical area identifier of a group of non-essential SIBs is pre-configured by a network management entity that coordinates multiple nodes. The node transmitter circuitry 34 transmits the broadcast message BM to the wireless terminal 26.

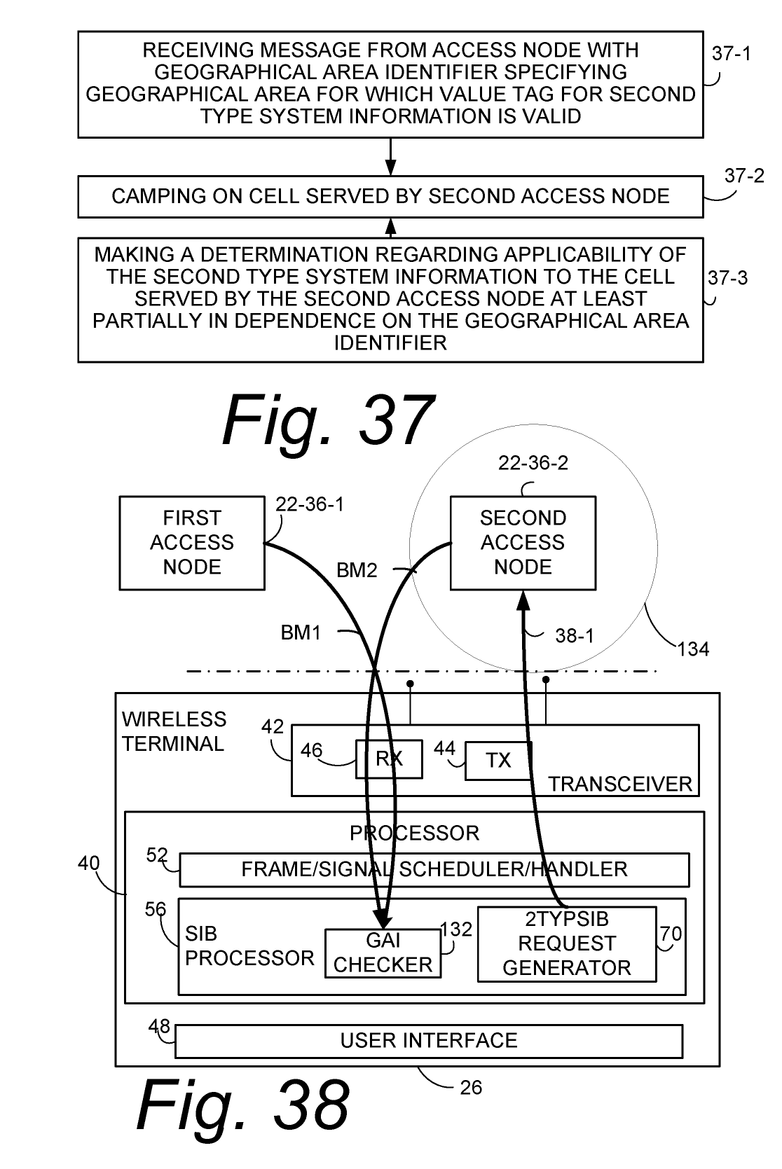

FIG. 37 shows example, representative acts or steps performed by the wireless terminal 26 of FIG. 36, in the context of a simplified depiction of radio access network (RAN) shown in FIG. 38. Act 37-1 comprises receiving a message, such as broadcast message BM, from a first access node (first access node 22-36-1). The message received from the first access node includes: first type system information; second type system information; a value tag associated with the second type system information; a geographical area identifier which specifies a geographical area for which the value tag is valid. Thus, as a result of act 37-1, the wireless terminal 26 of FIG. 36 obtains the content of the first type system information and the content of the second type system information as provided by the first access node 22-36-1.

Act 37-2 of comprises the wireless terminal 26 camping on a cell, such as cell 134 of FIG. 38, served by second access node 22-36-2. Act 37-3 comprises making a determination regarding applicability of the second type system information (obtained from the first access node 22-36-1) to the cell served by the second access node 22-36-2. The determination of act 37-3 is made at least partially in dependence on the geographical area identifier.

As understood from preceding embodiments and modes, the first type system information is periodically broadcasted by the transmitter and is required for initial access to the radio access network, but the second type system information is not required for initial access to the radio access network. Moreover, the node processor 30 may schedule transmission by the transmitter of content of the second type system information over the radio interface separately from the broadcast message which comprises the first type system information.

In the example embodiment and mode of FIG. 36 the terminal processor 40, and geographical area identifier checker 132 in particular, is configured to make the determination based at least partially on membership of the first access node and the second access node to a same geographical area. Membership in the same geographical area may be determined by a comparison of the geographical area identifier received from the first access node and a second geographical area identifier received from the second access node. FIG. 38 shows the first geographical area identifier being received in a first broadcast message BM1 from the first access node 22-36-1 and the second geographical area identifier being received in a second broadcast message BM2 from the first access node 22-36-2.

The terminal processor 40 is configured to use the second type system information received from the first access node 22-36-1 in the cell 134 served by the second access node 22-36-2 when the determination of act 37-3 indicates that the second type system information obtained from the first access node 22-36-1 is applicable to the cell 134 served by the second access node 22-36-2. On the other hand, when the determination of act 37-3 indicates that the second type system information obtained from the first access node is not applicable to the cell served by the second access node, as shown by arrow 38-1 in FIG. 36 and FIG. 38, the wireless terminal 26 requests, from the second access node 22-36-2, the second type system information for use in the cell 134 served by the second access node 22-36-2. The 2TYPSIB request generator 70 of wireless terminal 26 may make the request depicted by arrow 38-1. A 2TYPSIB request handler 72 of the second access node 22-36-2 may handle the request and subsequently supply the second type system information in accordance with any of the aforementioned example embodiments and modes.

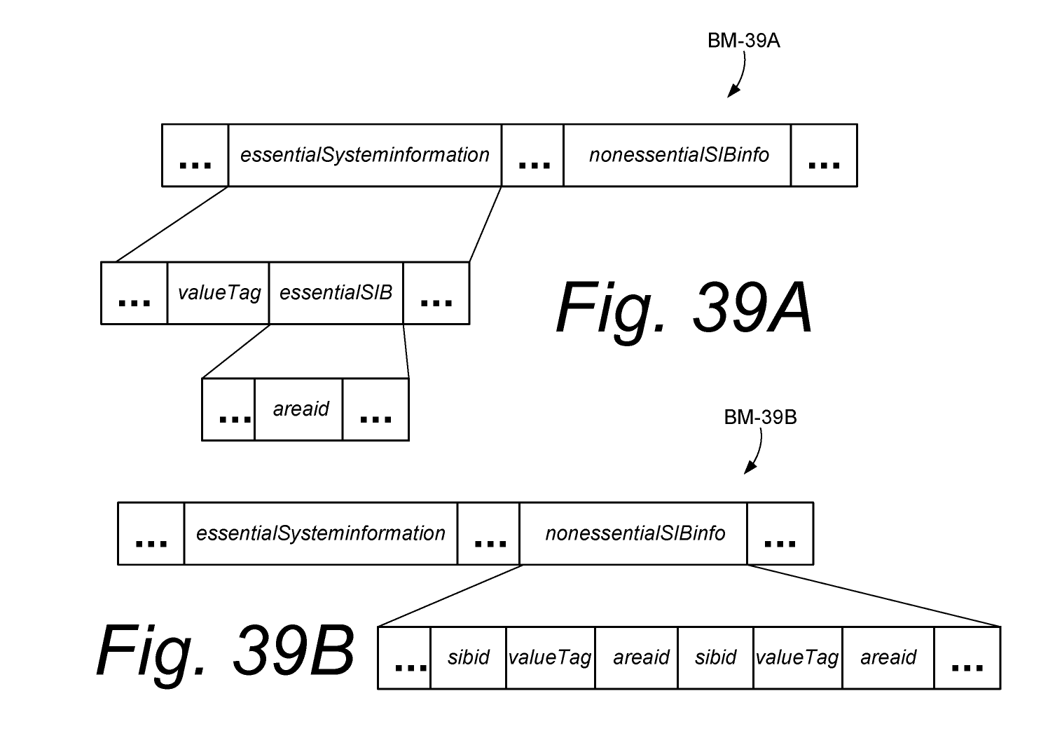

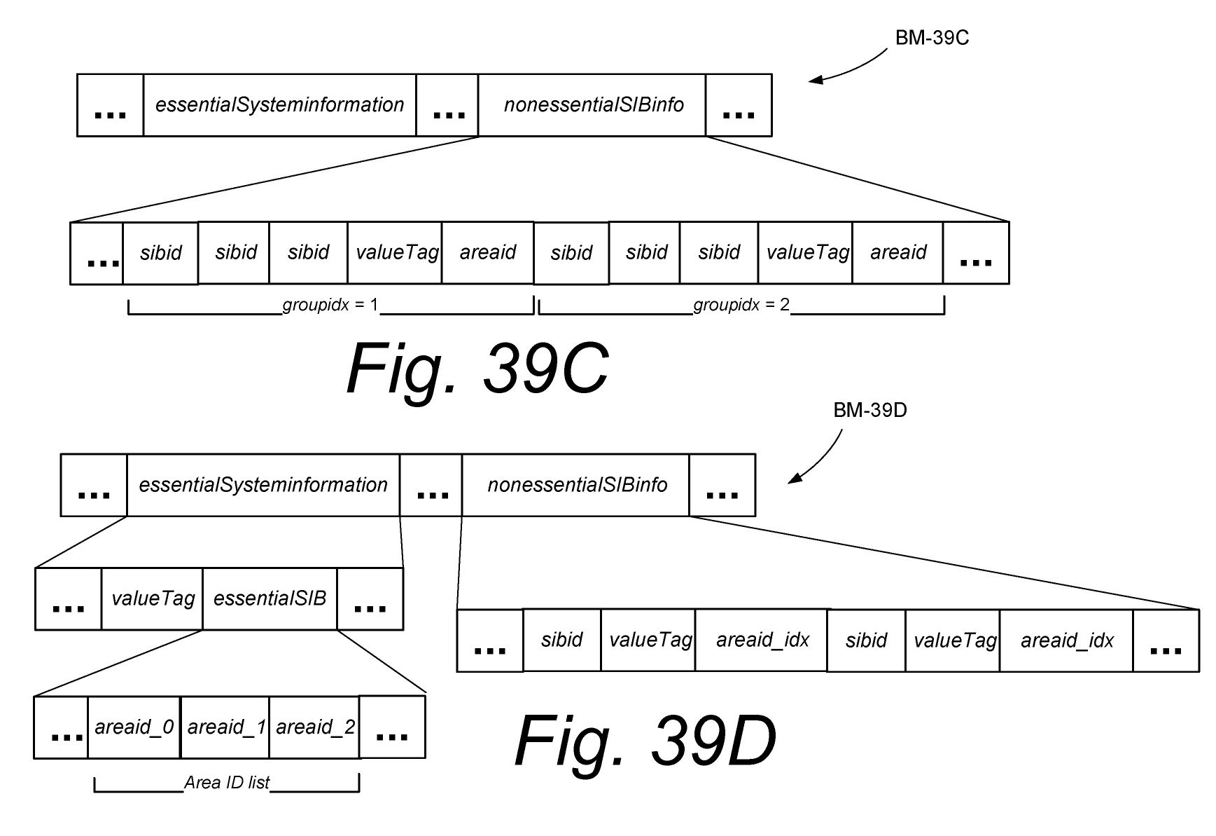

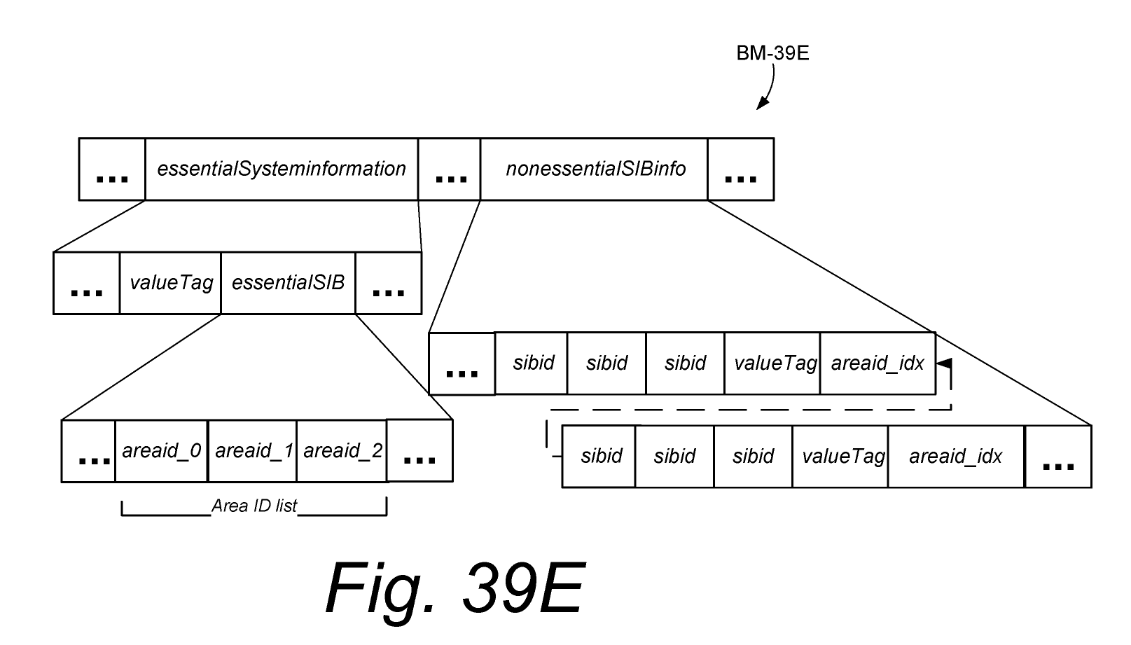

As mentioned above, the broadcast message BM may include content of the first type system information; an identification of the second type system information available from the first access node; the value tag; and the geographical area identifier. The manner of inclusion of the geographical area identifier may be in any of several ways. As a first example, FIG. 39A shows an example format of a broadcast message BM-39A in which the geographical area identifier (shown in FIG. 39A as “areaid”) is included in and obtained from a portion of the broadcast message BM-39A which pertains to the first type system information, e.g., an essentialSystemInformation information element of the broadcast message BM-39A.

As a second example, FIG. 39B shows an example format of a broadcast message BM-39B in which the geographical area identifier(s) (also shown in FIG. 39B as “areaid”) is/are included in and obtained from a portion of the broadcast message BM-39B which pertains to the identification of the second type system information, e.g., an nonessentialSIBInfor information element of the broadcast message BM-39B. FIG. 39B particularly shows that the geographical area identifier is included in and obtained individually for at least one second type system information. Plural System Information Blocks may have geographical area identifiers individually associated therewith. On the other hand, FIG. 39C shows that for broadcast message BM-39C the geographical area identifier may be included in and obtained in association with a group of plural second type system information. For example, a first geographical area identifier (first areaid) shown in FIG. 39C may pertain to a first group (groupidx=1) comprising the first three system information blocks (sibids) shown in FIG. 39C, and the second geographical area identifier (second areaid) shown in FIG. 39C may pertain to a second group (groupidx=2) comprising the second three system information blocks (sibids) shown in FIG. 39C. Each group may comprise any number of second type system information blocks, and the number of second type system information blocks in the groups may vary from group to group.

The broadcast message 39-D of FIG. 39D shows a further possible manner of including and obtaining the geographical area identifier(s). The broadcast message BM 39-D of FIG. 39 is formatted so that a list of geographical area identifiers is included in or obtained from a first portion of the broadcast message. In the example of FIG. 39D the first portion of the broadcast message happens to pertain to the first type system information, e.g., in the essentialSystemInformation information element of the broadcast message BM-39D. FIG. 39D shows the list (Area ID list) as comprising list members areaid_0, areaid_1, areaid_2, and so forth. In preparing the broadcast message BM-39D, the node processor 30 includes, in a second portion of the broadcast message BM-39D, a reference (e.g., areaid_idx) to a member of the list which is associated with at least one second type system information. In the example of FIG. 39D the second portion of the broadcast message BM-39D pertains to the identification of the second type system information. It should also be understood that, as a modification of FIG. 39D shown in FIG. 39E, the reference to the member of the list may be associated with a group of second type system information.

Recapping a portion of the foregoing, the FIG. 36 shows an example embodiment and mode of how the validity of the value tag may be determined. In FIG. 36, each access node (e.g., eNB) broadcasts a geographical area identifier (Area ID), e.g., an identification of the geographical area for non-essential SIB validity. The wireless terminal 26 considers that a non-essential SIB previously received is valid when it was received from an access node with the same geographical area as that for the current camped access node. In one configuration shown in FIG. 39A, the geographical area identifier (Area ID) may be an independent parameter included in the Essential System Information message. In another configuration, the geographical area identifier may be a subset or a combination of other broadcasted identities, such as Public Land Mobile Network (PLMN) Identity and Tracking Area Identity (TAI).

The example embodiment and mode of the broadcast message BM-39A of FIG. 39A assumes that all the non-essential SIBs in a given access node are associated with a single validity area with a common areaid. In order to enable flexible configurations, the example embodiments and modes of FIG. 39B-FIG. 39E show that an individual non-essential SIB, or a group of non-essential SIBs, may have its own areaid. FIG. 39B illustrates one exemplary implementation of the Essential System Information message, where each presence of sibIdIvalueTag pair is followed by the associated areaId. FIG. 39C illustrates one exemplary implementation wherein the groupId is used. In FIG. 39D and FIG. 39E, the essential SIB now contains a list of areaId's and each sibId/valueTag pair has an index (areaId_idx) that refers to one element of said areaId list. For example, areaId_idx=0 refers to the areaId_0 element in the list.

Some of the above embodiments and modes assume that the area ID and the value tag uniquely specify the version of content(s) of the corresponding SIB/SIB group. However, this may not be the case, depending on network configurations and the available value ranges of areaId and/or valueTag. For example, a set of access nodes in a geographical area may re-use the same areaId that is used by another set of access nodes in a different geographical area. As a result, there is a chance that areaId and valueTag of a certain SIB/SIB group for one of those areas accidentally become the same as those of the same SIB/SIB group for the other area, even though the content is different. If such areas are not sufficiently apart in distance, the wireless terminal that received and saved non-essential SIBs in one of those areas may consider the SIBs still valid in the other area. To avoid this kind of collision, further example embodiments and modes described below provide a content validation mechanism, wherein the wireless terminal and the currently camped-on access nodes communicate to check if the SIB/SIB group content(s) that the wireless terminal previously received is still valid.

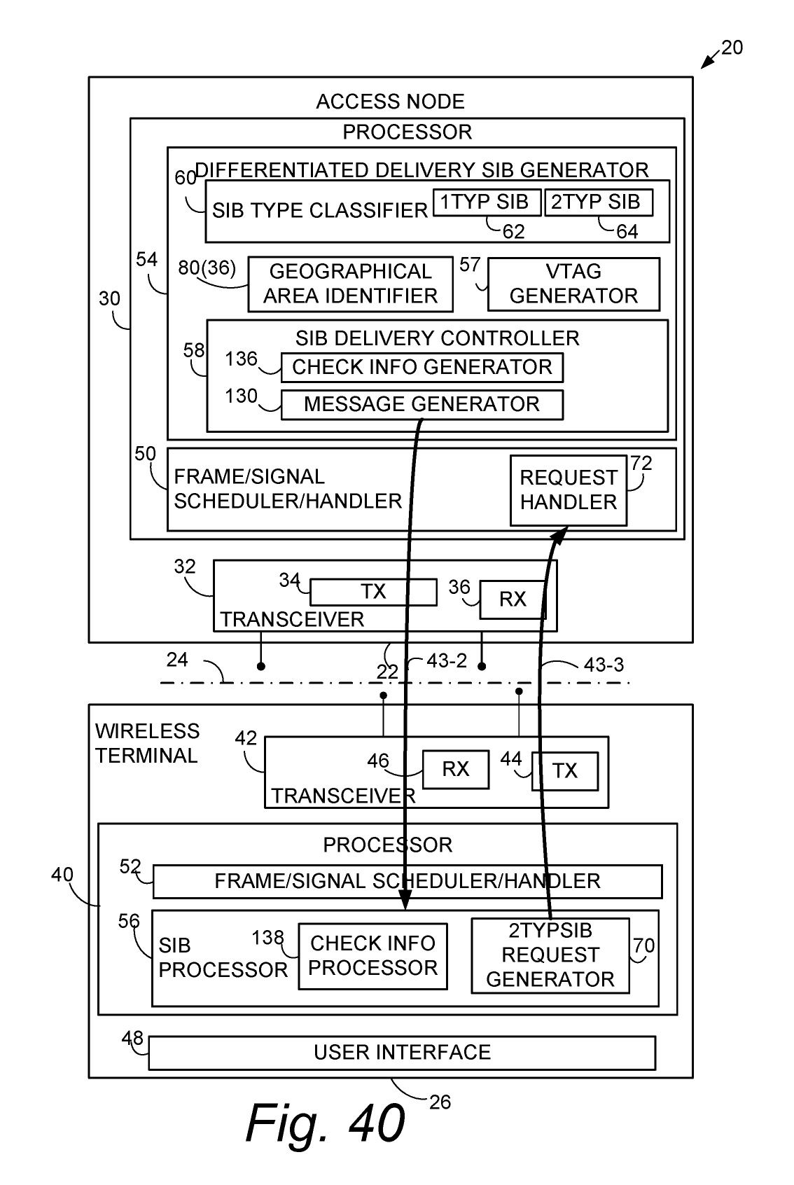

FIG. 40 shows an example embodiment and mode of an example communications system wherein the radio access node generates check information based on content of system information available at the access node, and transmits the check information over a radio interface. In this regard, FIG. 40 shows access node 22, and node processor 30 in particular, as comprising check information generator 136. FIG. 40 further shows wireless terminal 26 as comprising check information processor 138.

In different example embodiments and modes the check information, which is based on content of system information available at the access node, may be obtained from the access node in different ways. For example, in some example embodiments and modes the check information which is based on content of system information available at the access node may be transmitted in a unicast message to a particular wireless terminal. In other example embodiments and modes the check information which is based on content of system information available at the access node may be included in a broadcast message from the access node. In this former example, the check information may be based on content of second type system information available from the access node, and the broadcast message may include first type system information, an identification of the second type system information available from the access node, and the check information which is based on content of second type system information system information available from the access node

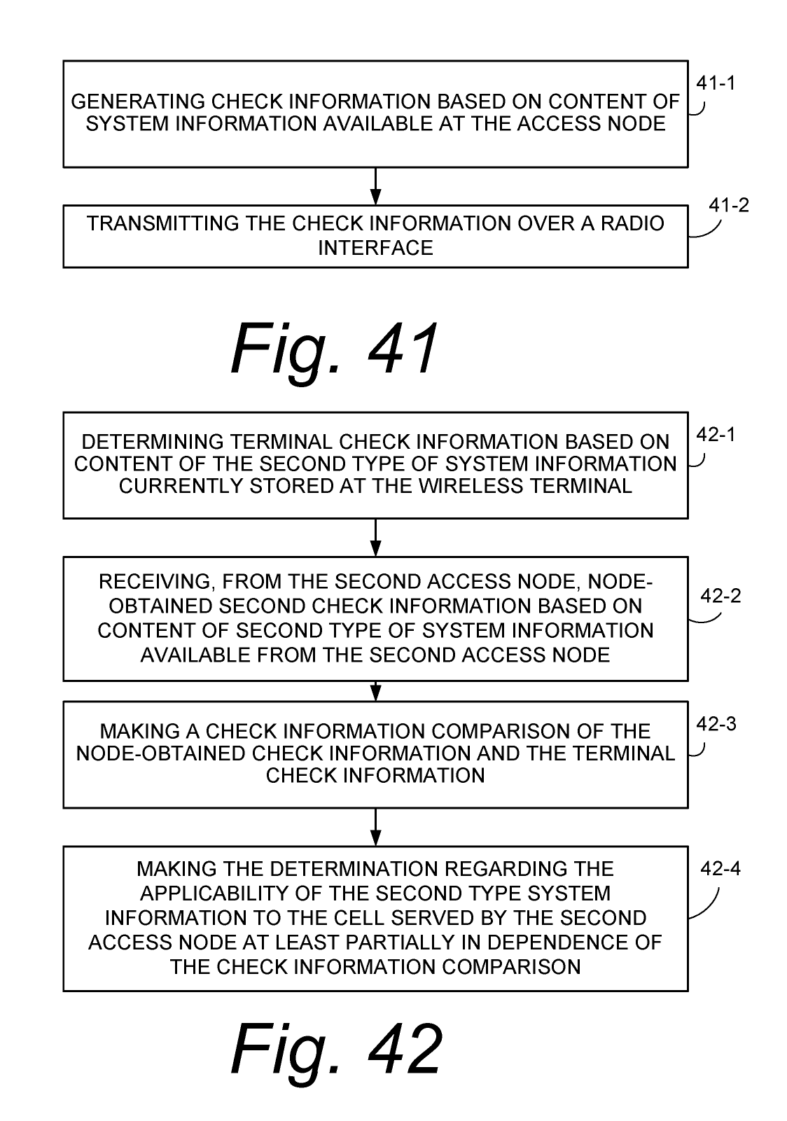

FIG. 41 shows example acts or steps executed by the access node 22 of FIG. 40 in conjunction with check information performed over system information technology. Act 41-1 comprises access node 22 generating check information based on content of system information available at the access node. The check information generated as act 41-1 may be, for example, a checksum, cyclical redundancy check, or other check quantity computed or determined over all of the second type system information blocks available at the access node 22. Act 41-2 comprises access node 22 transmitting the check information over a radio interface, as depicted by arrow 140 in FIG. 40.

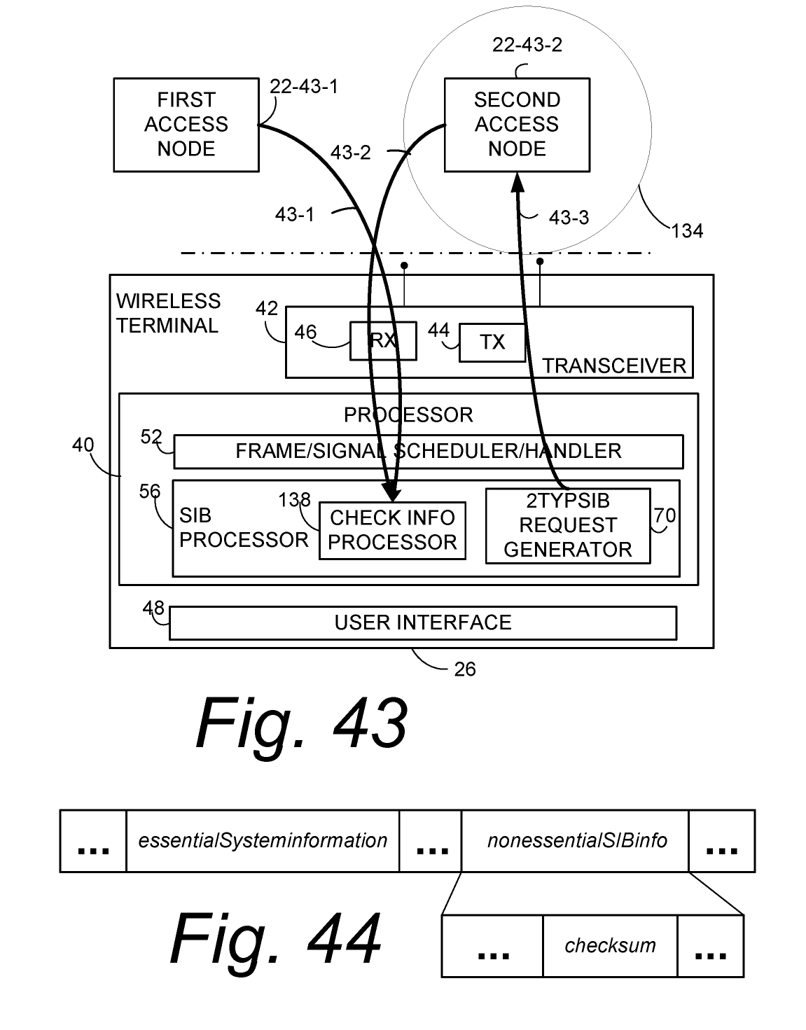

FIG. 42 shows example acts or steps executed by wireless terminal 26 of FIG. 40 in conjunction receipt of check information performed over system information technology. The acts of FIG. 42 may be performed in the context of the radio access network (RAN) of FIG. 43, which shows first access node 22-43-1 and second access node 22-43-2. Act 42-1 comprises determining terminal check information based on content of the second type of system information currently stored at the wireless terminal. Such second type of system information may have been previously obtained, for example, from the first access node 22-43-1, as indicated by arrow 43-1 in FIG. 43. The terminal check information determined as act 42-1 may be, for example, a checksum, cyclical redundancy check, or other check quantity computed or determined over all of the second type system information blocks stored by wireless terminal 26. Of course, the way in which the check information is generated or determined (e.g., whether checksum, CRC, etc.) is coordinated between the access node 22 and wireless terminal 26. Act 42-2 comprises receiving, from the second access node, node-obtained second check information based on content of second type of system information available from the second access node 22-43-2, as indicated by arrow 43-2 in FIG. 40 and FIG. 43. Act 42-3 comprises the check information processor 138 making a check information comparison of the node-obtained check information and the terminal check information. Act 42-4 comprises making the determination regarding the applicability of the second type system information to the cell served by the second access node (e.g., the determination of act 41-2) at least partially in dependence of the check information comparison, at least partially in dependence on the outcome of act 42-3.

The determination of act 42-4 may be that the node check information and the terminal check information favorably compare (e.g., are the same), in which case the wireless terminal 26 may use the terminal-stored second type system information in the cell served by the access node 22 and need not request the second type system information from the access node 22. But if the determination of act 42-4 is not favorable, the wireless terminal 26 will need to send a request message to the access node 22, as indicated by arrow 43-3 in FIG. 40 and FIG. 43.

In the foregoing the receiver 46 of wireless terminal 26 of FIG. 40 may receive the node-obtained second check information from a broadcast message. In such case the broadcast message may comprising the first type system information and an identification of second type system information available at the second access node.

Thus as further illustrated in FIG. 44, in one configuration, the nonEssentialSIBInfo information element in the Essential System Information message may contain a field checksum. The checksum value is derived from the contents of all the non-essential SIBs available by the access node that broadcasts the message. Upon receipt of this message the wireless terminal may first check the validity of saved non-essential SIB contents (if any) using the area IDs and the value tags. If some of the area IDs or value tags do not match, the UE may request on-demand delivery of corresponding SIBs/SIB groups. If all match, the wireless terminal may then calculate the checksum of the saved contents (in the manner depicted by act 42-1), obtain a checksum (e.g., check information) from the access node (in the manner depicted by act 42-2), and then compare (as depicted by act 42-3) the checksum calculated for the saved contents (calculated at act 42-1) with the checksum broadcasted in the message. If the checksum matches, the UE may consider that all the saved non-essential SIBs are valid. Otherwise, the wireless terminal may initiate requesting on-demand delivery of some or all of the non-essential SIBs.

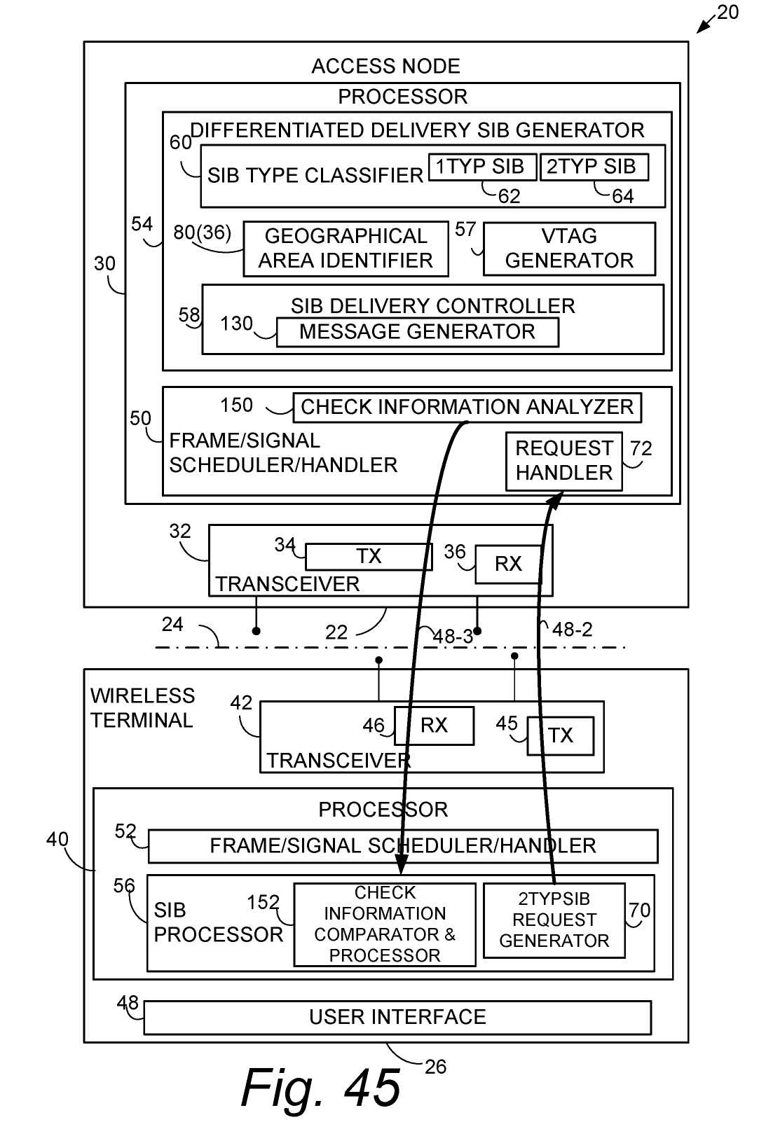

FIG. 45 shows an example embodiment and mode of an example communications system wherein a wireless terminal obtains updated system information from an access node and performs check information comparison of node-obtained check information and updated terminal check information. In this regard, FIG. 45 shows access node 22, and node processor 30 in particular, as comprising check information analyzer 150. FIG. 45 further shows wireless terminal 26 as comprising check information comparator and processor 152.

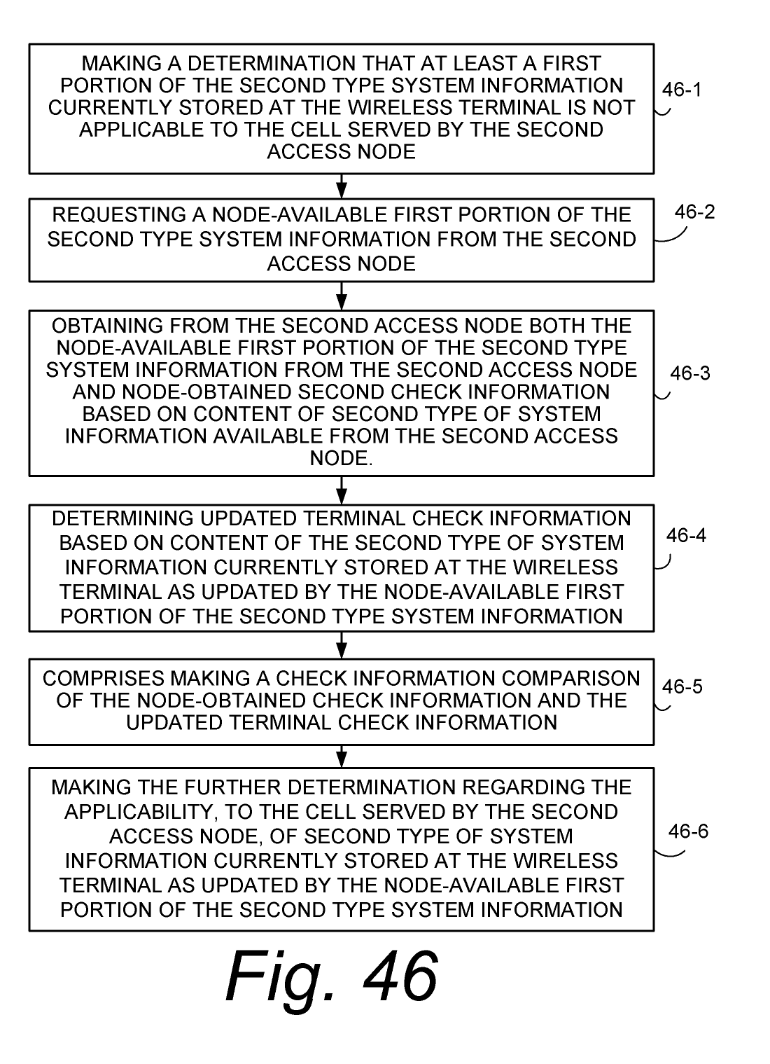

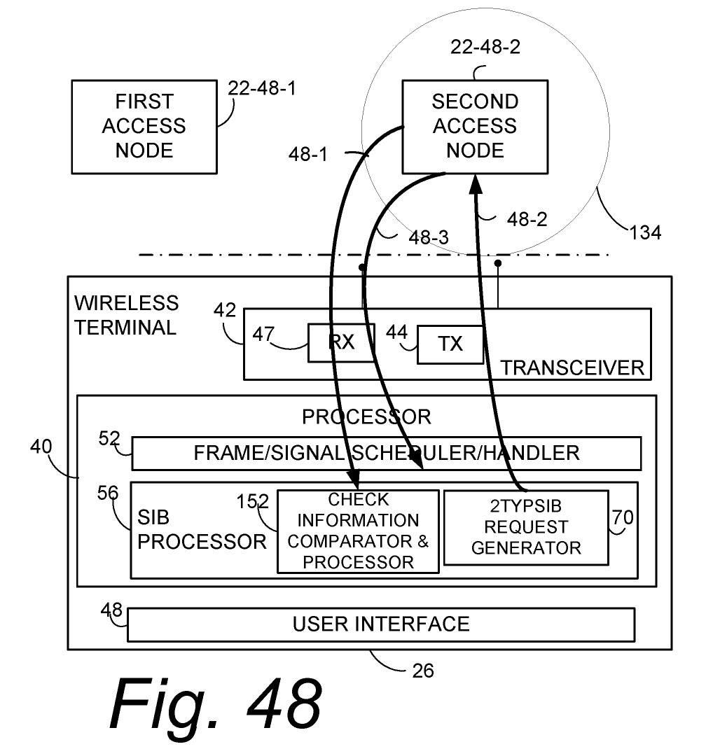

FIG. 46 shows example, representative, basic acts or steps performed by the wireless terminal 26 of FIG. 45. The acts of FIG. 46 may be understood in the context of the radio access network (RAN) shown in FIG. 48, which shows first access node 22-48-1 and second access node 22-48-2. Act 46-1 comprises wireless terminal 26 making a determination that at least a first portion of the second type system information currently stored at the wireless terminal is not applicable to the cell served by the second access node. The determination of act 46-1 may result, for example, by the terminal-stored value tag or terminal-stored geographical area identifier associated with a certain second type system information block not matching the value tag or the geographical area identifier obtained from the second access node and associated with that certain second type system information block. Arrow 48-1 shows the wireless terminal 26 obtaining the value tag or the geographical area identifier from the second access node. Act 46-2 comprises the wireless terminal requesting, from the second access node 22-48-2, a node-available first portion of the second type system information available from the second access node, as depicted by arrow 48-2 in FIG. 48. Act 46-3 comprises obtaining, from the second access node, both the node-available first portion of the second type system information available from the second access node and node-obtained second check information based on content of the second type of system information available from the second access node, as depicted by arrow 48-3 in FIG. 45 and FIG. 48. Obtaining the node-available first portion of the second type system information from the second access node may be accomplished through various types of request messages as previously described in conjunction with other example embodiments and modes. Act 46-4 comprises wireless terminal 26 determining updated terminal check information based on content of the second type of system information currently stored at the wireless terminal as updated by the node-available first portion of the second type system information. In other words, as act 46-4 the updated terminal check information is computed over the second type system information blocks that were believed by the terminal to be current and a second type system information block that was obtained from the node in act 46-3. Act 46-5 comprises wireless terminal 26 making a check information comparison of the node-obtained check information (obtained at act 46-3) and the updated terminal check information (determined at act 46-5). Act 46-6 comprises making the further determination regarding the applicability, to the cell served by the second access node, of second type of system information currently stored at the wireless terminal as updated by the node-available first portion of the second type system information. In essence, if the comparison of act 46-5 is favorable, as act 46-6 the wireless terminal 26 uses the second type system information as updated in the cell served by the second access node 22.

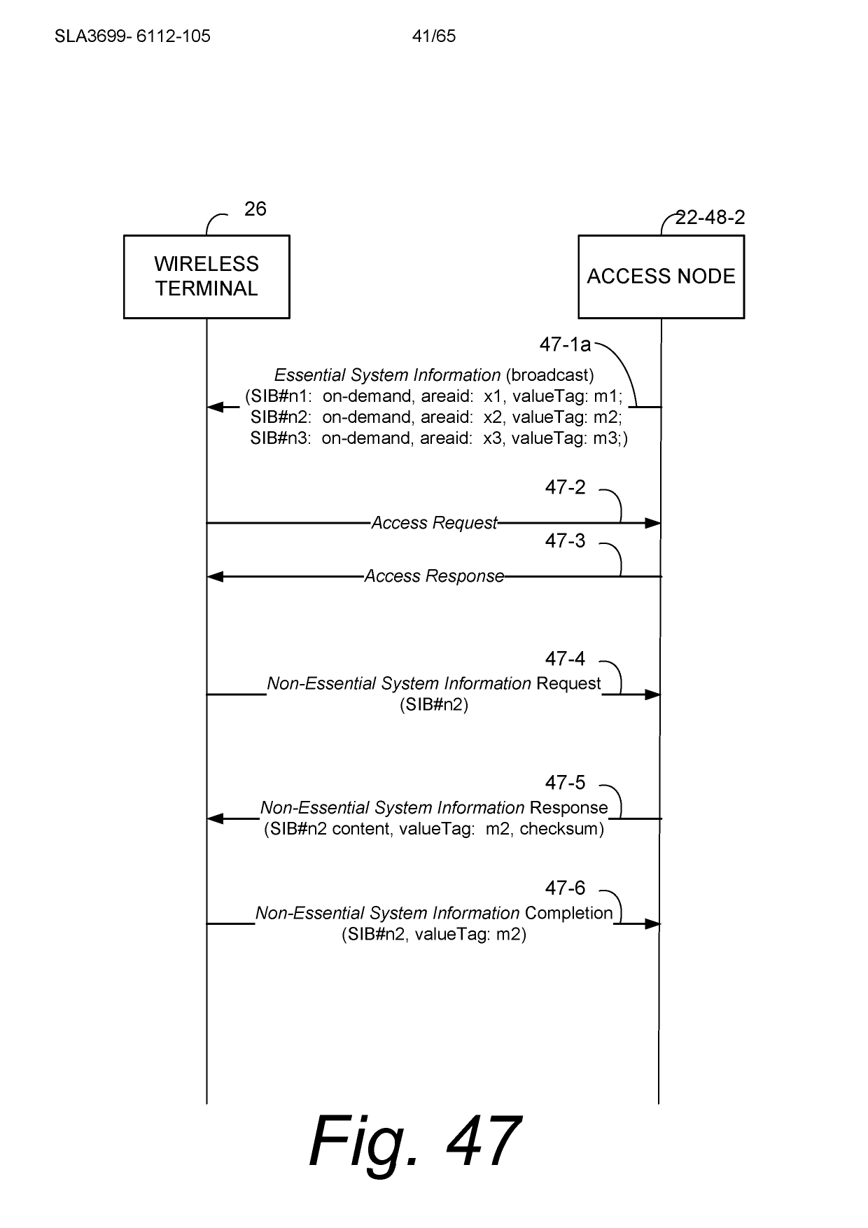

FIG. 47 shows overall example, representative, basic acts or steps performed by access node 22 and wireless terminal 26 of FIG. 45 in a specific scenario. The acts of FIG. 47 may also be understood in the context of the radio access network (RAN) shown in FIG. 48, which shows first access node 22-48-1 and second access node 22-48-2.

Act 47-1 comprises the access node sending an Essential System Information message that includes, for each of three second type system information blocks, respective geographical area identifiers x1, x2, and x3 and respective valueTags m1, m2, and m3. Act 47-2 comprises the wireless terminal making an access request. Act 47-3 comprises the access node sending an access response message to the wireless terminal. Act 47-4 comprise the wireless terminal sending a Non-Essential System Information Request message to the access node (as depicted by arrow 48-2). Act 47-4 may occur as a result of the wireless terminal having determined (as act 46-1) that a portion of the second type system information currently stored at the wireless terminal is not applicable to the cell served by the second access node. In the example shown in FIG. 47, the wireless terminal has determined that the second type system information block SIB#n2 is not applicable. Act 47-5 comprises the access node sending a Non-Essential System Information Response message to the access node, as also depicted by arrow 48-3. The Non-Essential System Information Response message includes the content of the sought second type system information block SIB#n2, the valueTag for the sought block SIB#n2, and a checksum computed over all the second type system information available at the second access node. Upon receipt of the Non-Essential System Information Response message of act 47-5, the wireless terminal returns a Non-Essential System Information Completion message.

Thus FIG. 47 shows that (as act 47-5) the access node includes the checksum value for all the contents of the available non-essential SIBs in a downlink unicast message. In the example of FIG. 47, SIB#n1, SIB#n2 and SIB#n3 are the non-essential SIBs which are available by request. The wireless terminal 26 detects that the saved SIB#n2 is not current (areaId or valueTag mismatch). The wireless terminal then follows procedures such as those disclosed above to request the on-demand delivery of SIB#n2 (as shown by act 47-4). The Non-essential System Information Response message of act 47-5 may include the checksum value calculated for the contents of SIB#n1, SIB#n2 and SIB#n3, along with the content of the requested SIB#n2. After receiving the Non-essential System Information Response message, the wireless terminal may calculate the checksum using the saved SIB#n1 and SIB#n3 and the received SIB#n2, and then compare with the received checksum. If it does not match, the UE may additionally request SIB#n1 and SIB#n3

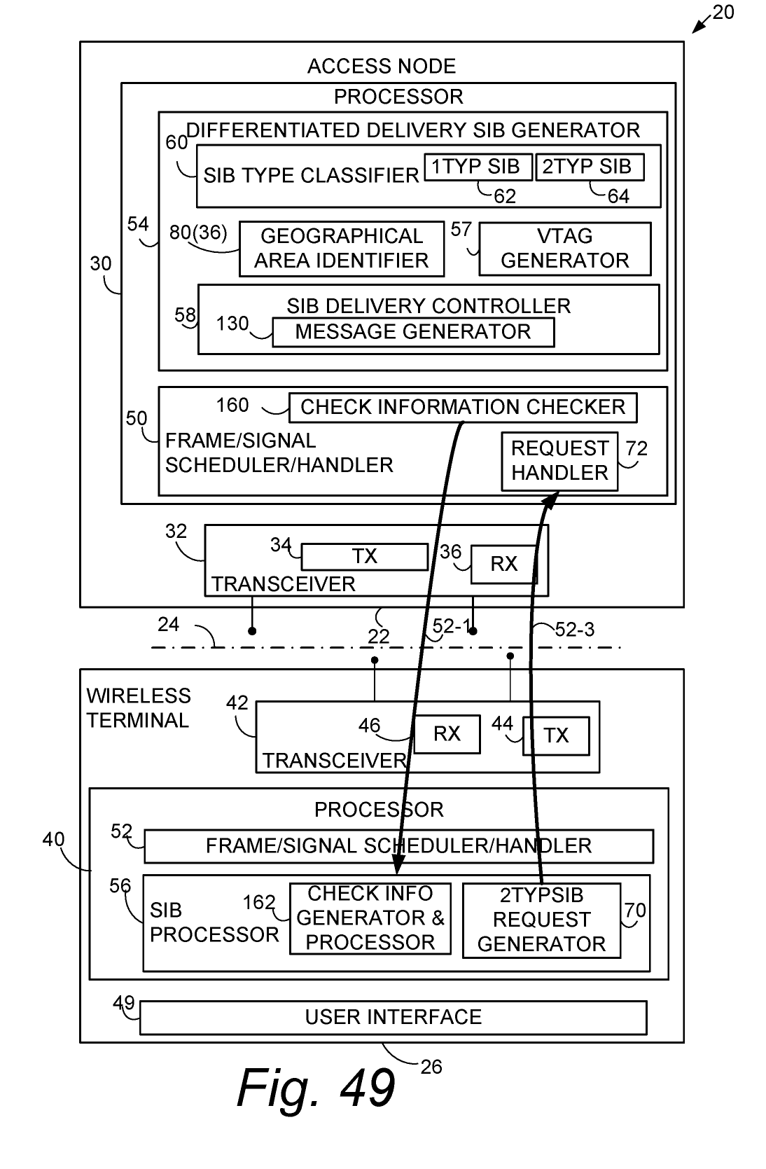

FIG. 49 shows an example embodiment and mode of an example communications system wherein the radio access node receives check information based on content of system information stored at the wireless terminal, and either rejects or accepts a connection request in accordance with the received check information. In this regard, FIG. 49 shows access node 22, and node processor 30 in particular, as comprising check information checker 160. FIG. 49 further shows wireless terminal 26 as comprising terminal check information generator and processor 162.

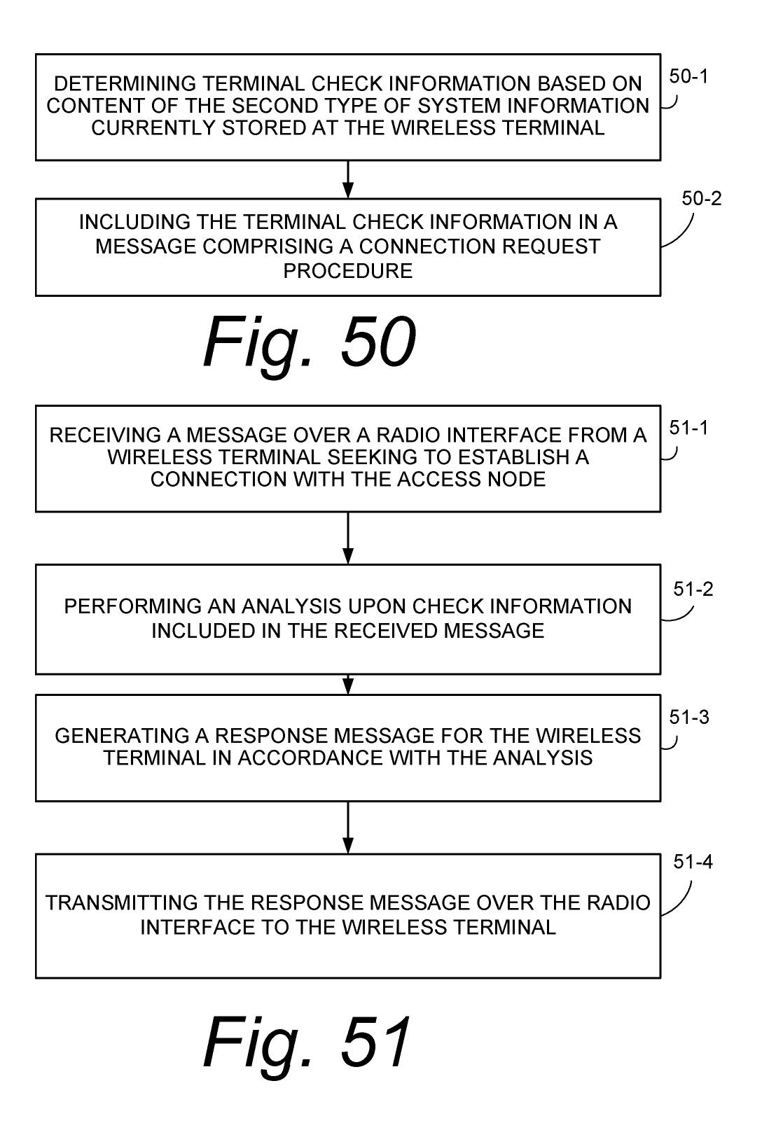

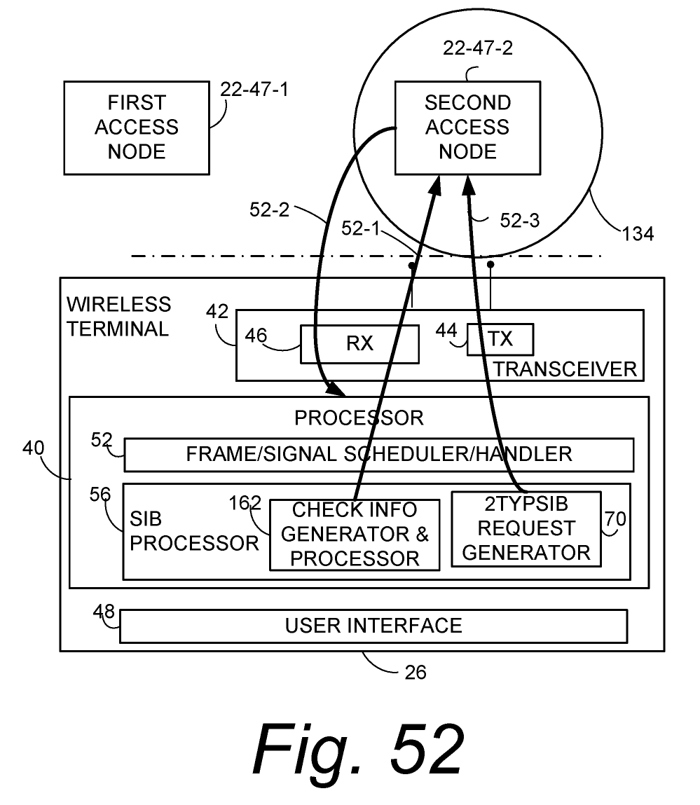

FIG. 50 shows example, representative, basic acts or steps performed by the wireless terminal 26 of FIG. 49. The acts of FIG. 50 are performed upon wireless terminal 26 making a determination that (the wireless terminal 26 believes that) the second type system information is applicable to the cell served by the second access node. Act 50-1 comprises the wireless terminal 26 determining terminal check information based on content of the second type of system information currently stored at the wireless terminal. Act 50-2 comprises the wireless terminal 26 including the terminal check information in a message comprising a connection request procedure. Such message of the connection request procedure is depicted by arrow 52-1 in FIG. 49 and FIG. 52. The access node 22, and check information checker 160 in particular, determines whether the access node 22 agrees that the check information received from the terminal is accurate for the second type system information available from the second access node 22. If the access node 22 is in agreement, the access node 22 accepts the connection request. But if the access node 22 in not in agreement, the connection request is rejected. Upon receiving a rejection in the connection request procedure, the wireless terminal may request the second type system information from the second access node, as depicted by arrow 52-3 in FIG. 49 and FIG. 52.

FIG. 51 is a flowchart showing example, representative, basic acts or steps performed by the access node of FIG. 49. Act 51-1 comprises receiving a message over a radio interface from a wireless terminal seeking to establish a connection with the access node. Such message may be depicted by arrow 52-1 of FIG. 49 and FIG. 52. Act 51-2 comprises performing an analysis upon check information included in the received message. The check information is based on content of system information believed current by the wireless terminal, and the analysis comprises a comparison of the check information included in the received message with check information derived by the access node with respect to content of the system information deemed current by the access node. Act 51-3 comprises generating a response message for the wireless terminal in accordance with the analysis. Act 51-4 comprises transmitting the response message over the radio interface to the wireless terminal. The response message is depicted by arrow 52-2 of FIG. 52.

It should be appreciated that while the check information of the example embodiments and modes of FIG. 40-FIG. 44, FIG. 45-FIG. 48, and FIG. 49-FIG. 52 have been illustrated as being utilized in conjunction reference to or based on other parameters such as geographical area identifier and value tag, the check information which is based on content of system information available at the access node may also be utilized without reference to such parameters and/or may be based on other quantities or parameters that pertain to system information. Moreover, while illustrated herein at least in some example implementations as being based on content of second type system information, the check information may not be limited to second type system information but may apply to other types of system information as well. Yet further, the example embodiments and modes of FIG. 40-FIG. 44, FIG. 45-FIG. 48, and FIG. 49-FIG. 52, and other example embodiments and modes described herein, may be utilized individually or in conjunction with one another, e.g., one or more features of one or more embodiments and modes may be combined. That is, the access node 22 or the wireless terminal 26 may be configured to operate in accordance with more than one such example embodiment and mode.

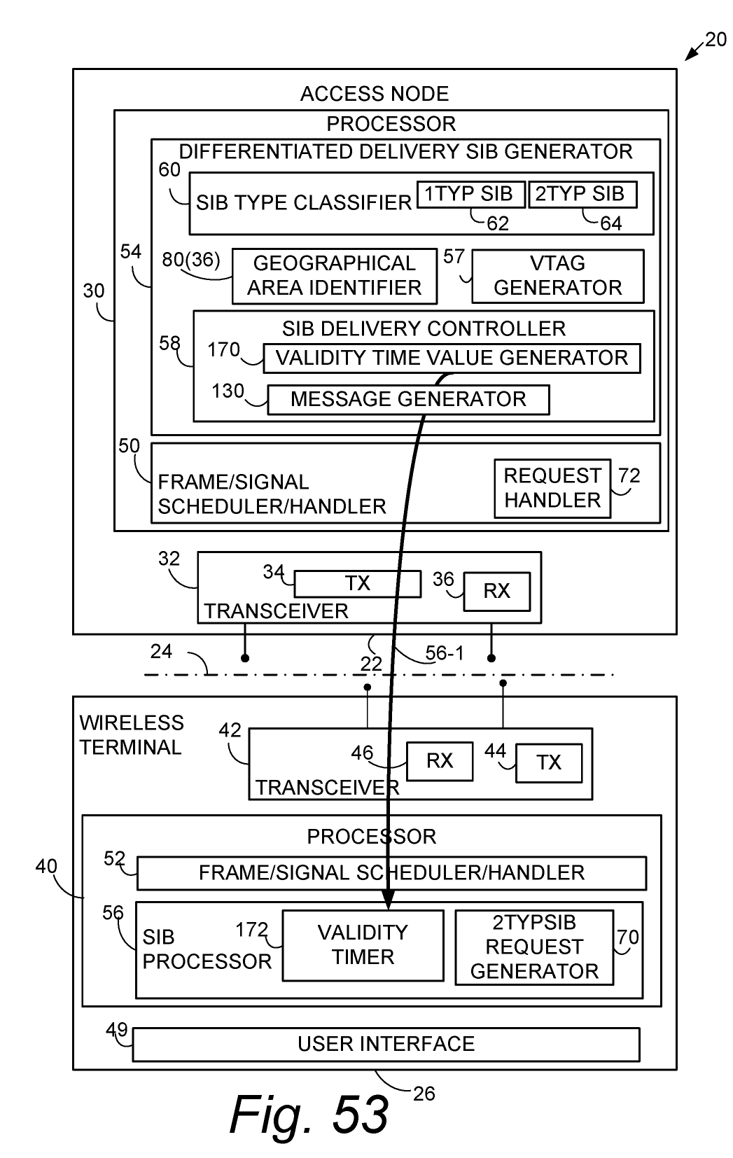

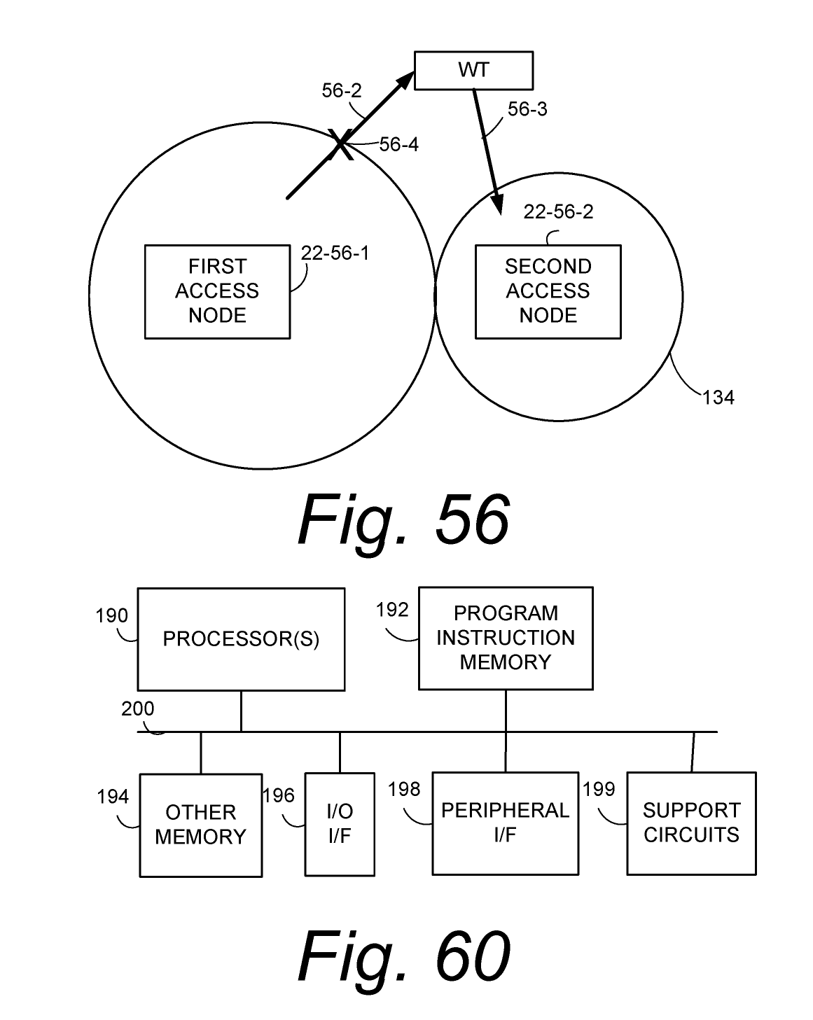

FIG. 53 shows an example embodiment and mode of an example communications system wherein the radio access node 22 sends a validity time value which specifies a time period during which the second type system information system information obtained from the first access node 22 remains valid in the geographical area served by the access node 22. FIG. 53 shows access node 22, and system information (SI) generator 54 in particular, as comprising validity time value generator 170. The node processor 30 of access node 22 thus include system information in a message for transmission over a radio interface to a wireless terminal and the validity timer value. FIG. 53 also shows wireless terminal 26 as comprising validity timer 172, which enables SIB processor 56 of wireless terminal 26 to make the determination regarding applicability of the second type system information to the cell served by the access node 22 at least partially in dependence on the geographical area identifier and the validity timer value. The use of the validity timer value is particularly beneficial in a scenario, such as that shown in FIG. 56, in which the wireless terminal 26 exits the cell served by a first access node and then re-enter the geographical area (e.g., the cell served by the first access node or another access node in the same geographical area) before the validity timer expires. In FIG. 56, arrow 56-2 shows the wireless terminal 26 leaving or existing the cell served by the first access node 22-56-1, and arrow 56-3 shows the wireless terminal 26 subsequently re-entering the geographical area (e.g., entering a cell served by access node 22-56-2, which happens to be a member of the same geographical area. The wireless terminal 26 could also re-enter the geographical area by entering the cell served by the first access node 22-56-1).

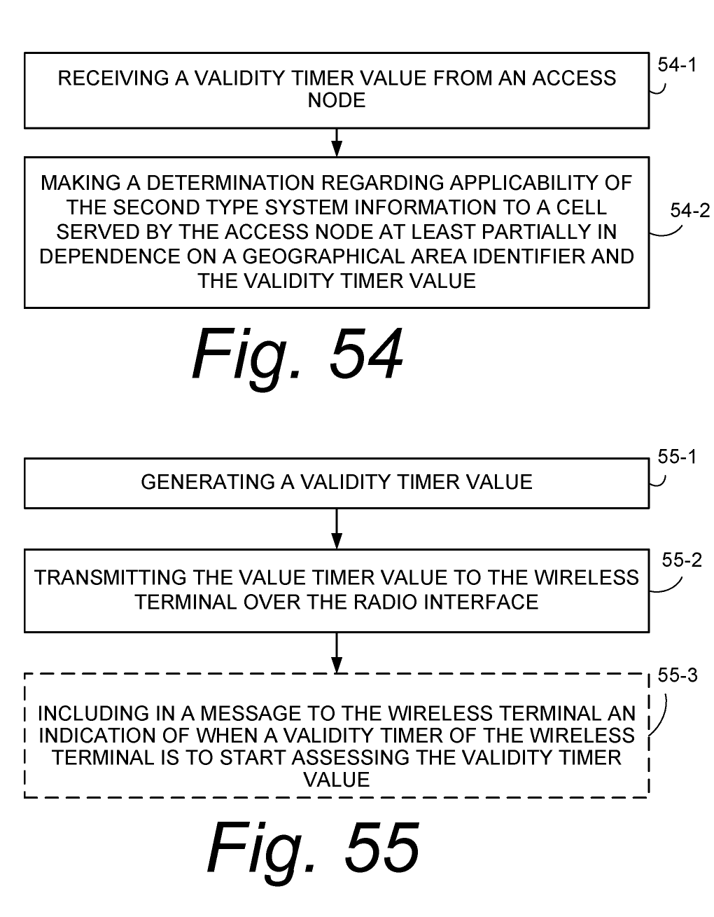

FIG. 54 shows example, representative, basic acts or steps performed by the wireless terminal 26 of FIG. 53. The acts of FIG. 54 are illustrated in an example scenario of a simplified context of a radio access network (RAN) as shown in FIG. 56, which illustrates a first access node 22-56-1 and a second access node 22-56-2. Act 54-1 comprises the wireless terminal 26 receiving a validity timer value from an access node. In the example scenario shown in FIG. 56, the validity timer is received from access node 22-56-1. As understood from other example embodiments and modes, the wireless terminal 26 also receives from the access node 22-56-1 other information including: first type system information; second type system information; a value tag associated with the second type system information; a geographical area identifier which specifies a geographical area for which the value tag is valid. The geographical area is an area served by the access node and a group comprising at least one other access node. The validity timer value specifies a time period during which the second type system information system information obtained from the first access node remains valid in the geographical area. The validity timer value is stored in validity timer 172 of SIB processor 56. Act 54-2 comprises wireless terminal 26 (e.g., terminal processor 40) making a determination regarding applicability of the second type system information to a cell served by the access node. The determination is made at least partially in dependence on the geographical area identifier and the validity timer value.

FIG. 55 shows example representative acts or steps performed by the access node 22 of the example embodiment and mode of FIG. 53, in the simplified context of the radio access network (RAN) of FIG. 56. Act 55-1 comprises the access node 22, and validity time value generator 170 in particular, generating a validity timer value which specifies a time period during which content of system information facilitating use of communication services provided by the access node remains valid in a geographical area served by the access node and a group comprising at least one other access node. Preferably but not exclusively the validity timer value specifies a time period during which content of non-essential system information (e.g., the second type system information) remains valid in the geographical area, the non-essential system information not being required for initial access to the radio access network. Act 55-2 comprises the access node 22 transmitting the value timer value to the wireless terminal over the radio interface. In FIG. 53 arrow 56-1 depicts transmission of the value timer value from access node 22-56-1 to the wireless terminal 26.

The access node 22 may optionally also perform act 55-3. Act 55-3 comprises the access node 22 including in a message to the wireless terminal an indication of when a validity timer of the wireless terminal is to start assessing the validity timer value. The message in which the indication of when a validity timer of the wireless terminal is to start assessing the validity timer value may be the same message in which the validity timer value is sent to the wireless terminal 26, or a different message.

In a first example implementation, the indication is configured to indicate that the validity timer of the wireless terminal is to start assessing the validity timer value upon receipt of the content of the non-essential system information. Thus in the first example implementation, the wireless terminal 26 starts the validity timer upon receipt of the second type system information from the first access node 22-56-1, and permits use of the second type system information should the wireless terminal exit and then re-enter the geographical area before the validity timer expires.

In a second example implementation, the indication is configured to indicate that the validity timer of the wireless terminal is to start assessing the validity timer value when the wireless terminal leaves the geographical area. Thus in the second example implementation, the wireless terminal 26 starts the validity timer upon the wireless terminal 26 leaving the geographical area (at the time at which the wireless terminal 26 is at the location 56-4 shown in FIG. 56).

Thus, the example embodiment and modes represented by FIG. 53 provide a detailed method for dealing with the validity period of received non-essential SIBs. It was disclosed in previous embodiments that a received non-essential SIB (or a group of non-essential SIBs) may be valid within a pre-determined or network-configured time period. In the first example implementation described above, a validity timer associated with a specific non-essential SIB (or a specific group of SIBs) may (re-)start immediately upon receipt of the SIB/SIB group. Alternatively, in the second example implementation, the wireless terminal 26 may defer starting the timer until it leaves the geographical area (as depicted by arrow 56-2 in FIG. 56) for the corresponding SIB/SIB group. In this second example implementation, after starting the timer the wireless terminal 26 may eventually reuse the content of SIB/SIB group if the wireless terminal 26 goes back to the original area (as depicted by arrow 56-3 in FIG. 3) and if the timer has not expired. The wireless terminal 26 may discard the content when the validity timer expires.

The timer value and/or which of these configurations to choose may be obtained in several ways. As a timer-parameter implementation, the timer value and/or an indication of which of these configurations to choose may be provided by access node 22. As a second timer-parameter implementation, the timer value and/or an indication of which of these configurations to choose may be pre-configured at the wireless terminal 26. Either of these example implementations may reduce the chance of area ID/value tag collision. Further, the second example implementation may suppress unnecessary on-demand delivery requests from a wireless terminal staying in one area.

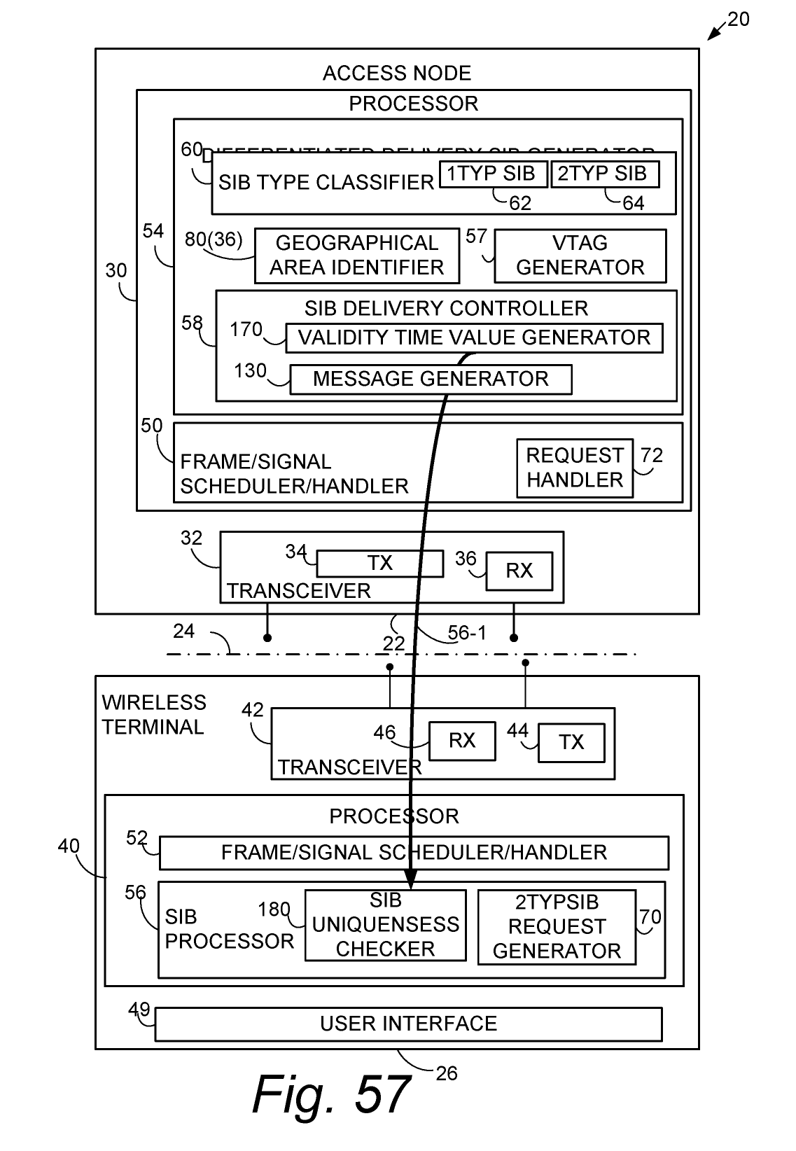

FIG. 57 shows an example embodiment and mode of an example communications system wherein a wireless terminal determines that, if a geographical area identifier is not received along with system information from a particular access node, the system information received from that access node is unique for that access node and thus cannot be presumed to be usable in cells served by other access nodes. To that end FIG. 57 shows wireless terminal 26 as comprising SIB uniqueness checker 180.

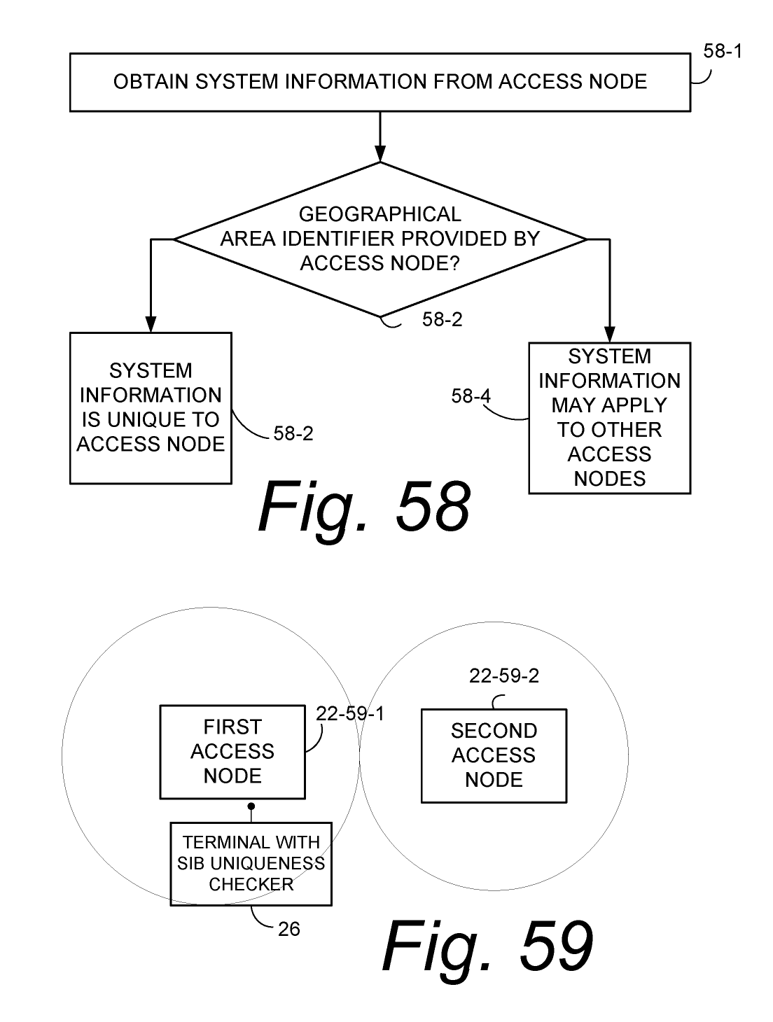

FIG. 58 shows example, representative, basic acts or steps performed by the wireless terminal 26 of FIG. 57. The acts of FIG. 58 are illustrated in an example scenario of a simplified context of a radio access network (RAN) as shown in FIG. 59, which illustrates a first access node 22-59-1 and a second access node 22-96-2. Act 58-1 comprises the wireless terminal 26 obtaining system information from a first access node 22-59-1. The system information obtained in act 58-1 may comprise first type system information; second type system information; a value tag associated with the second type system information; and (if provided by the access node 22) a geographical area identifier which specifies a geographical area for which the value tag is valid. As understood with reference to other example embodiments and modes, the geographical area being served by the access node and a group comprising at least one other access node. Act 58-2 comprises the wireless terminal 26 a determination regarding provision by the first access node 22-59-1 of the geographical area identifier, i.e., checking whether the access node 22-59-1 provided a geographical area identifier. If the result of the determination of act 58-2 is negative, i.e., no geographical area identifier was provided by the access node 22-59-1, then as act 58-3 the wireless terminal 26 understands that the system information provided by access node 22-59-1 is unique to access node 22-59-1 and that such system information cannot be presumed to be valid in the cell of another access node, such as access node 22-59-2. On the other hand, if the result of the determination of act 58-2 is positive, i.e., a geographical area identifier was provided by the access node 22-59-1, then as act 58-4 the wireless terminal 26 understands that the system information provided by access node 22-59-1 may also apply (subject to possible further checking) to another cell in the same geographical area, such as access node 22-59-2, for example. Act 58-3 and act 58-4 thus together comprise an act of making a second determination regarding applicability of the second type system information to a cell served by the second access node.

Thus, in some example embodiments and modes represented by FIG. 57-FIG. 59, the presence of a geographical area identifier such as areaId may be optional. If the geographical area identifier (areaId)is omitted for a certain sibId/valueTag pair, the wireless terminal 26 may treat the non-essential SIB (or the group of non-essential SIBs) with that sibId as an node-specific SIB; only valid for the access node. Likewise, for other example embodiments and modes which utilize a list and index, the presence of areaId_idx may be optional and, if omitted, the corresponding non-essential SIB or the group of SIBs may be access node-specific.

FIG. 61-FIG. 66 show an example embodiment and mode of a communications system wherein a mode of delivery of one or more system information blocks (SIBs) may be changed. As used herein, a delivery mode being “changed” has the same meaning as the delivery mode being “transitioned” or “switched”. A brief review and discussion of example delivery modes follows.

From example embodiments described above it is understood that it some instances a system information block (SIB) may be periodically broadcast. Such is typically the case, for example, in preceding embodiments wherein system information blocks (SIBs) which belong to a first type of system information are periodically broadcast in an Essential System Information message. These types of system information blocks (SIBs) thus belong to a first set of system information blocks (SIBs) which have a broadcast delivery mode. One or more other system information blocks (SIBs) are not periodically broadcasted in messages such as the Essential System Information message, although they may be identified in the Essential System Information message (e.g., in a nonEssentialSIBInfo information element with the identification of the non-essential SIBs) as being available on demand (e.g., on request) from the access node. In some of the preceding example embodiments and modes these type of “on demand” system information blocks (SIBs) have been referred to as second type system information block (SIB). In some example embodiments and modes described above these other types of system information blocks (SIBs) were delivered “on-demand” in response to a (usually) subsequent request message, such as a Non-essential System Information Request message. These other types of system information blocks (SIBs) thus belong to a second set of system information blocks (SIBs) which have an on-demand delivery mode.

FIG. 61-FIG. 66 show an example embodiment and mode of a communications system wherein, when a particular system information block (SIB) changes membership, e.g., changes membership between the first set of system information and the second set of system information, the access node changes the delivery mode of the particular system information block (SIB), and thus in an example implementation accordingly changes composition of the broadcast messages which emanate from the access node. For example, if the particular system information block (SIB) changes from the first set of system information to the second set of system information, the delivery mode of that particular system information block (SIB) is changed from broadcast delivery mode to on-demand delivery mode, and the contents of that particular system information block (SIB) are no longer carried in the broadcast message, as described in more detail below. On the other hand, if the particular system information block (SIB) changes from the second set of system information to the first set of system information, the delivery mode of that particular system information block (SIB) is changed from the on-demand delivery mode to the broadcast delivery mode, and the contents of that particular system information block (SIB) are then included in the broadcast message, as also described in more detail below.

The access node 22-61 of FIG. 61 comprises node processor 30-61 and node transceiver 32-61. Unless otherwise noted, elements of the example embodiment and mode of FIG. 61 are similar to comparably named and numbered elements of other embodiments (although for the FIG. 61 example embodiment and mode the reference number suffix may vary), including node transceiver 32-61 and node processor 30-61 (and various component functionalities of node processor 30-61 such as frame/signal scheduler/handler 50-61 and differentiated delivery SIB generator 54-61).

The differentiated delivery SIB generator 54-61 of access node 22-61 comprises SIB classifier 60-61, which classifies or otherwise maintains a listing of system information blocks (SIBs) which belong to a first SIB set 62-61 and a second SIB set 64-61. In some example embodiments and modes, the system information blocks (SIBs) which belong to the first SIB set 62-61 may be considered “first type” SIBs (e.g., 1TYP SIB), and the system information blocks that belong to the second SIB set 64-61 may be considered “second type” SIBs (e.g., 2TYP SIB). As used herein, system information blocks (SIBs) which belong to the first SIB set 62-61 may also be referred to as first system information blocks, while system information blocks that belong to the second SIB set 64-61 may also be referred to as second system information blocks.

The SIB classifier 60-61 includes SIB-set membership controller 184, which manages the membership of the first SIB set 62-61 and second SIB set 64-61, and which may change (e.g., switch) of membership of a particular SIB from one set to another set (e.g., switch from first SIB set 62-61 to second SIB set 64-61, or visa-versa). In example, non-limiting example implementation, SIB-set membership controller 184 may even make a determination as to whether a particular SIB should belong to the first SIB set 62-61 or the second SIB set 64-61. Whether the SIB-set membership controller 184 makes a determination of a change in membership, or otherwise notes a change in membership required by other units or functionalities or nodes, the SIB-set membership controller 184 has influence on the mode of delivery of each SIB as the SIB is prepared for delivery by SIB delivery controller 58.

The differentiated delivery SIB generator 54-61 of the example access node 22-61 may also comprise VTAG generator 57-61 and (optionally) geographical area identifier 80, as understood at least in part from other example embodiments and modes. Moreover, as in other example embodiments and modes, messages which transmit SIBs, e.g., to wireless terminals 26, are generated by message generator 130 and are transmitted by node transceiver 32-61.

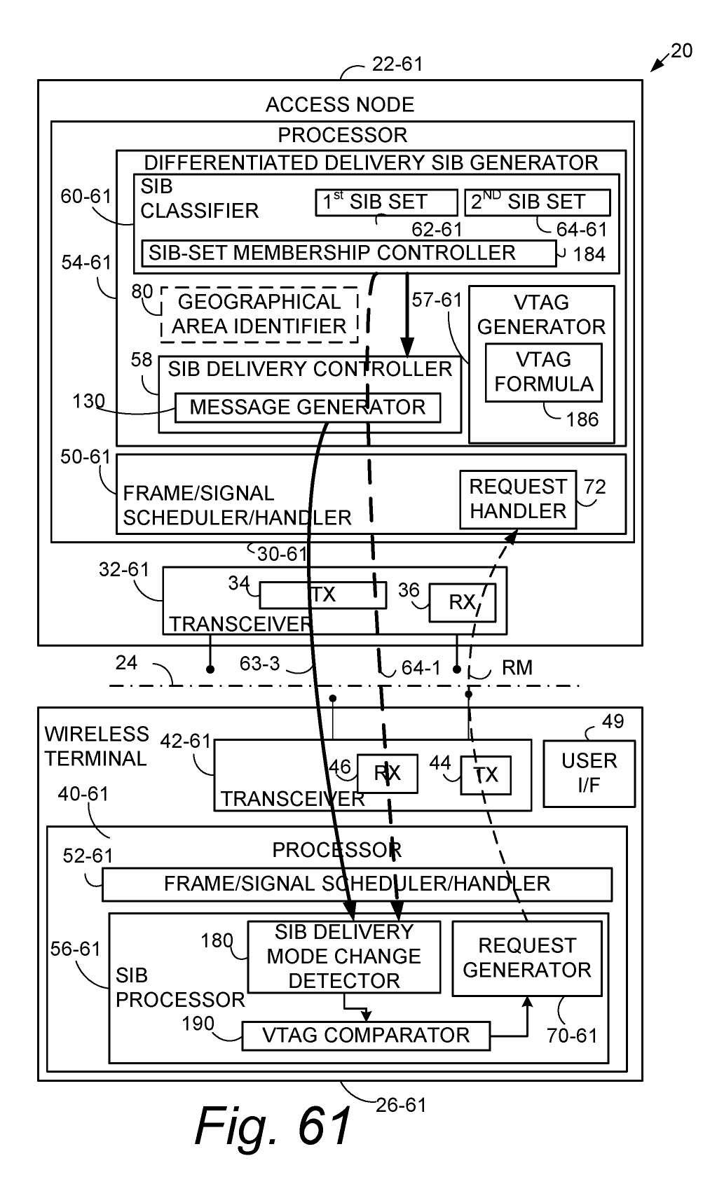

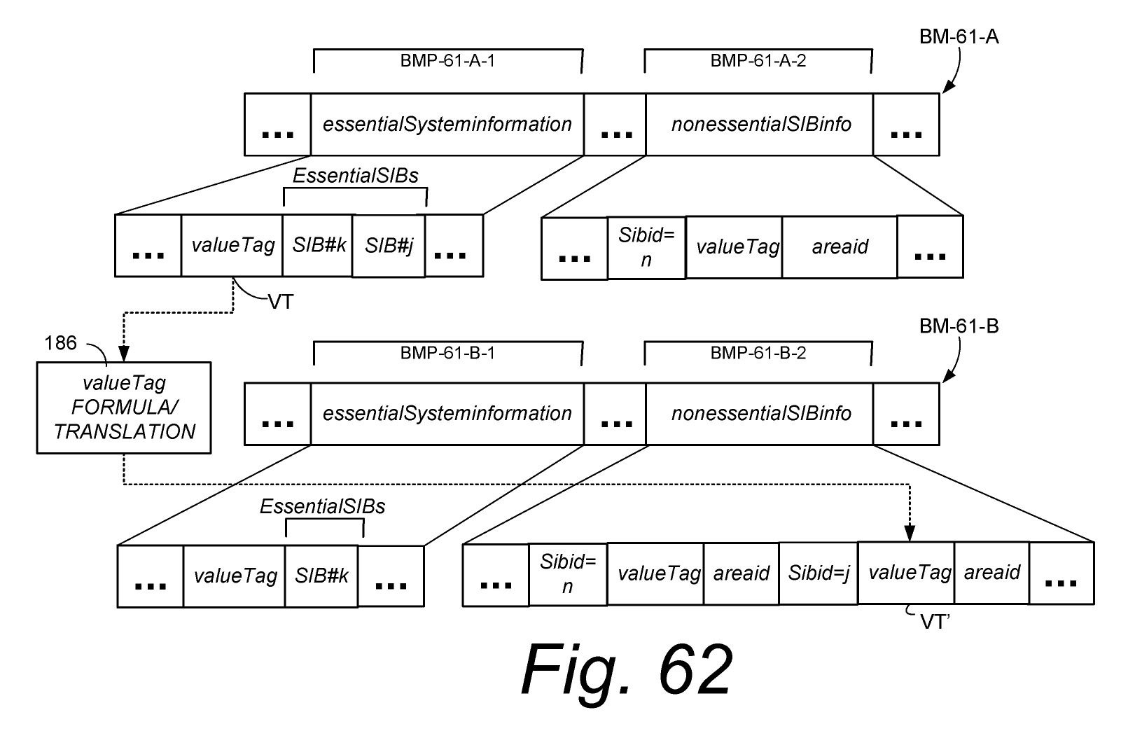

The node processor 30-61 of FIG. 61, and particularly message generator 130, is configured to generate broadcast messages, such as broadcast messages BM-61-A and BM-61-B hereinafter described with respect to FIG. 62. The broadcast messages are configured to include contents of system information blocks comprising a first set of system information blocks (SIBs). For example, the broadcast message BM-61-A of FIG. 62 includes contents of system information blocks (SIBs) SIB#k and SIB#j. The broadcast messages also inform that contents of at least one other system information block (SIB) is/are available upon demand (but such contents are not carried in the broadcast message per se). Thus, as shown by broadcast message BM-61-A, the contents of system information blocks (SIBs) of the first set (e.g., SIB#k and SIB#j) are provided to one or more wireless terminals using a broadcast delivery mode, but the system information blocks (SIBs) of the second set are provided to wireless terminal using an on-demand delivery mode. An example of a system information block (SIB) of the second set is the SIB having Sibid=n in FIG. 62.

Moreover, the node processor 30-61 of FIG. 61, and particularly SIB-set membership controller 184, is further configured to change the delivery mode for the particular system information block (SIB) when a particular system information block changes membership between the first set and the second set. A change of membership of a particular SIB changes the delivery mode of that particular SIB, as well as the constituency and/or composition of the broadcast message BM.

For sake of example illustration, FIG. 62 shows two broadcast messages of system information: broadcast message BM-61-A (considered a first broadcast message) and broadcast message BM-61-B (considered a second broadcast message). The broadcast messages each comprises two broadcast message portions: BMP-1 and BMP-2. That is, first broadcast message BM-61-A comprises first broadcast message first portion BMP-61-A-1 and first broadcast message second portion BMP-61-A- 2. Similarly, second broadcast message BM-61-B comprises second broadcast message first portion BMP-61-B-1 and second broadcast message second portion BMP-61-B-2. In general, the broadcast message first portion (e.g., first broadcast message first portion BMP-61-A-1 and second broadcast message first portion BMP-61-B-1) comprises contents of plural system information blocks and particularly system information blocks of first SIB set 62-61. On the other hand, the broadcast message second portions (e.g., first broadcast message second portion BMP-61-A-2 and second broadcast message second portion BMP-61-B-2) comprise identification of at least another system block (e.g., a system information block of second SIB set 64-61) whose contents is not included in either the broadcast message first portion or the broadcast second first portion.

In the above regard, a change of membership of SIB#j is reflected by the difference between broadcast message BM-61-A and broadcast message BM-61-B of FIG. 62. Before the membership change of SIB#j, the contents of SIB#j are included in first broadcast message first portion BMP-61-A-1. But after the membership change of SIB#j, the contents of the SIB#j are removed from first broadcast message first portion of subsequent system information broadcast messages, as reflected by second broadcast message first portion BMP-61-B-1. Moreover, after the membership change certain information concerning SIB#j (e.g., identifier [Sibid=n], valueTag, and (if applicable) areaid) are included in second broadcast message second portion BMP-61-B-2 of subsequent system information broadcast messages.

The transmitter circuitry node transceiver 32-61 of FIG. 61 is configured to transmit the broadcast messages over an air interface to the one or more wireless terminals, e.g., broadcast message BM-61-A before the membership change and broadcast message BM-61-B after the membership change.

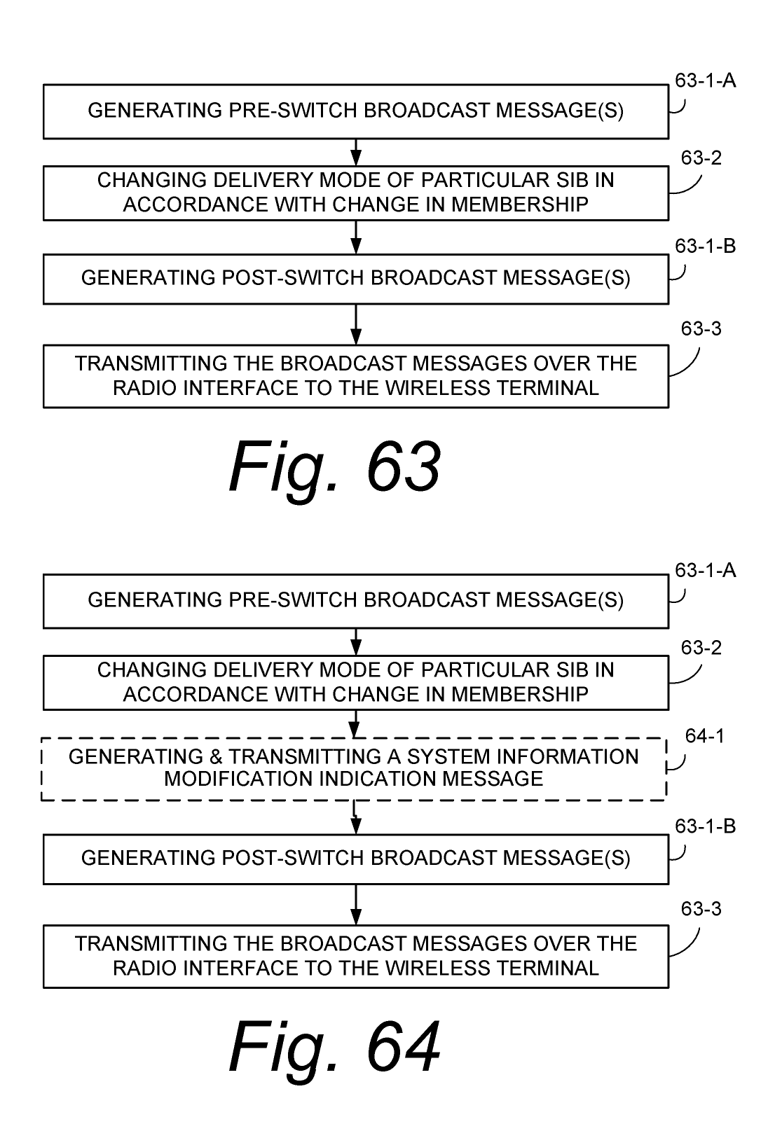

FIG. 63 shows example, representative, basic acts or steps performed by the access node 22-61 of FIG. 61, and node processor 30-61 in particular. Act 63-1-A and Act 63-1-B comprise the access node 22-61 generating broadcast messages. For example, Act 63-1-A comprises generating the broadcast message BM-61-A of FIG. 62. As understood from the foregoing, the broadcast messages include (in their broadcast message first portion) contents of system information blocks comprising a first set of system information blocks (SIBs) but (in their broadcast message second portion) inform that contents of at least one other system information block (SIB) is/are available upon demand. Act 63-1-A thus comprises generating a pre-switch broadcast message(s), as the broadcast messages generated by act 63-1-A occur prior to the membership change (e.g., the membership “switch”) of a particular SIB that occurs at act 63-2. Although illustrated for sake of simplicity by only SIB#j, it should be understood that a membership change may affect one or more system information blocks.

Act 63-2 comprises the node processor 30-61 changing the delivery mode for a particular system information block (SIB) when that particular system information block changes membership between the first set and the second set. In the example situation of FIG. 62, SIB#j changes membership from first SIB set 62-61 to second SIB set 64-61. The change in membership is reflected in FIG. 63 by generation of the broadcast message of Act 63-1-B occurring after the membership change of act 63-2, and is represented for example by broadcast message BM-61-B of FIG. 62. Act 63-1-B thus involves generation of a post-switch broadcast message, since act 63-1-B occurs after the delivery mode change and membership change of act 63-2.

Act 63-3 of FIG. 63 (also illustrated by an arrow 63-3 in FIG. 61) comprises the access node 22-61 transmitting the broadcast messages BM over an air interface to the one or more wireless terminals. The node transceiver 32-61 is configured to periodically transmit the broadcast messages, both before and after the change in membership. In this regard, the broadcast messages are transmitted by node transceiver 32-61 as they are generated, so that the broadcast message BM-61-A generated by act 63-1-A is transmitted before the membership change of act 63-2. The broadcast message BM-61-B generated by act 63-1-B is transmitted after the membership change of act 63-2. In the broadcast message BM-61-A generated by act 63-1-A the particular SIB SIB#j is delivered using a broadcast delivery mode (in broadcast message BM61-A). But after the membership change of act 63-2 the particular SIB SIB#j is delivered using an on-demand delivery mode, e.g., in a separate message generated by access node 22-61 which comprises the contents of the second set of system information blocks including the particular SIB SIB#j.

From FIG. 63 it should be understood that, when the particular system information block changes membership from the second set to the first set, the access node 22-61 is configured to change composition of subsequent system information broadcast messages by including contents of the particular system information block (SIB) in the broadcast message first portion of subsequent system information broadcast messages and removing an identifier of the particular system information block (SIB) from the broadcast message second portion. On the other hand, when the particular system information block changes membership from the first set to the second set, the access node 22-61 configured to change composition of the broadcast messages by deleting contents of the particular system information block (SIB) from the broadcast message first portion of subsequent system information broadcast messages and including an identifier of the particular system information block (SIB) in the broadcast message second portion of subsequent system information broadcast messages.

In the on-demand delivery mode the contents of a system information block (SIB) belonging to the second SIB set 64-61 may be transmitted in a separate message as described in other example embodiments and modes, e.g., after receipt of a request message from a wireless terminal. Such request message from a wireless terminal may be handled by request handler 72 shown in FIG. 61. The node transceiver 32-61 may transmit the separate message comprising contents of the second set of system information blocks using pre-determined resource allocations, as understood from previously described example embodiments and modes.

It should also be understood that the access node 22-61 may be configured to include, in the broadcast message second portion, for the at least one system information block comprising the second set of system information blocks, a geographical area identifier (areaid) which specifies a geographical area for which the value tag is valid. Such geographical area may be served by the access node and a group comprising at least one other access node.

It should further be understood that the system information block group context, with group indices, described in previous example embodiments and modes is also applicable to the example embodiment and mode of FIG. 61.

In an example implementation of the access node 22-61 of FIG. 61, the SIB-set membership controller 184 is configured to make a determination that the particular system information block is to change membership from the first set of system information blocks to the second set of system information blocks. The SIB-set membership controller 184 may choose to make this determination, and thus switch the delivery method of the particular system information block (SIB), for any number of reasons. For example, the SIB-set membership controller 184 may choose to switch or change the membership of the particular system information block, e.g., SIB SIB#j , from the first SIB set 62-61 to the second SIB set 64-61, and thus change the delivery mode from broadcast delivery to on-demand delivery, when the number of wireless terminals in the coverage area of access node 22-61 is low, e.g., is below a predetermined number. As another example reason, the access node may make the switch when a new node near by the node is introduced and activated, which will possibly change the traffic load.

Alternatively, rather than SIB-set membership controller 184 making the determination of the switch, the determination may be made elsewhere. For example, if there is a centralized node controller managing a plurality of access nodes, such centralized node controller may possibly make the determination.

Whether the membership/delivery mode change is made by SIB-set membership controller 184 or elsewhere, in some example embodiments and modes the access node 22-61 may optionally generate a special message-a system information modification indication—to inform one or more wireless terminals of the change in membership. FIG. 64 shows as act 64-1 such a system information modification indication (also illustrated by arrow 64-1 in FIG. 61) which is generated and transmitted after the membership and delivery mode change of act 63-2. The system information modification indication 64-1 may comprise a message which advises of system information updates and which is broadcast by access node 22-61, such as a paging message, for example. Alternatively, such system information modification indication may be included in the downlink physical layer signals, such as Downlink Control Information (DCI) on Physical Downlink Control Channel (PDCCH). The optional nature of act 64-1 and the system information modification indication is represented by broken lines in FIG. 64 and in FIG. 61.

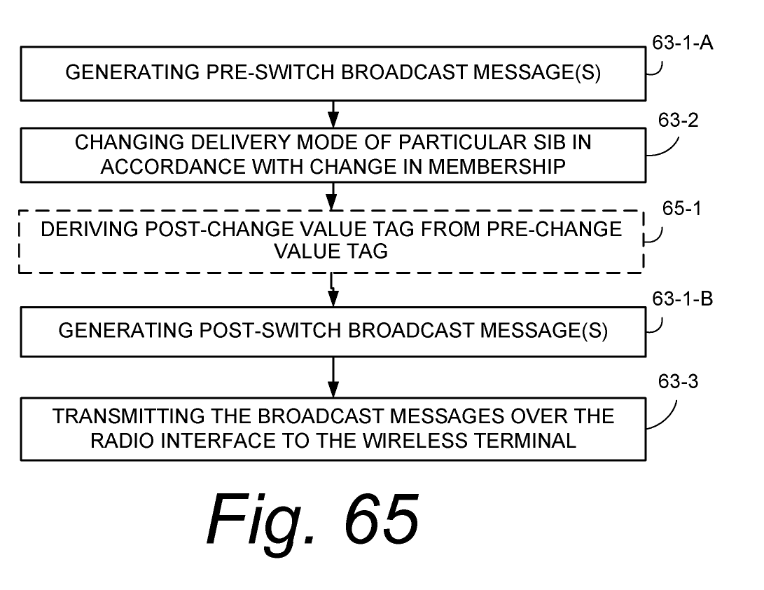

In a non-limiting optional example aspect of its operation, the access node 22-61 is configured, for the particular system information block which changes membership between the first set and the second set, to derive a post-change value tag for inclusion in the broadcast message second portion from a pre-change value tag which was previously included in the broadcast message for the particular system information block. FIG. 65 shows act 65-1 as comprising the node processor 30-61 (e.g., and VTAG generator 57-61 in particular) deriving a post-change value tag for inclusion in the broadcast message second portion from a pre-change value tag. The derivation of the post-change value tag from the pre-change value tag is also illustrated by FIG. 62, wherein the post-change value tag VT' included in the second broadcast message second portion BMP-61-B-2 for the particular SIB SIB#j is derived from the pre-change value tag VT which was associated with the particular SIB SIB#j in first broadcast message first portion BMP-61-A-1 before the membership change of the SIB SIB#j.

FIG. 62 further shows the derivation of the post-change value tag from the pre-change value tag may be performed by value tag formula/translation functionality 186 of access node 22-61 (e.g., of VTAG generator 57-61). By virtue of value tag formula/translation functionality 186 in some example embodiments and modes, the node processor circuitry is configured, for the particular system information block which changes membership between the first set and the second set, to derive the post-change value tag from the pre-change value tag using a pre-determined formula or translation, or a network-configured formula or translation. The, the value tag formula/translation functionality 186 serves to derive a post-change value tag for inclusion in the broadcast message second portion (e.g., second broadcast message second portion BMP-61-B-2) from a pre-change value tag which was previously included in the broadcast message (e.g., in first broadcast message first portion BMP-61-A-1) for the particular system information block. As illustrated by value tag VT′, the access node 22-61 may include the post-change value tag in the broadcast message.

In some example embodiments and modes the formula or translation serves to provide the post-change value tag as being identical to the pre-change value tag, e.g., VT′=VT. Other example formulas or translations are also possible, such as VT′=VT+k (where “k” is a predetermined number, and which would indicate that the range of VT' is separated from the range of VT.

Thus, as understood from FIG. 65, the access node 22-61 is configured, when transitioning a delivery method of a particular system information block from a first system information block that is periodically broadcast to a second system information that is transmitted by on-demand delivery, to use for the particular system information block a post-transition value tag that is derived from a pre-transition value tag that was associated with the particular system information block when the particular system information block comprised the first system information blocks.

FIG. 61 further shows the wireless terminal 26 as comprising terminal processor (circuitry) 40 and terminal transceiver (circuitry) 42. Unless otherwise noted, elements of the wireless terminal 26 of the example embodiment and mode of FIG. 61 are similar to comparably named and numbered elements of other embodiments (although for the FIG. 61 example embodiment and mode the reference number suffix may vary), including terminal transceiver 42-61 and terminal processor 40-61 (and various component functionalities of terminal processor 40-61 such as frame/signal scheduler/handler 52-61 and terminal SIB processor 56-61). The terminal SIB processor 56-61 comprises SIB delivery mode change detector 188 and SIB value tag comparator 190.

The terminal processor 40-61 of wireless terminal 26 is configured to obtain from each of the broadcast messages a broadcast message first portion and a broadcast message portion. As understood (for example) with reference to FIG. 62, the broadcast message first portion comprises contents of system information blocks which comprise a first set of system information blocks (e.g., first SIB set 62-61), and the broadcast message second portion comprises identification of at least one system information block comprising a second set of system information blocks (e.g., second SIB set 64-61). The second set of system information blocks comprise system information blocks whose contents is/are not included in either the broadcast message first portion or the broadcast message second portion.

SIB delivery mode change detector 188 is configured to detect when a particular system information block has changed membership between the first set and the second set. The SIB delivery mode change detector 188 may make such detection in various ways.

In some example embodiments and modes the SIB delivery mode change detector 188 may detect when the particular system information block has changed membership between the first set and the second set by detecting a changed composition of the broadcast messages. For example, if a particular SIB SIB#j changes membership from the first SIB set 62-61 to the second SIB set 64-61, the SIB delivery mode change detector 188 may contrast a post-change broadcast message such as broadcast message BM-61-B of FIG. 62 with a pre-change broadcast message such as broadcast message BM-61-A of FIG. 62, and note that the contents of the SIB SIB#j are no longer in first broadcast message first portion BMP-61-A-1, but instead that an identifier for SIB SIB#j is in second broadcast message second portion BMP-61-B-2.

In other example embodiments and modes, the SIB delivery mode change detector 188 may detect when the particular system information block has changed membership between the first set and the second set by receipt of a system information modification indication, such as system information modification indication 64-1 of FIG. 64, transmitted by access node 22-61.

The SIB value tag comparator 190 is configured to make a comparison, for the particular system information block which has changed membership, of a value tag associated with the particular system information block included in a broadcast message received before the changed membership and a value tag associated with the particular system information block included in a broadcast message received after the changed membership. For example, with reference to the particular SIB SIB#j of FIG. 62, the SIB value tag comparator 190 compares (1) the valueTag VT' included in the second broadcast message second portion BMP-61-B-2 for the particular SIB SIB#j of broadcast message BM-61-B received after the change with (2) the valueTag VT included in the first broadcast message first portion BMP-61-A-1 for the particular SIB SIB#j of broadcast message BM-61-B received before the change. The SIB value tag comparator 190 knows the formula or translation rule utilized by value tag formula/translation functionality 186 which should have been used by value tag formula/translation functionality 186 to derive the post-change valueTag VT′ from the pre-change valueTag VT, so if reverse application of the formula or transformation rule in fact does relate the post-change valueTag VT' to the pre-change valueTag VT, then the SIB value tag comparator 190 knows that the wireless terminal 26 already has the current contents of the particular SIB SIB#j and therefore does not need to obtain the current contents of SIB SIB#j (e.g. by making a request of wireless terminal 26 for the current contents of SIB SIB#j.

In a situation in which the particular SIB SIB#j changes membership from first SIB set 62-61 to second SIB set 64-61, and should the SIB value tag comparator 190 conclude that the version tag (valueTag VT') obtained from the second broadcast message second portion BMP-61-B-2 of a post-change broadcast message not relate to the pre-change valueTag VT, the SIB value tag comparator 190 further concludes that the contents of the particular SIB SIB#j has changed and, if needed by wireless terminal 26, must be obtained by a request message to access node 22-61. In this regard the wireless terminal 26 comprises the request generator 70-61 which, responsive, e.g., to SIB value tag comparator 190, sends a SIB request message to access node 22-61. Thus, the terminal processor 40-61 is configured, on the basis of the comparison performed by SIB value tag comparator 190, to generate a message (indicated by arrow RM in FIG. 61). The request message RM is configured to request the access node to transmit to the wireless terminal the contents of the particular system information block which has changed membership. The wireless terminal transmitter circuitry 44 of the wireless terminal 26 is configured to transmit the request message RM to the access node to request the contents of the particular system information block which has changed membership. The request message RM is shown by broken lines in FIG. 61 since the request message RM may not always be needed (e.g., not needed in the situation in which the SIB value tag comparator 190 determines a match between valueTag VT and valueTag VT′, for example).

FIG. 66 illustrates example, basic acts or steps performed by the wireless terminal 26 of FIG. 61. Act 66-1 comprises the wireless terminal 26 receiving system information broadcast messages over an air interface from an access node such as access node 22-61. As understood from the foregoing, the system information blocks (SIBs) which belong to first SIB set 62-61 are transmitted using a broadcast delivery mode and the system information blocks (SIBs) which belong to second SIB set 64-61 are transmitted using an on-demand delivery mode.

Act 66-2 comprises detecting when a particular system information block has changed membership between the first set and the second set. The detection of act 66-2 is understood with reference to the foregoing description of SIB delivery mode change detector 188.

Act 66-3 comprises comparing, for the particular system information block which has changed membership, a value tag associated with the particular system information block included in the broadcast messages before the changed membership and a value tag associated with the particular system information block included in the broadcast messages after the changed membership. The comparison of act 66-3 is understood with reference to the foregoing description of SIB value tag comparator 190.

As indicated above, if the comparison of act 66-3 so requires, further acts (shown as optional acts 66-4 and 66-5 in FIG. 66) may be performed. Act 66-4 comprises (as a result of the comparison of act 66-3) generating a message configured to request the access node to transmit to the wireless terminal the contents of the particular system information block which has changed membership. Act 66-5 comprises transmitting the request message (e.g., request message RM of FIG. 61) to the access node to request the contents of the particular system information block which has changed membership.

The example embodiments and modes of FIG. 61-FIG. 66 thus provide apparatus and method present to handle, e.g., the case where the eNB (e.g., access node 22-61) decides to switch the delivery method of an SIB from periodic broadcast to on-demand. The eNB may choose to conduct this operation when the number of wireless terminals (UEs) in its coverage area is becoming low. In this case, in order to indicate the new on-demand availability, the eNB may update the nonEssentialSIBInfo information element of the Essential System Information message by including sibId, valueTag and areaId of the SIB, where a pre-determined or network-configured formula may be used to derive this valueTag from the valueTag that the SIB was associated with before the switch. In some cases, the formula is simply configured to produce the identical value. The areaId of the SIB in the information element may be assigned if on-demand delivery of the SIB is available in a validity area, or may be omitted if on-demand delivery of the SIB is limited to this eNB.

When the UE receives the aforementioned updated Essential System Information message, the UE checks if the UE has previously received the SIB from the same eNB as a part of the essential system information via periodic broadcast. If so, the UE then checks if the valueTag of the SIB in the updated message matches the value produced by the pre-determined or network-configured formula using the previously received valueTag. If it matches, then the UE may refrain from requesting on-demand delivery of the SIB. In doing so, it is possible to suppress unnecessary requests from UEs.

As mentioned above, FIG. 62 illustrates an example of the message format before and after the switch. In one configuration, after the switch described above occurs, the eNB may inform UEs under coverage of the updates on the Essential System Information message by some means, such as a system information update indication broadcasted in Paging messages.

### 2nd Embodiments

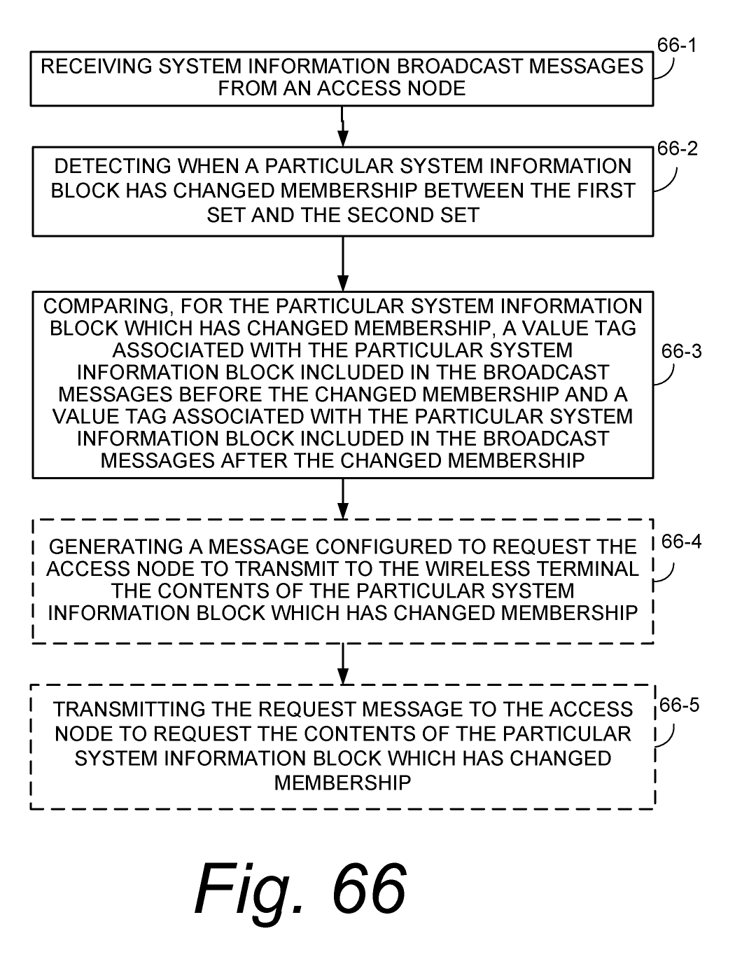

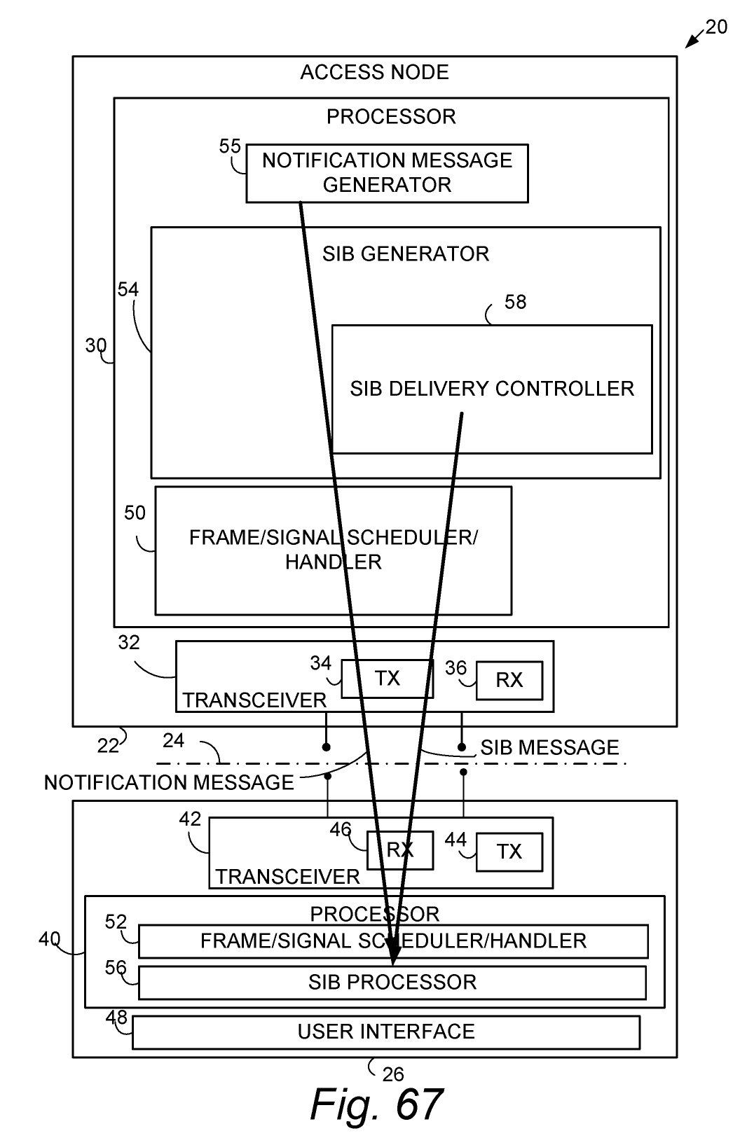

FIG. 67 shows an example communications system 20 wherein radio access node 22 communicates over air or radio interface 24 (e.g., Uu interface) with wireless terminal 26. As mentioned above, the radio access node 22 may be any suitable node for communicating with the wireless terminal 26, such as a base station node, eNodeB (“eNB”), or gNB, for example. The node 22 comprises node processor circuitry (“node processor 30”) and node transceiver circuitry 32. The node transceiver circuitry 32 typically comprises node transmitter circuitry 34 and node receiver circuitry 36, which are also called node transmitter and node receiver, respectively.

The wireless terminal 26 comprises terminal processor 40 and terminal transceiver circuitry 42. The terminal transceiver circuitry 42 typically comprises terminal transmitter circuitry 44 and terminal receiver circuitry 46, which are also called terminal transmitter 44 and terminal receiver 46, respectively. The wireless terminal 26 also typically comprises user interface 48. The terminal user interface 48 may serve for both user input and output operations, and may comprise (for example) a screen such as a touch screen that can both display information to the user and receive information entered by the user. The user interface 48 may also include other types of devices, such as a speaker, a microphone, or a haptic feedback device, for example.

For both the radio access node 22 and wireless terminal 26, the respective transceiver circuitries 32 and 42 include antenna(s). The respective transmitter circuits 34 and 44 may comprise, e.g., amplifier(s), modulation circuitry and other conventional transmission equipment. The respective receiver circuits 36 and 46 may comprise, e.g., e.g., amplifiers, demodulation circuitry, and other conventional receiver equipment.

In general operation node, 22 and wireless terminal 26 communicate with each other across radio interface 24 using predefined configurations of information. By way of non-limiting example, the radio access node 22 and wireless terminal 26 may communicate over radio interface 24 using “frames” of information that may be configured to include various channels. In Long Term Evolution (LTE), for example, a frame, which may have both downlink portion(s) and uplink portion(s), may comprise plural subframes, with each LTE subframe in turn being divided into two slots. The frame may be conceptualized as a resource grid (a two dimensional grid) comprised of resource elements (RE). Each column of the two dimensional grid represents a symbol (e.g., an OFDM symbol on downlink (DL) from node to wireless terminal; an SC-FDMA symbol in an uplink (UL) frame from wireless terminal to node). Each row of the grid represents a subcarrier. The frame and subframe structure serves only as an example of a technique of formatting of information that is to be transmitted over a radio or air interface. It should be understood that “frame” and “subframe” may be utilized interchangeably or may include or be realized by other units of information formatting, and as such may bear other terminology (such as blocks, for example).

To facilitate transmission of information between radio access node 22 and wireless terminal 26 over radio interface 24, the node processor 30 and terminal processor 40 of FIG. 67 are shown as comprising respective information handlers. For an example implementation in which the information is communicated via frames, the information handler for radio access node 22 is shown as node frame/signal scheduler/handler 50, while the information handler for wireless terminal 26 is shown as terminal frame/signal handler 52.

The node processor 30 of radio access node 22 also includes system information (SI) generator 54. The wireless terminal 26 uses the system information (SI) generated by radio access node 22, and even in some example implementations specifically requests certain system information (SI), in on-demand fashion. To that end the terminal processor 40 of wireless terminal 26 is shown as comprising SIB processor 56. The system information (SI) generator 54 also comprises SIB delivery controller 58, which controls the timing and content of delivery of system information (SI), and in some example embodiment and modes the SIB delivery controller 58 also controls the timing and delivery of certain node-available system information (“NASI”).

The system information (SI) generator 54 generates system information messages which comprise content of system information blocks. FIG. 68 depicts by solid vertical arrows the generation and transmission of system information messages, each solid vertical arrow being a separate system information message. The system information messages are shown in FIG. 68 as being generated over a horizontal axis depicting time, and in particular over three “modification periods”. The modification periods occur between modification period boundaries. The modification period boundaries are depicted in FIG. 68 by vertical dashed lines. FIG. 68 specifically shows four modification period boundaries: a first or left most modification period boundary which marks or delineates a beginning of a “previous” modification period; a second (from the left of FIG. 68) modification period boundary which marks an end of the “previous” modification period and a beginning of a “current” modification period; a third modification period boundary which marks an end of the “current” modification period and beginning of a “next” modification period; and, a fourth modification period boundary which marks an end of the “next” modification period. It should be understand that other modification periods may have occurred prior to the “previous” modification period, and that in the future further modification periods may occur after the “next” modification period.

A “modification period” can be any predefined time duration established by any predetermined convention. For example, the modification periods may be the same or akin to the concept of modification period as defined for LTE in 3GPP TS 36.304 as well as 36.331, both of which are incorporated herein by reference. It is anticipated that a similar time delineation may be used in future generations of technology, such as Fifth generation, and accordingly the modification period as used herein encompasses such similar time periods whether explicitly labeled as “modification period” or not.

The system information messages of FIG. 68 are shown as being periodic, with (for sake of example illustration) six system information messages transmitted between adjacent modification period boundaries. The number of system information messages between modification period boundaries is not confined or limited to six, since a greater or lesser number of system information messages may be transmitted. FIG. 68 depicts the system information messages of the “previous” modification period and the “current” modification period as “SIB XMT”, but the system information messages of the “next” modification period as “SIB′ XMT”. The unprimed reference to the system information messages of the “previous” modification period and the “current” modification period reflects the fact that the contents of the system information blocks of those system information messages do not change during the “previous” modification period and the “current” modification period. For example, for which ever of the system information messages in the “previous” modification period and the “current” modification period carry contents of SIB #2, the contents of each transmission of SIB #2 is the same as the other transmissions of SIB #2. Likewise, for which ever of the system information messages in the “previous” modification period and the “current” modification period carry contents of SIB #3, the contents of each transmission of SIB #3 is the same as the other transmissions of SIB #3. Of course, differently number system information blocks have different contents, but similarly numbered system information blocks have the same content in each of the “previous” modification period and “current” modification period of FIG. 68.

FIG. 68 differently depicts the system information messages of the “next” modification period as “SIB' XMT”. The primed notation “SIB′ ” indicates that the contents of at least one of the system information blocks carried in at least one of the system information messages has changed since a former modification period, e.g., since the current” modification period in the FIG. 68 scenario. For example, in the “next” modification period the content of the system information block SIB #2 may be changed from the content of the similarly numbered system information block SIB #2 of the “current” modification period. The change of content of any field or information element of the SIB #2 results in a “changed” SIB #2. Moreover, it is possible that, at the time that one type of system information block changes content (e.g., SIB #2), another system information block (e.g., SIB #4) may also have changed content.

The wireless terminal 26 of FIG. 67 may be able to discern or detect that content of a system information block has changed after the content has in fact been changed, e.g., after transmission of a system information message that includes the changed content of a system information block. For example, after the “next” modification period of FIG. 68 has begun, the terminal processor 40 may be able to determine or detect the changed content of one or more system information blocks. Such retroactive or reactionary detection of changed content of a system information block and switching over to the new system information block content may, however, require additional power consumption on the wireless terminal. In contrast, the node processor 30 of access node 22 of FIG. 67 comprises notification message generator 55. The notification message generator 55 generates a notification message which is configured to prospectively indicate a change of the content of at least one of the system information blocks. The notification message generator 55 generates notification messages NM which serve to alert one or more wireless terminals that the content of one or more system information blocks will change at the next modification period boundary. Preferably the notification message generator 55 is configured to schedule transmission by the transmitter circuitry of plural notification messages. For example, in the context of FIG. 68 the notification message generator 55 generates and the access node 22 transmits notification messages NM during the “current” modification period, thereby alerting the one or more wireless terminals that a change of content of one or more system information blocks will occur at the next modification period boundary, e.g., for the “next” modification period. The notification message generator 55 generates the notification messages NM in advance of a predetermined modification period boundary, in advance of the initial modification period boundary of the “next” modification period. In such case, the predetermined modification period boundary marks a beginning of a period in which the content of the at least one of the system information blocks changes from a previous modification period. The notification messages NM are shown by vertically dotted arrow in FIG. 68. For sake of example FIG. 68 illustrates five such notification messages NM, but a greater or lesser number may be generated.

The notification messages NM may also be referred to herein as “paging messages”. As such, the notification messages NM may, in some example embodiments and modes, take the form of conventional paging messages as understood in 3GPP. However, the notification messages NM are not limited to conventional paging messages and need not take the form of any specific type of message. In at least some example embodiments and modes the notification messages NMs may be broadcasted messages, not necessarily directed or confined to any particular wireless terminal and not necessarily intended for dissemination to plural wireless terminals served by the access node 22. Moreover, it should be understood (like conventional paging messages), that the radio resources that on which the access node 22 may transmit paging messages may be pre-determined and periodic. In fact, whether the access node 22 actually transmits on such a scheduled resource (e.g., at a particular time) is up to access node 22: if there is nothing to send, then the access node 22 may send nothing at that particular time. In some example embodiments and modes there is an agreement between the access node 22 and the wireless terminal(s) as to which resources the access node 22 uses for sending paging messages (if any) to that particular wireless terminal 26. Further, in some example embodiments and modes the wireless terminal 26 is supposed to monitor at least the agreed resources (paging occasions) to see if there is a paging message addressed to that particular wireless terminal 26. For example, in the example scenario of FIG. 68 the particular wireless terminal 26 of FIG. 67 knows, by pre-arranged convention, that the wireless terminal 26 is supposed to monitor the notification messages that are denoted by an asterisk, i.e., notification messages NM*.

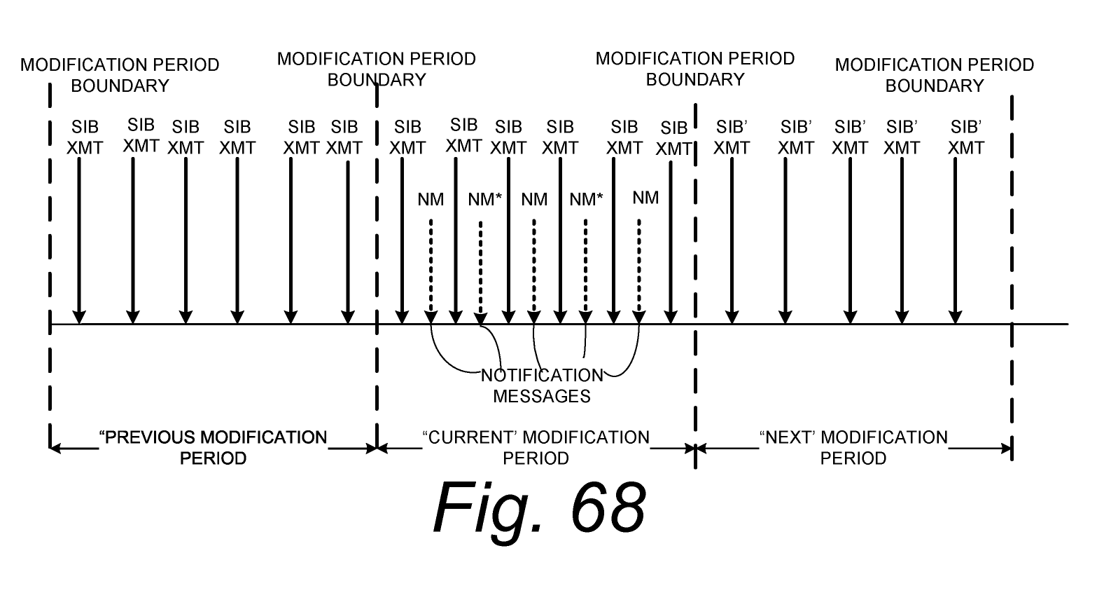

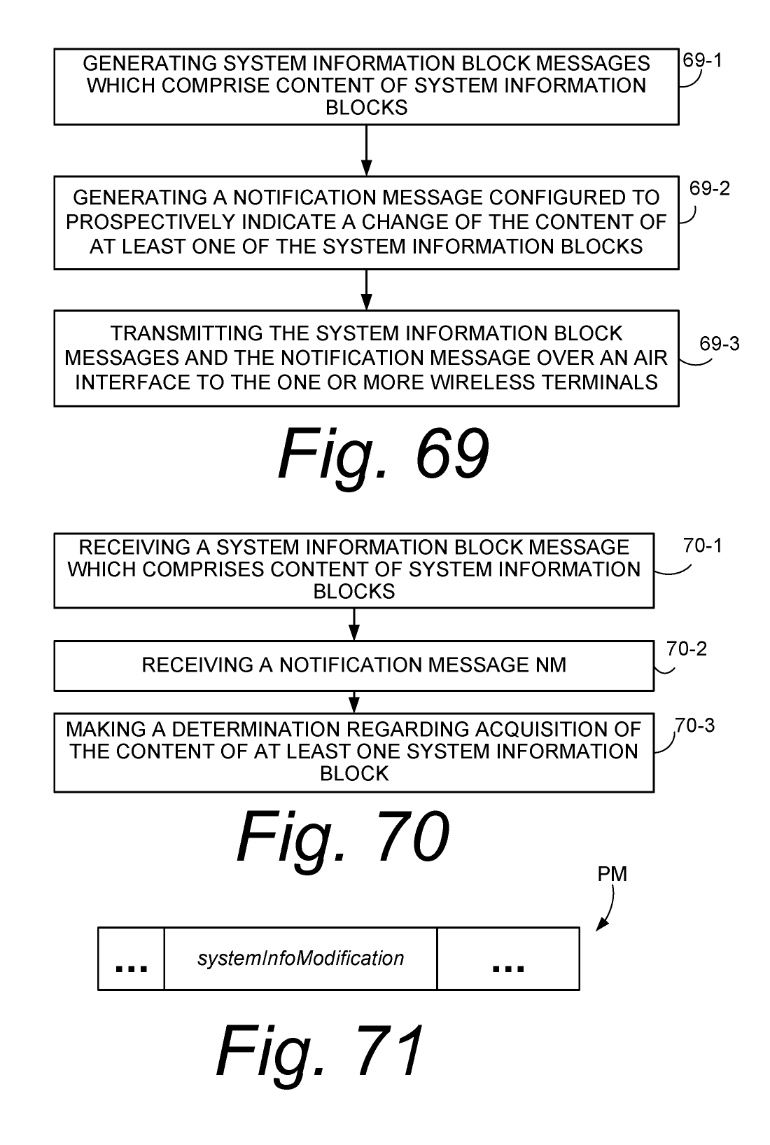

FIG. 69 illustrates example, representative basic acts or steps performed by access node 22 in conjunction with utilization of notification message generator 55. Act 69-1 comprises the node processor 30 generating system information messages which comprise content of system information blocks. One or more of such messages may be, for example, the Essential System Information message known in 3GPP. Act 69-2 comprises the notification message generator 55 generating a notification message configured to prospectively indicate a change of the content of at least one of the system information blocks. Act 69-3 comprises the transmitter circuitry 34 transmitting the system information messages and the notification message over an air interface 24 to the one or more wireless terminals.

In the example situation of FIG. 68, the system information messages may be the SIB XMT messages of the “current” modification period and the notification messages may be the notification messages NM of the “current” modification period. Each of system information messages and notification messages NM are transmitted at the proper time in the respective modification period, e.g., with the prescribed periodicity or other timing technique. The wireless terminal 26 looks for possible notification messages NM at certain times in the modification period, e.g., at the times that correspond to the transmission of notification messages NM* in FIG. 68.

Thus the wireless terminal 26 of FIG. 67 receives the system information messages and notification messages transmitted by the access node 22. The receiver circuitry 46 of wireless terminal 26 is configured to receive messages over the air interface 24 from the access node 22, including the system information messages (e.g., SIB XMT) which comprises content of system information blocks and appropriate ones of the notification message(s) NM configured to prospectively indicate of a change of content of at least one of the system information blocks. The terminal processor 40 of wireless terminal 26 uses the notification message NM addressed to or relevant to the wireless terminal 26 to make a determination regarding acquisition of the content of at least one system information block. In other words, the wireless terminal 26 uses the notification messages NM to realize that the wireless terminal 26 needs to obtain changed content of at least one of the system information blocks which the wireless terminal 26 utilizes.

FIG. 70 illustrates example, representative basic acts or steps performed by wireless terminal 26 in conjunction with utilization of a notification message. Act 70-1 comprises receiving a system information message which comprises content of system information blocks over the air interface 24 from the access node 22. Act 70-2 comprises receiving a notification message NM over the air interface 24 from the access node 22. The notification message NM is configured to prospectively indicate of a change of content of at least one of the system information blocks. Act 70-3 comprises the processor circuitry 40 making a determination regarding acquisition of the content of at least one system information block, e.g., when and how to acquire the one or more system information blocks since the wireless terminal 26 now knows that content has changed for at least one system information block effective at the initial modification period boundary for the “next” modification period.

The example embodiment and mode of FIG. 67-FIG. 70 thus describe how the wireless terminal 26 is notified of updates on the system information. In some example embodiments and modes, system information may be transmitted a number of times with the same content within a pre-defined period (i.e., the modification period). When changing any of the system information, the access node 22 may generate a notification messages NM that may comprise an information element which indicates that the system information will change at the next modification boundary. Upon receiving the change notification, the wireless terminal 26 may acquire the new system information immediately from the start of the next modification period.

In an example embodiment and mode, the notification messages NM is itself an optional field or information element (IE) in a Paging message (PM) and, if present, indicates that at least one of the system information blocks (SIBs) available from the access node 22 will be updated. For sake of example illustration, such an information element may be referred to as systemInfoModification. In one configuration, the information element may be a Boolean-type field, and in an example implementation the Boolean values may be in such a way that the ‘true’ value or binary 1 value may indicate the availability of system information updates, and the ‘false’ value or binary 0 value may indicate no system information updates. FIG. 71 illustrates one exemplary structure of the notification messages NM or Paging message containing an information element such as systemInfoModification. Thus, the processor circuitry 30 of access node 22 and of notification message generator 55 in particular may, for some example embodiments and modes, generate the notification message as comprising a paging message, and may generate the notification message as comprising an information element in the paging message. The information element may indicates a change of content of the at least one of the system information blocks.

When the wireless terminal 26 receives the notification message NM, from the next modification period boundary the wireless terminal may start acquiring the system information blocks. The “1st embodiment” as captioned and described above may provide example embodiments and modes (e.g. FIG. 1-FIG. 66) for acquiring system information blocks, and disclose technology which may be used in conjunction with the technology disclosed herein.

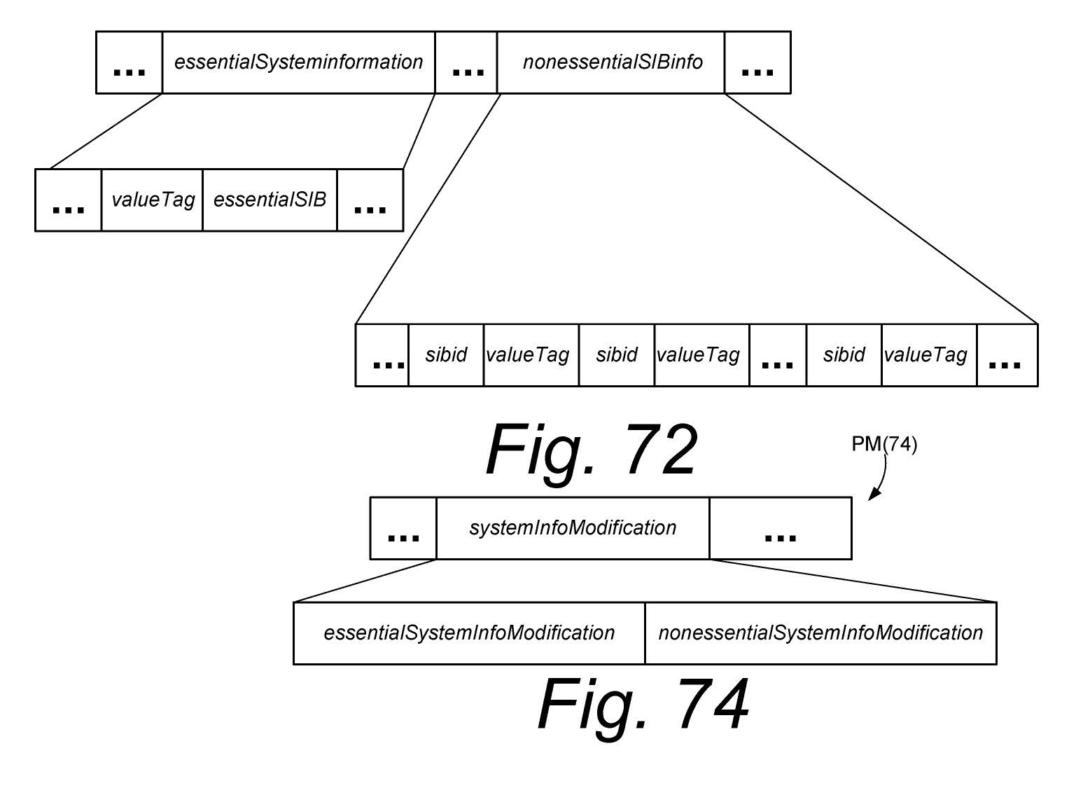

In some example embodiments and modes the content of one or more system information blocks may be obtained from an Essential System Information message, and particularly from an essentialSystemInformation information element which comprises the Essential System Information message. FIG. 72 shows an example format of an Essential System Information message according to an example embodiment and mode which shows, e.g., the essentialSystemInformation information element.

In addition, if the received Essential System Information message indicates scheduling information about other essential SIBs to be broadcasted separately from this message, the wireless terminal 26 may also attempt to acquire such essential SIBs. Furthermore, if the Essential System Information message indicates availability of non-essential SIBs (e.g., by one of the techniques described in the 1st embodiment as captioned and described above), the wireless terminal 26 may also attempt to acquire such non-essential SIBs accordingly. It should be noted that before attempting to acquire such SIBs, either essential or non-essential, the wireless terminal 26 may also check “value tags” associated with such SIBs (e.g., by one of the techniques described in one or more of the foregoing embodiments) which may be broadcasted in the Essential System Information message and may acquire only the SIBs that have updated value tags.

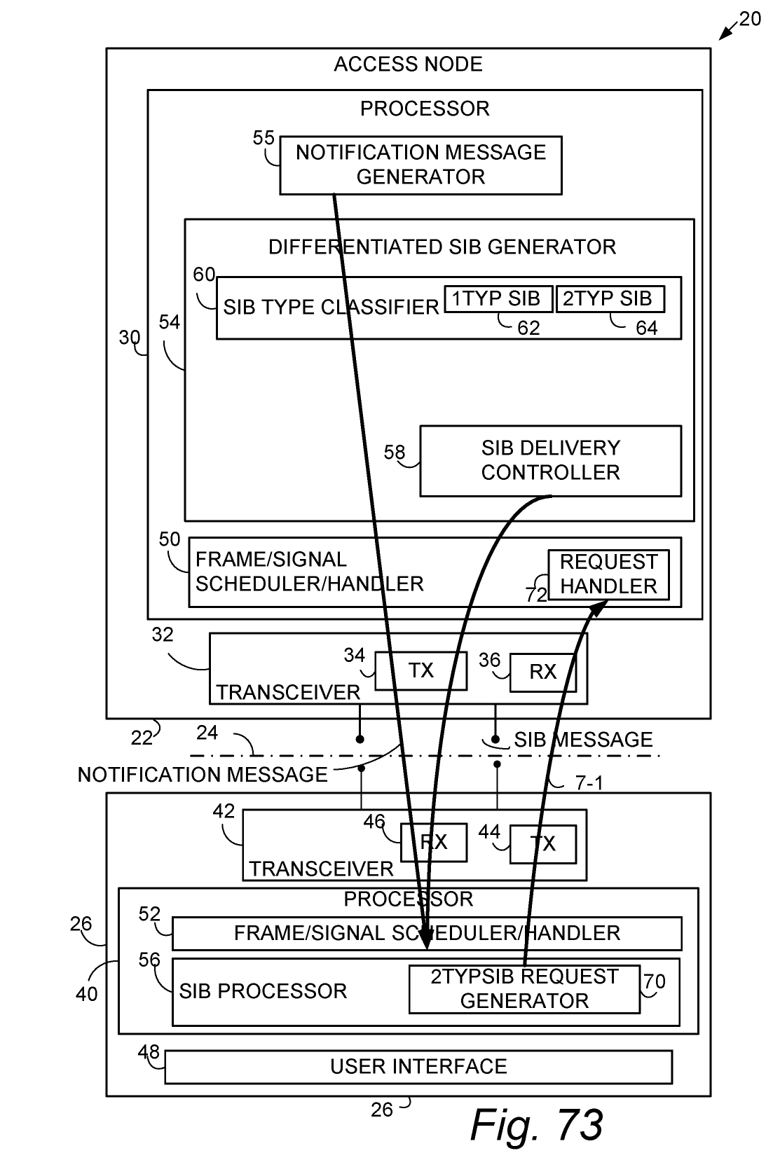

In some example embodiments and modes, such as that shown in FIG. 73, the system information (SI) may be classified into plural categories or types. Delivery of each category or type of system information (SI) may be separately triggered and thus may be separately delivered across radio interface 24 to one or more wireless terminals. Accordingly, for FIG. 73 the system information (SI) generator of radio access node 22 is also known as differentiated delivery SIB generator 54. The system information (SI) generator 54 is depicted in FIG. 73 as comprising SIB type classifier 60 which defines the plural categories or types of system information, and may further define an association between the plural types and respective system information blocks. For sake of example two representative categories or types of system information (SI) are shown as defined by the SIB type classifier 60 in FIG. 71: a first type of system information (1TYP SIB) and a second type of system information (2TYP SIB). Definitions and procedures for handling for the first type of system information (1TYP SIB) and the second type of system information (2TYP SIB) may be selectively configured and maintained, and are accordingly reflected by 1TYPSIB controller 62 and 2TYPSIB controller 64, respectively.

In an example embodiment and mode, the first type of system information (1TYP SIB) is SIB “essential system information”, which means system information (SI) which is essential to or minimally required by the wireless terminal 26 for initial access to the radio access network and to radio interface 24 in particular. Essential system information may be also referred as “minimum system information”. On the other hand, in the same example embodiment and mode, the second type of system information (2TYP SIB) is non-essential system information (SI). “Non-essential” system information (SI) is defined as all other types of information, and thus excludes the minimal information required for initial access. Non-essential system information may be also referred as “other system information”. As such the second type of system information (2TYP SIB) may facilitate utilization of certain features or services provided by or through radio access node 22. Thus, the first type system information comprises information which is periodically broadcasted by the transmitter and which is required for initial access to the radio access network, but the second type system information is not required for initial access to the radio access network.

In the example embodiment and mode of FIG. 73, the radio access node 22 separately delivers the different types of system information, e.g., delivers the second type of system information (2TYP SIB) separately from the first type of system information (1TYP SIB). For example, the node processor 30 may schedule periodic transmissions by the transmitter of first type system information over the radio interface; and thereafter or separately from the periodic transmissions of the first type system information, schedule transmission by the transmitter of second type system information over the radio interface. Accordingly, in example embodiments and modes, the SIB delivery controller 58, among other things, may implement the “differentiated” delivery of the second type of system information (2TYP SIB) apart from the first type of system information (1TYP SIB). As explained herein, the transmission of second type system information may be either by unicast or broadcast.

The wireless terminal 26 may, after obtaining initial access to the communications system 20 (e.g., as a result of receiving the first type of system information (1TYP SIB)), recognize or appreciate that the wireless terminal 26 may need the second type of system information (2TYP SIB). Thus the wireless terminal 26 may make a special request for the second type of system information (2TYP SIB). The FIG. 73 embodiment and mode is thus an example of the radio access node 22 providing second type system information “on demand”. Such request or demand for second type of system information (2TYP SIB) may arise, for example, when the wireless terminal 26 seeks to utilize a certain service provided by the communications system 20 or a functionality of wireless terminal 26 which, although not required for access, may enhance operation of wireless terminal 26. Accordingly, FIG. 73 shows the SIB processor 56 of wireless terminal 26 as comprising 2TYPSIB request generator 70, which may generate a 2TYPSIB request depicted by arrow 7-1.

For the example embodiment and mode of FIG. 73, SIB delivery controller 58 may control the timing and content of delivery of system information (SI), as well as timing and delivery of certain node-available system information (“NASI”) such as the non-essential system information. In an example embodiment and mode, illustrated in FIG. 72, the Essential System Information message includes both the essentialSystemInformation information element (which comprises content of one or more system information blocks) and a nonEssentialSIBInfo information element which, e.g., identifies the system information (e.g., the non-essential SIBs) that is available (e.g., “on demand”) from the radio access node 22 but which (e.g., for sake of signaling efficiency and economy) is not included in the Essential System Information message. As further shown in FIG. 72, a “value tag” or revision tag may or may not be associated with the available system information.

Thus in the FIG. 73 example embodiment and mode, the differentiated system information (SI) generator 54 generates a first set of system information blocks which are provided by the access node in a broadcast mode and a second set of system information blocks which are provided to a wireless terminal using an on-demand delivery mode. Moreover, in the example embodiment and mode of FIG. 73 the notification message generator 55 generates the notification message to prospectively indicate which of one or more of the first set of system information blocks and the second set of system information blocks will include a system information block comprising changed content. That is, the notification message generator 55 generates the notification messages NM to specify changed SIB content separately for each of the first set of system information blocks and the second set of system information blocks.

In an example implementation of FIG. 73, the notification message generator 55 of node processor 30 generates a notification message such as the paging message PM(74) shown in FIG. 74. The paging message PM(74) of FIG. 74 comprises a first field which prospectively indicates if the first set of system information blocks will include a system information block comprising changed content and a second field which prospectively indicates if the second set of system information blocks will include a system information block comprising changed content. Consistent with the FIG. 73 nomenclature, for sake of example the first field of the paging message PM(74) is labeled essentialSystemInfoModification and the second field is labeled nonessentialSystemInfoModification.

In an implementation of the example embodiment and mode of FIG. 73, notification message generator 55 may generate the first field (e.g., essentialSystemInfoModification) as a binary field which prospectively indicates if the first set of system information blocks will include a system information block comprising changed content, and may similarly generate the second field (e.g., nonessentialSystemInfoModification) as a binary field which prospectively indicates if the second set of system information blocks will include a system information block comprising changed content.

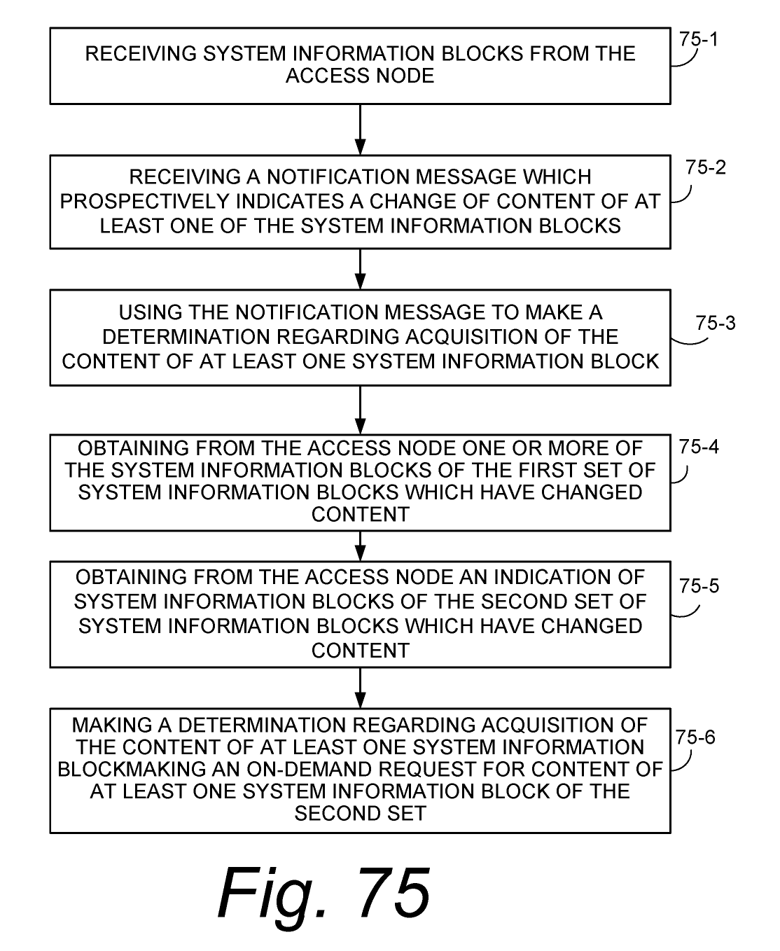

FIG. 75 shows example acts or steps performed by a wireless terminal of the example embodiment and mode of FIG. 73. Act 75-1 comprises the wireless terminal 26 receiving system information blocks from the access node 26, e.g., system information messages SIB XMT in the “current” modification period of FIG. 68, for example. Act 75-2 comprises receiving a notification message which prospectively indicates a change of content of at least one of the system information blocks. Such receipt of notification messages NM are shown during the “current” modification period in FIG. 68. In the FIG. 73 example embodiment and mode, the notification message NM has the form of the paging message PM(74) of FIG. 74 and thus comprises two fields: a first field which indicates whether one or more of the first type or “essential” system information blocks will have changed content in the “next” modification period, and a second field which indicates whether one or more of the second type or “non-essential” system information blocks will have changed content in the “next” modification period. Act 75-3 comprises the processor circuitry 40 of wireless terminal 26 using the notification message to make a determination regarding acquisition of the content of at least one system information block. In conjunction with the determination of act 75-3, the wireless terminal 26 determines from the first field of the paging message PM(74) of FIG. 74 if any system information blocks of the first set (essential SIBs) will have changed content, and determines from the second field of the paging message PM(74) of FIG. 74 if any system information blocks of the second set (non-essential SIBs) will have changed content. After the determination, as act 75-4 the wireless terminal 26, in the “next” modification period (see FIG. 68), obtains from the access node one or more of the system information blocks of the first set of system information blocks which have changed content in the “next” modification period. Act 75-4 may comprise obtaining the content of one or more of the system information blocks from the essentialSystemInformation information element of the Essential System Information message of FIG. 72, for example. As understood from the foregoing, the first set of system information blocks may be system information blocks which are provided by the access node in a broadcast mode. As act 75-5 the wireless terminal 26 may obtain from the access node an indication of system information blocks of the second set of system information blocks (non-essential system information blocks) which are provided to a wireless terminal using an on-demand delivery mode. Such indication may come, for example, from the nonEssentialSIBInfo information element of the Essential System Information message of FIG. 72. Thereafter as optional act 75-6, the wireless terminal 26 may make an on-demand request for content of at least one system information block of the second set.

Commenting further on FIG. 75, when the wireless terminal 26 receives a notification message and if the essentialSystemInfoModification information element of FIG. 75 indicates that the essential system information will be updated, in the next modification period (e.g., the “next” modification period of Fig.68) as act 75-4 the wireless terminal 26 may acquire the updated system information by receiving the Essential System Information message containing the essentialSystemInformation information element. In addition, if the Essential System Information message indicates scheduling information about other essential SIBs broadcasted separately from this message, the wireless terminal 26 may attempt to acquire such essential SIBs. Further, if the nonessentialSystemInfoModification information element indicates updates on the non-essential system information (see act 75-5), as act 75-6 the wireless terminal 26 may decide to acquire all of the non-essential SIBs available from the eNB. Alternatively, the wireless terminal 26 may first receive the Essential System Information message, read the value tags in the nonEssentialSIBInfo information element and find out the non-essential SIBs that are associated with the updated value tags. In either case, the wireless terminal 26 may attempt to acquire the non-essential SIBs that UE has decided to acquire by one of the aforementioned delivery methods.

Thus, for the example embodiment and mode of FIG. 73, and as reflected by the acts of FIG. 75, the processor circuitry 40 of wireless terminal 26 is further configured to obtain from the notification message a prospective indication that one or more of the first set of system information blocks will include a system information block comprising changed content and a prospective indication that one or more of the second set of system information blocks will include a system information block comprising changed content.

The example embodiment and mode of FIG. 73 and FIG. 74 thus provides additional granularity on information on the notification, with the systemInfoModification information element in the Paging message of FIG. 74 comprising two parameters: essentialSystemInfoModification that indicates some of the essential SIBs will be updated, and nonessentialSystemInfoModification that indicates some of the non-essential SIBs will be updated. In some example embodiments and modes the presence of essentialSystemInfoModification or nonessentialSystemInfoModification may indicate updates on at least one essential or non-essential SIBs, respectively. Alternatively, as mentioned above, the systemInfoModification may comprise two binary fields for the aforementioned two parameters, each of which may be the Boolean-type field.

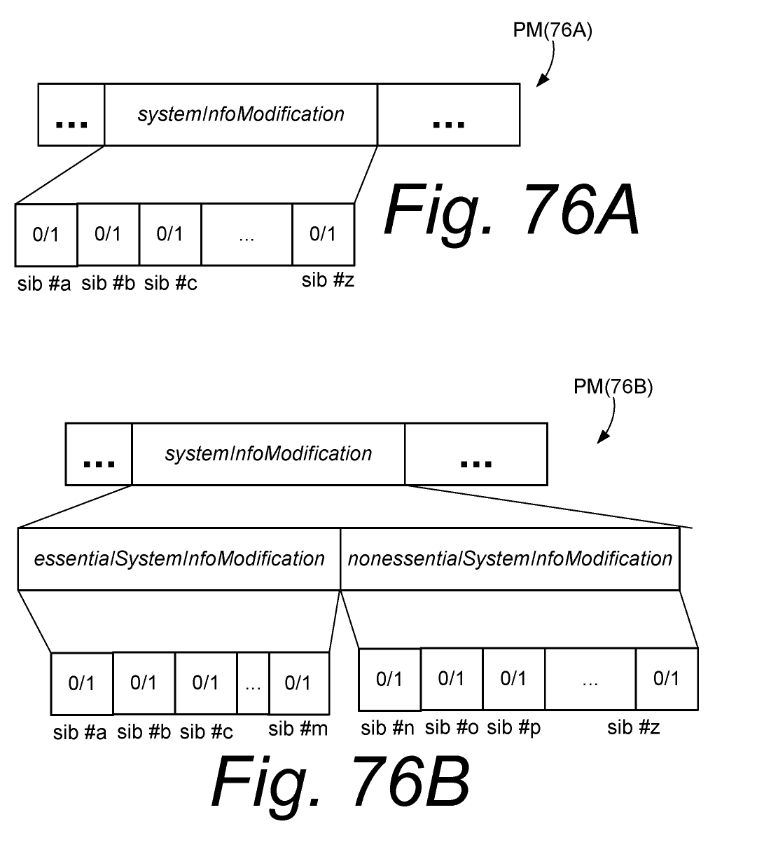

In some example embodiments and modes, the notification message NM may specifically indicate specifically which SIBs are to be updated. For example, in an implementation in which the notification message NM comprises the paging message PM, the systemInfoModification information element in the Paging message may specifically indicate which SIBs are to be updated. FIG. 76A shows an example format of a paging message PM(76A) which comprises a bitmap. Members of the bitmap correspond to respective system information block numbers and indicate by a binary value (e.g., either “1” or “0”) whether there will be a content change of the respective system information block at the next modification period boundary.

The bitmap representation of FIG. 76A can also be applied to the example embodiment and mode of FIG. 73 in which the notification message NM is segmented for differing categories or classes of system information blocks. For example, as shown by FIG. 76B, the notification message generator 55 may generate the first field (e.g., essentialsystemInfoModification) as a bitmap which prospectively indicates which system information blocks the first set of system information blocks (e.g., which of blocks SIB #a-SIB#m) will comprise changed content, and may similarly generate the second field (e.g., nonessentialSystemInfoModification) as a bitmap which prospectively indicates which of the system information blocks of the second set of system information blocks (e.g., which of blocks SIB #n-SIB#z) will comprise changed content. In the example of FIG. 76B, the terminal processor 40 decodes the first field as a bitmap which prospectively identifies the particular system information blocks of first set of system information blocks that will have changed content, and decodes the second field as a bitmap which prospectively identifies the particular system information blocks of second set of system information blocks that will have changed content.

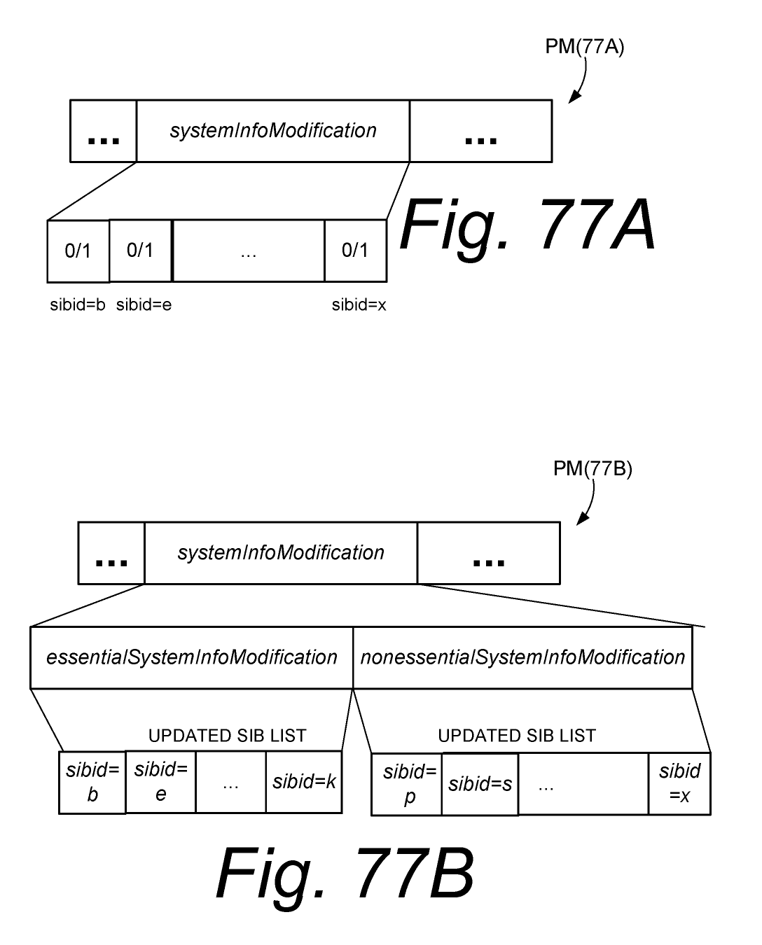

In another example of the example embodiment and mode of FIG. 73 which is illustrated in FIG. 77A, notification message generator 55 may generate the notification message to comprise a field (e.g., systemInfoModification) which prospectively identifies (e.g., by name or SIB block number or SIB identifier) the particular system information blocks that will have changed content. For example, in the example paging message PM(77A) of FIG. 77A the information element systemInfoModification lists system information blocks having identifiers sibid=b, sibid=e, and sibid=x among those with changed content. In the example of FIG. 77A, the terminal processor 40 obtains from the notification message a field (e.g., systemInfoModification) which comprises SIB identifiers of system information blocks which will have changed content.

In some example configurations and implementations of FIG. 77A and FIG. 77B, each SIB identifier in systemInfoModification may be encoded as a type of enumeration comprising of a list of SIB types (SIB1, SIB2, . . . ). For example, in the FIG. 77B example embodiment and mode the essentialSystemInfoModification information element or the nonessentialSystemInfoModification information element may comprise a list of identifiers (sibIds) only for updated essential or non-essential SIBs, respectively. Upon receiving the Paging message PM(76B) containing either essentialSystemInfoModification information element or the nonessentialSystemInfoModification information element or both, the wireless terminal 26 may determine which SIBs to acquire. Specifically, the wireless terminal 26 may attempt to acquire all the essential SIBs identified as updated by receiving the Essential System Information message, the other updated SIBs scheduled by the message, and/or the updated non-essential SIBs. If all of the updated SIBs are non-essential, the wireless terminal may not need to receive the Essential System Information message. Instead, the wireless terminal 26 may directly proceed with one of the aforementioned delivery method.

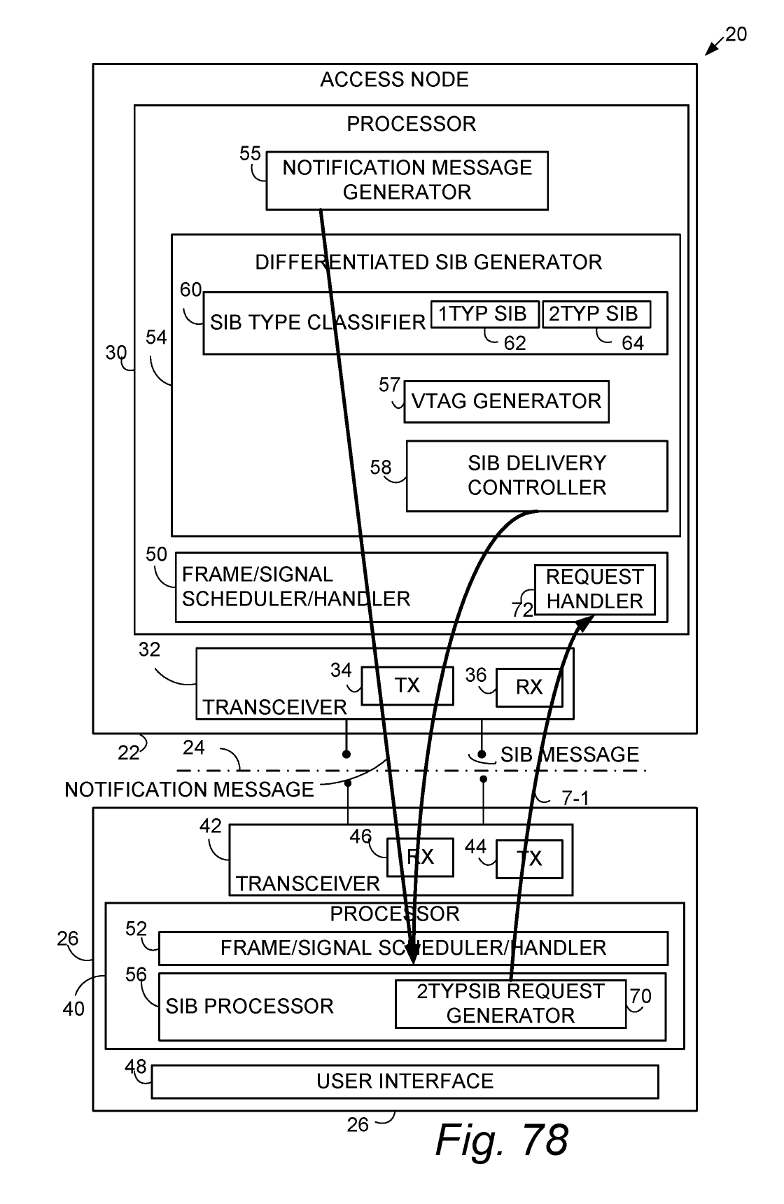

In some example embodiments and modes represented by FIG. 78, node processor 30, and system information (SI) generator 54 comprise value tag generator 57. The value tag generator 57 generates a value tag which is associated with the system information (SI). The value tag, also known as a version tag or “Vtag”, is configured to provide an indication of the version or vintage of system information with which the value tag is associated. In example implementations the value tag may take the form of a numeral or character, e.g., “1” for first version, “2” for second version, etc., or “A” for first version, “B”, for second version, etc. Any other convention for differentiating between values or versions may instead be employed. The value tag generator 57 serves, e.g., to change the value tag when a parameter of the system information is changed. For example, the value tag generator 57 may increment a number of the value tag when a parameter of the system information is changed.

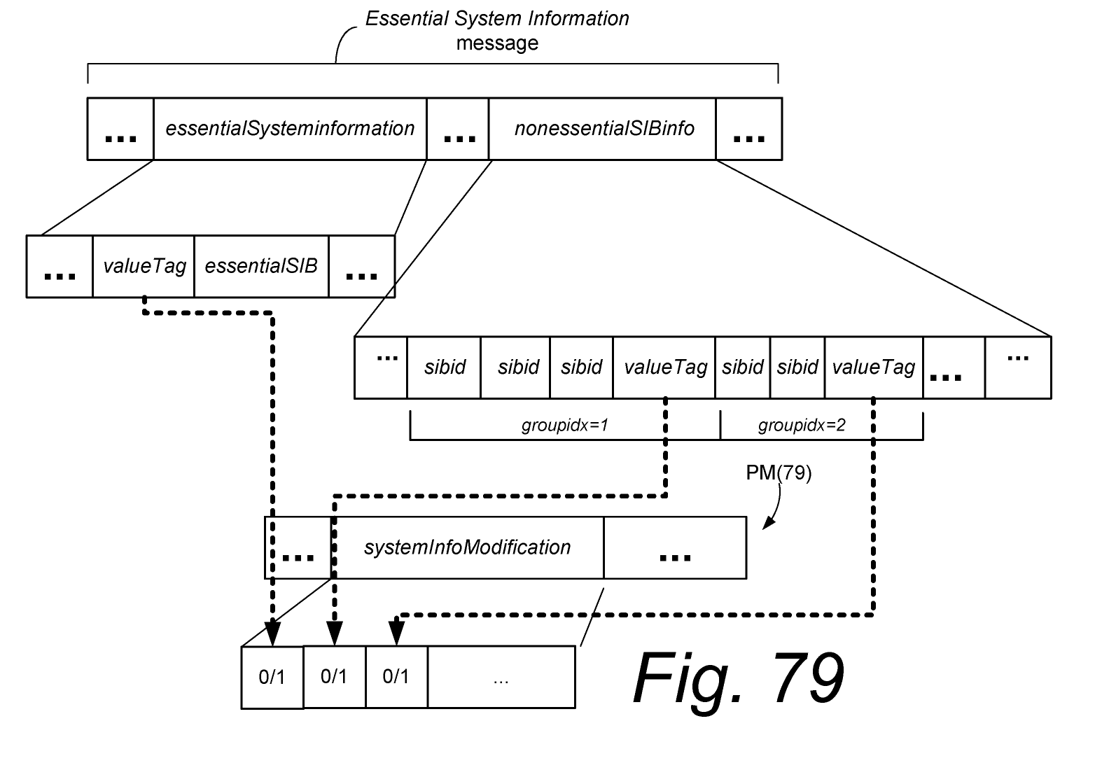

In the paging message PM(79) of FIG. 79 the structure of the systemInfoModification information element is derived from the structure of the value tags contained in the Essential System Information message. In FIG. 79, the Essential System Information message comprises the essentialSystemInformation information element and the nonessentialSystemInformation information element, as understood with reference to previous embodiments. The essentialSystemInformation information element includes contents of a representative essential SIB, i.e., essentialSIB, as well as a value tag associated with essentialSIB. For sake of illustration the value tag associated with essentialSIB is the known as the first value tag in FIG. 79. The nonessentialSystemInformation information element of FIG. 79 comprises multiple (e.g., two) system information block groups, each SIB group having a group identifier groupidx and an associated value tag. The first SIB group (having identifier groupidx=1) is associated with the illustrative second value tag of FIG. 79; the second SIB group (having identifier groupidx=2) is associated with the illustrative third value tag of FIG. 79. The valueTag in each non-essential SIB group of this message is updated when the content of at least one non-essential SIB belonging to this group changes. In one configuration, each non-essential SIB group may be associated with groupidx, an index of the group in the order of occurrence in the nonEssentialSIBInfo.

In the example embodiment and mode of FIG. 78 and FIG. 79, the update indications contained in the systemInfoModification information element of paging message PM(79) are mapped to the value tags included in the Essential System Information message using a pre-determined relationship. One example configuration of the pre-determined relationship is illustrated in FIG. 79, where the predetermined relationship is illustrated by dotted lined arrows. The systemInfoModification information element of paging message PM(79) comprises a bitmap of Boolean fields (each bit may be the aforementioned Boolean field), the n-th binary bit of which indicates the availability of updates on the SIBs associated with the n-th value tag in the Essential System Information message. From the foregoing it is seen a first bit of the systemInfoModification information element of paging message PM(79) indicates whether the system information block associated with the first illustrative value tag will have changed content; the second bit of the systemInfoModification information element of paging message PM(79) indicates whether the system information block(s) associated with the second illustrative value tag (e.g. the first system information block group in groupidx=1) will have changed content; and, the third bit of the systemInfoModification information element of paging message PM(79) indicates whether the system information block(s) associated with the third illustrative value tag (e.g. the second system information block group in groupidx=2) will have changed content.

Before receiving the Paging message PM(79), the wireless terminal 26 has already received a valid Essential System Information message either from the same access node 22 that transmits the Paging message or another access node capable of transmitting the Essential System Information message on behalf of the access node 22 that transmits said Paging message. When receiving the Paging message PM(79) the wireless terminal 26 may parse the bitmap in the systemInfoModification information element. For each bit of the bitmap the wireless terminal 26 finds the corresponding value tag in the Essential System Information message based on a pre-determined mapping relationship. For example, as mentioned above, the n-th binary bit of the bitmap may correspond to n-th value tag. The wireless terminal 26 then identifies the SIB/SIB groups associated with the value tag. If such a SIB/SIB group is an essential SIB/SIB group, the wireless terminal 26 may proceed to receiving the SIB/SIB group based on their broadcast schedule specified in the received Essential System Information message. On the other hand, if such a SIB/SIB group is a non-essential SIB/SIB group, the wireless terminal 26 may initiate the aforementioned non-essential SIB acquisition process, such as on-demand delivery request. If the bitmap indicates updates on only non-essential SIBs, the wireless terminal 26 does not need to receive the Essential System Information message and can instead directly proceed to the non-essential SIB acquisition.

Thus, as understood from the foregoing, the notification message generator 55 of FIG. 78 may generate the notification message (e.g., the paging message PM(79)) to comprise ordered information for a system information block(s) or group of system information blocks. The ordered information of the notification message is formatted in accordance with an order in which the value tags for the system information block(s) or group of system information blocks appear in the system information messages, the ordered information indicating whether the system information block(s) or group of system information blocks associated with the respective value tag will have changed content. As illustrated in FIG. 79, the ordered information of the notification message may comprise a bitmap comprising bit positions corresponding to the value tags which appear in the system information messages.

Features of any one or more of the example embodiments and modes described herein may be combined with any other example embodiment(s) and mode(s) described herein. For example, features of FIG. 1-FIG. 66 may be combined with the example embodiments and modes of FIG. 67-FIG. 79.

Certain units and functionalities of node 22 and wireless terminal 26 are, in example embodiments, implemented by electronic machinery, computer, and/or circuitry. For example, the node processors 30 and terminal processors 40 of the example embodiments herein described and/or encompassed may be comprised by the computer circuitry of FIG. 80. FIG. 60 shows an example of such electronic machinery or circuitry, whether node or terminal, as comprising one or more processor(s) circuits 190, program instruction memory 192; other memory 194 (e.g., RAM, cache, etc.); input/output interfaces 196; peripheral interfaces 198; support circuits 199; and busses 200 for communication between the aforementioned units.

The program instruction memory 192 may comprise coded instructions which, when executed by the processor(s), perform acts including but not limited to those described herein. Thus is understood that each of node processor 30 and terminal processor 40, for example, comprise memory in which non-transient instructions are stored for execution.

The memory 194, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 199 are coupled to the processors 190 for supporting the processor in a conventional manner. These circuits include cache, power supplies, clock circuits, input/output circuitry and subsystems, and the like.

The technology of this application thus encompasses but is not limited to the following example embodiments, example features, and example advantages:

Example Embodiment D-1: A user equipment (UE) for receiving system information, comprising:

a processor;

a memory in electronic communication with the processor, wherein instructions stored in the memory are executable to:
receive first system information periodically broadcasted from eNB;
determine types of second system information to additionally receive, wherein each of said types corresponds to a second system information block;
transmit to the eNB a request containing said types of the second system information; and,
receive the requested second system information from the eNB; and,
receive a notification of system information updates.

Example Embodiment D-2: The UE of Example Embodiment D-1, wherein the notification of system information updates is included in a Paging message.

Example Embodiment D-3: The UE of Example Embodiment D-1, wherein said notification includes a first indication and a second indication.

Example Embodiment D-4: The UE of Example Embodiment D-3, wherein the first indication indicates whether there are changes on at least one first system information block.

Example Embodiment D-5: The UE of Example Embodiment D-3, wherein the second indication indicates whether there are changes on at least one second system information block.

Example Embodiment D-6: The UE of Example Embodiment D-3, wherein the first indication specifies identifications of first system information blocks to be updated.

Example Embodiment D-7: The UE of Example Embodiment D-3, wherein the second indication specifies identifications of second information blocks to be updated.

Example Embodiment D-8: The UE of Example Embodiment D-6, wherein the first indication consists of a plurality of binary values, each of which indicates whether there is a change on a designated first system information block.

Example Embodiment D-9: The UE of Example Embodiment D-7, wherein the second indication consists of a plurality of binary values, each of which indicates whether there is a change on a designated second system information block.

Example Embodiment D-10: The UE of Example Embodiment D-6, wherein the first indication consists of a list of identifiers of first system information blocks that are updated.

Example Embodiment D-11: The UE of Example Embodiment D-3 or 7, wherein the second indication consists of a list of identifiers of second system information blocks that are updated.

Example Embodiment D-12: The UE of Example Embodiment D-1, wherein said notification consists of update indications, the association of each update indication to specific system information block being derived from the first system information.

Example Embodiment D-13: The UE of Example Embodiment D-12, wherein said plurality of update indications consist of at least one bitmap.

Example Embodiment D-14: The UE of Example Embodiment D-12, wherein each of said update indications is associated with a value tag transmitted in the first system information.

Example Embodiment D-15: The UE of Example Embodiment D-13, wherein said association between the update indications and the value tags are pre-determined.

Example Embodiment D-16: The UE of Example Embodiment D-15, wherein the n-th update indication is associated with the n-th value tag.

Example Embodiment D-17: The UE of Example Embodiment D-1, wherein the UE attempts to acquire the updated system information upon receiving said notification.

Example Embodiment D-18: The UE of Example Embodiment D-17, wherein the UE attempts to acquire the first system information upon receiving said notification.

Example Embodiment D-19: The UE of Example Embodiment D-15, wherein the UE attempts to acquire the second system information upon receiving said notification.

Example Embodiment D-20: The UE of Example Embodiment D-18, wherein the UE further attempts to acquire other system information blocks transmitted separately from the received first system information.

Example Embodiment D-21: The UE of Example Embodiment D-20, wherein said other system information blocks are first system information blocks.

Example Embodiment D-22: The UE of Example Embodiment D-21, wherein the UE obtains the broadcast schedule information of said other information blocks from the received first system information.

Example Embodiment D-23: The UE of Example Embodiment D-20, wherein said other system information blocks are second system information blocks.

Example Embodiment D-24: The UE of Example Embodiment D-18, wherein the UE further reads the value tags included in the acquired first system information and attempts to acquire system information blocks associated with the value tags changed from the value tags included in a previously received first system information.

Example Embodiment D-25: The UE of Example Embodiment D-24, wherein said system information blocks are first system information blocks.

Example Embodiment D-26: The UE of Example Embodiment D-25, wherein the UE obtains the broadcast schedule information of said other information blocks from the received first system information.

Example Embodiment D-27: The UE of Example Embodiment D-24, wherein said other system information blocks are second system information blocks.

Example Embodiment D-28: The UE of Example Embodiment D-3, wherein the UE attempts to acquire the first system information upon receiving said notification in which the first indication indicates updates on the first system information.

Example Embodiment D-29: The UE of Example Embodiment D-3, wherein the UE attempts to acquire the second system information upon receiving said notification in which the second indication indicates updates on the second system information.

Example Embodiment D-30: The UE of Example Embodiment D-3, wherein the UE first acquire the first system information upon receiving said notification in which the second indication indicates updates on the second system information, then further attempts to acquire second system information blocks.

Example Embodiment D-31: The UE of Example Embodiment D-30, wherein the second system information blocks that the UE attempts to acquire are updated second system information blocks whose value tags included in the first system information are updated.

Example Embodiment D-32: The UE of Example Embodiment D-6, wherein the UE attempts to acquire the first system information blocks for which said binary values indicate changes.

Example Embodiment D-33: The UE of Example Embodiment D-9, wherein the UE attempts to acquire the second system information blocks for which said binary values indicate changes.

Example Embodiment D-34: The UE of Example Embodiment D-10, wherein the UE attempts to acquire the first system information blocks whose identifiers are included in the list of identifiers of first system information blocks that are updated.

Example Embodiment D-35: The UE of Example Embodiment D-11, wherein the UE attempts to acquire the second system information blocks whose identifiers are included in the list of identifiers of second system information blocks that are updated.

Example Embodiment D-36: The UE of Example Embodiment D-12, wherein using a previously received first system information the UE associates each of said update indications to one or a plurality of system information blocks.

Example Embodiment D-37: The UE of Example Embodiment D-36, wherein said association is among each of the update indicators, one value tag included in the first system information and the system information blocks associated with the value tag.

Example Embodiment D-38: The UE of Example Embodiment D-36, wherein the UE attempts to acquire the system information block or a plurality of system information blocks for which the associated update indication indicates availability of updates.

Example Embodiment D-39: The UE of Example Embodiment D-38, wherein said one or a plurality of updated system information blocks are first system information blocks.

Example Embodiment D-40: The UE of Example Embodiment D-38, wherein said one or a plurality of updated system information blocks are second system information blocks.

Example Embodiment D-41: An evolved node B (eNB) for delivering system information, comprising:

a processor;

a memory in electronic communication with the processor, wherein instructions stored in the memory are executable to:
periodically broadcast first system information that includes types of second system information available by request, wherein each of said types corresponds to a second system information block;
receive from a UE a request for transmission of said second system information;
transmit said requested second system information; and,
transmit a notification of system information updates.

Example Embodiment D-42: The eNB of Example Embodiment D-41, wherein the notification of system information updates is included in a Paging message.

Example Embodiment D-43: The eNB of Example Embodiment D-41, wherein said notification includes a first indication and a second indication.

Example Embodiment D-44: The eNB of Example Embodiment D-43, wherein the first indication indicates whether there are changes on at least one first system information block.

Example Embodiment D-45: The eNB of Example Embodiment D-43, wherein the second indication indicates whether there are changes on at least one second system information block.

Example Embodiment D-46: The eNB of Example Embodiment D-43, wherein the first indication specifies identifications of first system information blocks to be updated.

Example Embodiment D-47: The eNB of Example Embodiment D-43, wherein the second indication specifies identifications of second system information blocks to be updated.

Example Embodiment D-48: The eNB of Example Embodiment D-46, wherein the first indication consists of a plurality of binary values, each of which indicates whether there is a change on a designated first system information block.

Example Embodiment D-49: The eNB of Example Embodiment D-47, wherein the second indication consists of a plurality of binary values, each of which indicates whether there is a change on a designated second system information block.

Example Embodiment D-50: The eNB of Example Embodiment D-46, wherein the first indication consists of a list of identifiers of first system information blocks that are updated.

Example Embodiment D-51: The eNB of Example Embodiment D-47, wherein the second indication consists of a list of identifiers of second system information blocks that are updated.

Example Embodiment D-52: The eNB of Example Embodiment D-41, wherein said notification consists of update indications, the association of each update indication to specific system information block being derived from the first system information.

Example Embodiment D-53: The eNB of Example Embodiment D-51, wherein said plurality of update indications consist of at least one bitmap.

Example Embodiment D-54: The eNB of Example Embodiment D-52, wherein each of said update indications is associated with a value tag transmitted in the first system information.

Example Embodiment D-55: The eNB of Example Embodiment D-53, wherein said association between the update indications and the value tags are pre-determined.

Example Embodiment D-56: The eNB of Example Embodiment D-54, wherein the n-th update indication is associated with the n-th value tag.

Example Embodiment D-57: A method for a user equipment (UE) comprising: receiving first system information periodically broadcasted from eNB;

determining types of second system information to additionally receive;

transmitting to the eNB a request containing said types of the second system information, wherein each of said types corresponds to a second system information block; and,

receiving the requested second system information from the eNB; and, receive a notification of system information updates.

Example Embodiment D-58: A method for an evolved node B (eNB) comprising:

periodically broadcasting first system information that includes types of second system information available by request;

receiving from a UE a request for transmission of said second system information, wherein each of said types corresponds to a second system information block; and,

transmitting said requested second system information; and,

transmit a notification of system information updates.

Example Embodiment P-1: An access node comprising:

processor circuitry configured to:
generate system information messages which comprise content of system information blocks;
generate a notification message configured to prospectively indicate a change of the content of at least one of the system information blocks;

transmitter circuitry configured to transmit the system information messages and the notification message over an air interface to the one or more wireless terminals.

Example Embodiment P-2: The access node of Example Embodiment P-1, wherein the processor circuitry is further configured to generate the notification message for transmission by the transmitter circuitry in advance of a predetermined modification period boundary.

Example Embodiment P-3: The access node of Example Embodiment P-2, wherein the predetermined modification period boundary marks a beginning of a period in which the content of the at least one of the system information blocks changes from a previous modification period.

Example Embodiment P-4: The access node of Example Embodiment P-2, wherein the processor circuitry is further configured to schedule transmission by the transmitter circuitry of plural notification messages.

Example Embodiment P-5: The access node of Example Embodiment P-4, wherein the processor circuitry is further configured to schedule transmission by the transmitter circuitry of the plural notification messages to precede the predetermined modification period boundary.

Example Embodiment P-6: The access node of Example Embodiment P-1, wherein the processor circuitry is further configured to generate the notification message as comprising a paging message.

Example Embodiment P-7: The access node of Example Embodiment P-6, wherein the processor circuitry is further configured to generate the notification message as comprising an information element in the paging message.

Example Embodiment P-8: The access node of Example Embodiment P-1, wherein the processor circuitry is further configured to generate the notification message as comprising an information element that indicates a change of content of the at least one of the system information blocks.

Example Embodiment P-9: The access node of Example Embodiment P-1, wherein the processor circuitry is further configured:

to generate a first set of system information blocks which are provided by the access node in a broadcast mode and a second set of system information blocks which are provided to a wireless terminal using an on-demand delivery mode;

to generate the notification message to prospectively indicate which of one or more of the first set of system information blocks and the second set of system information blocks will include a system information block comprising changed content.

Example Embodiment P-10: The access node of Example Embodiment P-9, wherein the processor circuitry is further configured to generate the notification message to comprise a first field which prospectively indicates if the first set of system information blocks will include a system information block comprising changed content and a second field which prospectively indicates if the second set of system information blocks will include a system information block comprising changed content.

Example Embodiment P-11: The access node of Example Embodiment P-10, wherein the processor circuitry is further configured to generate the first field as a binary field which prospectively indicates if the first set of system information blocks will include a system information block comprising changed content and to generate the second field as a binary field which prospectively indicates if the second set of system information blocks will include a system information block comprising changed content.

Example Embodiment P-12: The access node of Example Embodiment P-9, wherein the processor circuitry is further configured to generate the notification message to comprise a first field which prospectively identifies particular system information blocks of the first set of system information blocks that will have changed content and a second field which prospectively identifies particular system information blocks of the second set of system information blocks that will have changed content.

Example Embodiment P-13: The access node of Example Embodiment P-12, wherein the processor circuitry is further configured to generate the first field as a bitmap which prospectively identifies the particular system information blocks of first set of system information blocks that will have changed content and to generate the second field as a bitmap which prospectively identifies the particular system information blocks of second set of system information blocks that will have changed content.

Example Embodiment P-14: The access node of Example Embodiment P-9, wherein the processor circuitry is further configured to generate the notification message to prospectively indicate which system information blocks of the first set and which system information blocks of the second set will include a system information block comprising changed content.

Example Embodiment P-15: The access node of Example Embodiment P-14, wherein the processor circuitry is further configured to generate the notification message to comprise a first field which comprises identifiers of the first set of system information blocks which will include a system information block comprising changed content and to comprise a second field which comprises identifiers of the second set of system information blocks will include a system information block comprising changed content.

Example Embodiment P-16: The access node of Example Embodiment P-1, wherein the processor circuitry is further configured:

to generate the system information messages to associate a value tag with a system information block or group of system information blocks;

to generate the notification message to comprise ordered information for a system information block(s) or group of system information blocks, the ordered information of the notification message being formatted in accordance with an order in which the value tags for the system information block(s) or group of system information blocks appear in the system information messages, the ordered information indicating whether the system information block(s) or group of system information blocks associated with the respective value tag will have changed content.

Example Embodiment P-17: The access node of Example Embodiment P-16, wherein the processor circuitry is further configured to generate the ordered information of the notification message to comprise a bitmap comprising bit positions corresponding to the value tags which appear in the system information messages.

Example Embodiment P-18: A method in an access node comprising:

using processor circuitry to:generate system information messages which comprise content of system information blocks;

generate a notification message configured to prospectively indicate a change of the content of at least one of the system information blocks;

transmitting the system information messages and the notification message over an air interface to the one or more wireless terminals.

Example Embodiment P-19: The method of Example Embodiment P-18, further comprising using the processor circuitry to generate the notification message for transmission by the transmitter circuitry in advance of a predetermined modification period boundary.

Example Embodiment P-20: The method of Example Embodiment P-19, wherein the predetermined modification period boundary marks a beginning of a period in which the content of the at least one of the system information blocks changes from a previous modification period.

Example Embodiment P-21: The method of Example Embodiment P-19, further comprising using the processor circuitry to schedule transmission by the transmitter circuitry of plural notification messages.

Example Embodiment P-22: The method of Example Embodiment P-21, further comprising using the processor circuitry to schedule transmission by the transmitter circuitry of the plural notification messages to precede the predetermined modification period boundary.

Example Embodiment P-23: The method of Example Embodiment P-18, further comprising using the processor circuitry to generate the notification message as comprising a paging message.

Example Embodiment P-24: The method of Example Embodiment P-23, further comprising using the processor circuitry to generate the notification message as comprising an information element in the paging message.

Example Embodiment P-25: The method of Example Embodiment P-18, further comprising using the processor circuitry to generate the notification message as comprising an information element that indicates a change of content of the at least one of the system information blocks.

Example Embodiment P-26: The method of Example Embodiment P-18, further comprising using the processor circuitry:

to generate a first set of system information blocks which are provided by the access node in a broadcast mode and a second set of system information blocks which are provided to a wireless terminal using an on-demand delivery mode;

to generate the notification message to prospectively indicate which of one or more of the first set of system information blocks and the second set of system information blocks will include a system information block comprising changed content.

Example Embodiment P-27: The method of Example Embodiment P-26, further comprising using the processor circuitry to generate the notification message to comprise a first field which prospectively indicates if the first set of system information blocks will include a system information block comprising changed content and a second field which prospectively indicates if the second set of system information blocks will include a system information block comprising changed content.

Example Embodiment P-28: The method of Example Embodiment P-27, further comprising using the processor circuitry to generate the first field as a binary field which prospectively indicates if the first set of system information blocks will include a system information block comprising changed content and to generate the second field as a binary field which prospectively indicates if the second set of system information blocks will include a system information block comprising changed content.

Example Embodiment P-29: The method of Example Embodiment P-26, further comprising using the processor circuitry to generate the notification message to comprise a first field which prospectively identifies particular system information blocks of the first set of system information blocks that will have changed content and a second field which prospectively identifies particular system information blocks of the second set of system information blocks that will have changed content.

Example Embodiment P-30: The method of Example Embodiment P-29, further comprising using the processor circuitry to generate the first field as a bitmap which prospectively identifies the particular system information blocks of first set of system information blocks that will have changed content and to generate the second field as a bitmap which prospectively identifies the particular system information blocks of second set of system information blocks that will have changed content.

Example Embodiment P-31: The method of Example Embodiment P-26, further comprising using the processor circuitry to generate the notification message to prospectively indicate which system information blocks of the first set and which system information blocks of the second set will include a system information block comprising changed content.

Example Embodiment P-32: The method of Example Embodiment P-31, further comprising using the processor circuitry to generate the notification message to comprise a first field which comprises identifiers of the first set of system information blocks which will include a system information block comprising changed content and to comprise a second field which comprises identifiers of the second set of system information blocks will include a system information block comprising changed content.

Example Embodiment P-33: The method of Example Embodiment P-18, further comprising using the processor circuitry:

to generate the system information message to associate a value tag with a system information block or group of system information blocks;

to generate the notification message to comprise ordered information for a system information block(s) or group of system information blocks, the ordered information of the notification message being formatted in accordance with an order in which the value tags for the system information block(s) or group of system information blocks appear in the system information messages, the ordered information indicating whether the system information block(s) or group of system information blocks associated with the respective value tag will have changed content.

Example Embodiment P-34: The method of Example Embodiment P-33, further comprising using the processor circuitry to generate the ordered information of the notification message to comprise a bitmap comprising bit positions corresponding to the value tag which appear in the system information messages.

Example Embodiment P-35: A wireless terminal comprising:

receiver circuitry configured to receive messages over an air interface from an access node, the messages including:
a system information message which comprises content of system information blocks;
a notification message configured to prospectively indicate of a change of content of at least one of the system information blocks;

processor circuitry configured to use the notification message to make a determination regarding acquisition of the content of at least one system information block.

Example Embodiment P-36: The wireless terminal of Example Embodiment P-35, wherein the receiver circuitry is configured to receive the notification message in advance of a predetermined modification period boundary.

Example Embodiment P-37: The wireless terminal of Example Embodiment P-36, wherein when the notification message prospectively indicates a change of content of the at least one of the system information blocks, the processor circuitry is configured to make a determination to acquire the content of the at least one system information block upon occurrence of the predetermined modification period boundary.

Example Embodiment P-38: The wireless terminal of Example Embodiment P-37, wherein the processor circuitry is configured to make the determination to acquire the content of the at least one system information block upon occurrence of the predetermined modification period boundary provided that the at least one system information block has an updated value tag.

Example Embodiment P-39: The wireless terminal of Example Embodiment P-36, wherein the predetermined modification period boundary marks a beginning of a period in which the content of the at least one of the system information blocks changes from a previous modification period.

Example Embodiment P-40: The wireless terminal of Example Embodiment P-36, wherein the receiver circuitry is further configured to receive plural notification messages in advance of the predetermined modification period boundary.

Example Embodiment P-41: The wireless terminal of Example Embodiment P-39, wherein the receiver circuitry is further configured to receive the plural notification messages preceding the predetermined modification period boundary.

Example Embodiment P-42: The wireless terminal of Example Embodiment P-35, wherein the receiver circuitry is further configured to receive the notification message as comprising a paging message.

Example Embodiment P-43: The wireless terminal of Example Embodiment P-42, wherein the receiver circuitry is further configured to receive the notification message as comprising an information element in the paging message.

Example Embodiment P-44: The wireless terminal of Example Embodiment P-35, wherein the processor circuitry is further configured to obtain from the notification message an information element that indicates a change of contents of the at least one of the system information blocks.

Example Embodiment P-45: The wireless terminal of Example Embodiment P-35, wherein the receiver circuitry is further configured:
to obtain from the access node a first set of system information blocks which are provided by the access node in a broadcast mode;
to obtain from the access node an indication of system information blocks of a second set of system information blocks which are provided to a wireless terminal using an on-demand delivery mode; and

wherein the processor circuitry is further configured to obtain from the notification message a prospective indication that one or more of the first set of system information blocks will include a system information block comprising changed content and a prospective indication that one or more of the second set of system information blocks will include a system information block comprising changed content.

Example Embodiment P-46: The wireless terminal of Example Embodiment P-45, wherein the processor circuitry is further configured to obtain from a system information message the content of a system information block of the first set that comprises changed content.

Example Embodiment P-47: The wireless terminal of Example Embodiment P-45, wherein the processor circuitry is further configured to request on-demand delivery of the content of a system information block of the second set that comprises changed content.

Example Embodiment P-48: The wireless terminal of Example Embodiment P-45, wherein the processor circuitry is further configured to obtain from the notification message a first field which prospectively indicates if the first set of system information blocks will include a system information block comprising changed content and a second field which prospectively indicates if the second set of system information blocks will include a system information block comprising changed content.

Example Embodiment P-49: The wireless terminal of Example Embodiment P-48, wherein the processor circuitry is further configured to obtain from the first field a binary value which prospectively indicates if the first set of system information blocks will include a system information block comprising changed content and to obtain from the second field a binary value which prospectively indicates if the second set of system information blocks will include a system information block comprising changed content.

Example Embodiment P-50: The wireless terminal of Example Embodiment P-45, wherein the processor circuitry is further configured to obtain from the notification message a first field which prospectively identifies particular system information blocks of the first set of system information blocks that will have changed content and a second field which prospectively identifies particular system information blocks of the second set of system information blocks that will have changed content.

Example Embodiment P-51: The wireless terminal of Example Embodiment P-50, wherein the processor circuitry is further configured to decode the first field as a bitmap which prospectively identifies the particular system information blocks of first set of system information blocks that will have changed content and to decode the second field as a bitmap which prospectively identifies the particular system information blocks of second set of system information blocks that will have changed content.

Example Embodiment P-52: The wireless terminal of Example Embodiment P-45, wherein the processor circuitry is further configured to obtain from the notification message a prospective indication of which system information blocks of the first set and which group(s) system information blocks of the second set will include a system information block comprising changed content.

Example Embodiment P-53: The wireless terminal of Example Embodiment P-52, wherein the processor circuitry is further configured to obtain from the notification message a first field which comprises identifiers of the first set of system information blocks which will include a system information block comprising changed content and to obtain from the notification message a second field which comprises identifiers of the second set of system 2 5 information blocks will include a system information block comprising changed content.

Example Embodiment P-54: The wireless terminal of Example Embodiment P-35, wherein the processor circuitry is further configured:

to obtain from the system information message a value tag associated with a system information block or group of system information blocks;

to obtain from the notification message ordered information for a system information block(s) or group of system information blocks, the ordered information of the notification message being formatted in accordance with an order in which the value tags for the system information block(s) or group of system information blocks appear in the system information messages, the ordered information indicating whether the system information block(s) or group of system information blocks associated with the respective value tag will have changed content.

Example Embodiment P-55: The wireless terminal of Example Embodiment P-54, wherein the processor circuitry is further configured to obtain from the notification message a bitmap comprising bit positions corresponding to the ordered information.

Example Embodiment P-56: A method in a wireless terminal comprising:

receiving messages over an air interface from an access node;
a system information message which comprises content of system information blocks;
a notification message configured to prospectively indicate of a change of content of at least one of the system information blocks;

using processor circuitry to make a determination regarding acquisition of the content of at least one system information block.

Example Embodiment P-57: The method of Example Embodiment P-56, further comprising receiving the notification message in advance of a predetermined modification period boundary.

Example Embodiment P-58: The method of Example Embodiment P-57, further comprising when the notification message prospectively indicates a change of content of the at least one of the system information blocks, using the processor circuitry to make a determination to acquire the contents of the at least one system information block upon occurrence of the predetermined modification period boundary.

Example Embodiment P-59: The method of Example Embodiment P-57, further comprising when the notification message prospectively indicates the change of content of the at least one of the system information blocks, using the processor circuitry to make the determination to acquire the contents of the at least one system information block upon occurrence of the predetermined modification period boundary provided that the at least one system information block has an updated value tag.

Example Embodiment P-60: The method of Example Embodiment P-57, wherein the predetermined modification period boundary marks a beginning of a period in which the content of the at least one of the system information blocks changes from a previous modification period.

Example Embodiment P-61: The method of Example Embodiment P-57, further comprising receiving plural notification messages in advance of the predetermined modification period boundary.

Example Embodiment P-62: The method of Example Embodiment P-61, further comprising receiving the plural notification messages preceding the predetermined modification period boundary.

Example Embodiment P-63: The method of Example Embodiment P-56, further comprising receiving the notification message as comprising a paging message.

Example Embodiment P-64: The method of Example Embodiment P-63, further comprising receiving the notification message as comprising an information element in the paging message.

Example Embodiment P-65: The method of Example Embodiment P-56, further comprising using the processor circuitry to obtain from the notification message an information element that indicates a change of contents of the at least one of the system information blocks.

Example Embodiment P-66: The method of Example Embodiment P-56, further comprising:

using the receiver circuitry:
to obtain from the access node a first set of system information blocks which are provided by the access node in a broadcast mode;
to obtain from the access node an indication of system information blocks of a second set of system information blocks which are provided to a wireless terminal using an on-demand delivery mode; and

using the processor circuitry to obtain from the notification message a prospective indication that one or more of the first set of system information blocks will include a system information block comprising changed content and a prospective indication that one or more of the second set of system information blocks will include a system information block comprising changed content.

Example Embodiment P-67: The method of Example Embodiment P-66, further comprising the processor circuitry obtaining from a system information message the content of a system information block of the first set that comprises changed content.

Example Embodiment P-68: The method of Example Embodiment P-66, further comprising the processor circuitry requesting on-demand delivery of the content of a system information block of the second set that comprises changed content.

Example Embodiment P-69: The method of Example Embodiment P-66, further comprising using the processor circuitry to obtain from the notification message a first field which prospectively indicates if the first set of system information blocks will include a system information block comprising changed content and a second field which prospectively indicates if the second set of system information blocks will include a system information block comprising changed content.

Example Embodiment P-70: The method of Example Embodiment P-69, further comprising using the processor circuitry to obtain from the first field a binary value which prospectively indicates if the first set of system information blocks will include a system information block comprising changed content and to obtain from the second field a binary value which prospectively indicates if the second set of system information blocks will include a system information block comprising changed content.

Example Embodiment P-71: The method of Example Embodiment P-66, further comprising using the processor circuitry to obtain from the notification message a first field which prospectively identifies particular system information blocks of the first set of system information blocks that will have changed content and a second field which prospectively identifies particular system information blocks of the second set of system information blocks that will have changed content.

Example Embodiment P-72: The method of Example Embodiment P-71, further comprising using the processor circuitry to decode the first field as a bitmap which prospectively identifies the particular system information blocks of first set of system information blocks that will have changed content and to decode the second field as a bitmap which prospectively identifies the particular system information blocks of second set of system information blocks that will have changed content.

Example Embodiment P-73: The method of Example Embodiment P-66, further comprising using the processor circuitry to obtain from the notification message a prospective indication of which system information blocks of the first set and which system information blocks of the second set will include a system information block comprising changed content.

Example Embodiment P-74: The method of Example Embodiment P-73, further comprising using the processor circuitry to obtain from the notification message a first field which comprises identifiers of the first set of system information blocks which will include a system information block comprising changed content and to obtain from the notification message a second field which comprises identifiers of the second set of system information blocks will include a system information block comprising changed content.

Example Embodiment P-75: The method of Example Embodiment P-56, further comprising using the processor circuitry to:

to obtain from the system information message a value tag associated with a system information block or group of system information blocks;

to obtain from the notification message ordered information for a system information block(s) or group of system information blocks, the ordered information of the notification message being formatted in accordance with an order in which the value tags for the system information block(s) or group of system information blocks appear in the system information messages, the ordered information indicating whether the system information block(s) or group of system information blocks associated with the respective value tag will have changed content.

Example Embodiment P-76: The method of Example Embodiment P-75, further comprising using the processor circuitry to obtain from the notification message a bitmap comprising bit positions corresponding to the ordered information.

Although the processes and methods of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routines of the disclosed embodiments are capable of being executed on any computer operating system, and is capable of being performed using any CPU architecture. The instructions of such software are stored on non-transient computer readable media.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

Nodes that communicate using the air interface also have suitable radio communications circuitry. Moreover, the technology can additionally be considered to be embodied entirely within any form of computer-readable memory, such as solid-state memory, magnetic disk, or optical disk containing an appropriate set of computer instructions that would cause a processor to carry out the techniques described herein.

It will be appreciated that the technology disclosed herein is directed to solving radio communications-centric issues and is necessarily rooted in computer technology and overcomes problems specifically arising in radio communications. Moreover, in at least one of its aspects the technology disclosed herein improves the functioning of the basic function of a wireless terminal and/or node itself so that, for example, the wireless terminal and/or node can operate more effectively by prudent use of radio resources.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an 2 0 element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every 2 5 problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An access node comprising:
processor circuitry configured to:
generate system information messages which comprise content of system information blocks;
generate a notification message configured to prospectively indicate a change of the content of at least one of the system information blocks;
transmitter circuitry configured to transmit the system information messages and the notification message over an air interface to the one or more wireless terminals.

2. The access node of claim 1, wherein the processor circuitry is further configured to generate the notification message for transmission by the transmitter circuitry in advance of a predetermined modification period boundary; and
wherein the predetermined modification period boundary marks a beginning of a period in which the content of the at least one of the system information blocks changes from a previous modification period.

3. The access node of claim 1, wherein the processor circuitry is further configured to generate the notification message as comprising a paging message.

4. The access node of claim 1, wherein the processor circuitry is further configured:
to generate a first set of system information blocks which are provided by the access node in a broadcast mode and a second set of system information blocks which are provided to a wireless terminal using an on-demand delivery mode;
to generate the notification message to prospectively indicate which of one or more of the first set of system information blocks and the second set of system information blocks will include a system information block comprising changed content.

5. The access node of claim 1, wherein the processor circuitry is further configured:
to generate the system information messages to associate a value tag with a system information block or group of system information blocks;
to generate the notification message to comprise ordered information for a system information block(s) or group of system information blocks, the ordered information of the notification message being formatted in accordance with an order in which the value tags for the system information block(s) or group of system information blocks appear in the system information messages, the ordered information indicating whether the system information block(s) or group of system information blocks associated with the respective value tag will have changed content.

6. A method in an access node comprising:
using processor circuitry to:
generate system information messages which comprise content of system information blocks;
generate a notification message configured to prospectively indicate a change of the content of at least one of the system information blocks;
transmitting the system information messages and the notification message over an air interface to the one or more wireless terminals.

7. The method of claim 6, further comprising using the processor circuitry to generate the notification message for transmission by the transmitter circuitry in advance of a predetermined modification period boundary; and wherein the predetermined modification period boundary marks a beginning of a period in which the content of the at least one of the system information blocks changes from a previous modification period.

8. The method of claim 6, further comprising using the processor circuitry to generate the notification message as comprising a paging message.

9. The method of claim 6, further comprising using the processor circuitry:
to generate a first set of system information blocks which are provided by the access node in a broadcast mode and a second set of system information blocks which are provided to a wireless terminal using an on-demand delivery mode;
to generate the notification message to prospectively indicate which of one or more of the first set of system information blocks and the second set of system information blocks will include a system information block comprising changed content.

10. The method of claim 6, further comprising using the processor circuitry:
to generate the system information message to associate a value tag with a system information block or group of system information blocks;
to generate the notification message to comprise ordered information for a system information block(s) or group of system information blocks, the ordered information of the notification message being formatted in accordance with an order in which the value tags for the system information block(s) or group of system information blocks appear in the system information messages, the ordered information indicating whether the system information block(s) or group of system information blocks associated with the respective value tag will have changed content.

11. A wireless terminal comprising:
receiver circuitry configured to receive messages over an air interface from an access node, the messages including:
a system information message which comprises content of system information blocks;
a notification message configured to prospectively indicate of a change of content of at least one of the system information blocks;
processor circuitry configured to use the notification message to make a determination regarding acquisition of the content of at least one system information block.

12. The wireless terminal of claim 11, wherein the processor circuitry is configured to make the determination to acquire the content of the at least one system information block upon occurrence of the predetermined modification period boundary provided that the at least one system information block has an updated value tag.

13. The wireless terminal of claim 11, wherein the receiver circuitry is further configured to receive the notification message as comprising a paging message.

14. The wireless terminal of claim 11, wherein the receiver circuitry is further configured:
to obtain from the access node a first set of system information blocks which are provided by the access node in a broadcast mode;
to obtain from the access node an indication of system information blocks of a second set of system information blocks which are provided to a wireless terminal using an on-demand delivery mode; and
wherein the processor circuitry is further configured to obtain from the notification message a prospective indication that one or more of the first set of system information blocks will include a system information block comprising changed content and a prospective indication that one or more of the second set of system information blocks will include a system information block comprising changed content.

15. The wireless terminal of claim 11, wherein the processor circuitry is further configured:
to obtain from the system information message a value tag associated with a system information block or group of system information blocks;
to obtain from the notification message ordered information for a system information block(s) or group of system information blocks, the ordered information of the notification message being formatted in accordance with an order in which the value tags for the system information block(s) or group of system information blocks appear in the system information messages, the ordered information indicating whether the system information block(s) or group of system information blocks associated with the respective value tag will have changed content.

16. A method in a wireless terminal comprising:
receiving messages over an air interface from an access node; the messages including:
a system information message which comprises content of system information blocks;
a notification message configured to prospectively indicate of a change of content of at least one of the system information blocks;
using processor circuitry to make a determination regarding acquisition of the content of at least one system information block.

17. The method of claim 16, further comprising when the notification message prospectively indicates the change of content of the at least one of the system information blocks, using the processor circuitry to make the determination to acquire the contents of the at least one system information block upon occurrence of the predetermined modification period boundary provided that the at least one system information block has an updated value tag.

18. The method of claim 16, further comprising receiving the notification message as comprising a paging message.

19. The method of claim 16, further comprising:
using the receiver circuitry:
to obtain from the access node a first set of system information blocks which are provided by the access node in a broadcast mode;
to obtain from the access node an indication of system information blocks of a second set of system information blocks which are provided to a wireless terminal using an on-demand delivery mode; and
using the processor circuitry to obtain from the notification message a prospective indication that one or more of the first set of system information blocks will include a system information block comprising changed content and a prospective indication that one or more of the second set of system information blocks will include a system information block comprising changed content.

20. The method of claim 16, further comprising using the processor circuitry to:
to obtain from the system information message a value tag associated with a system information block or group of system information blocks;
to obtain from the notification message ordered information for a system information block(s) or group of system information blocks, the ordered information of the notification message being formatted in accordance with an order in which the value tags for the system information block(s) or group of system information blocks appear in the system information messages, the ordered information indicating whether the system information block(s) or group of system information blocks associated with the respective value tag will have changed content.
